(19) United States
(12) Patent Application Publication
(10) Pub. No.: US 2022/0002199 A1
(43) Pub. Date: Jan. 6, 2022

(54) Nanomaterial And Cellulosic Rheology Modifiers For 3D Concrete Printing

(71) Applicant: The Trustees of Columbia University in the City of New York, New York, NY (US)

(72) Inventors: Shiho Kawashima, Brooklyn, NY (US); AlaEddin Douba, New York, NY (US)

(21) Appl. No.: 17/366,697

(22) Filed: Jul. 2, 2021

Related U.S. Application Data
(60) Provisional application No. 63/047,430, filed on Jul. 2, 2020.

(51) Int. Cl. C04B 24/38; C04B 28/02; C04B 14/10; C04B 40/00; B33Y 70/10

(52) U.S. Cl. CPC C04B 24/383; C04B 28/02; C04B 2103/0079; C04B 40/0046; B33Y 70/10; C04B 14/10

(57) ABSTRACT

Viscosity and static yield stress are significant rheological properties for 3D concrete printing (3DCP), in which process high static yield stress is associated with high buildability and shape stability and low viscosity is associated with extrudability and pumping. The challenge in concrete rheology lies in decoupling the effect of admixtures on these two properties, i.e., achieving high static yield stresses while still maintaining moderately low viscosities. In meeting this challenge, provided here is an additive system of nanoclays and viscosity modifying admixtures that can tailor the rheological properties of cement composites to meet 3DCP performance requirements. Further, because 3DCP is a technology of scales, any additive must meet scalability and stability requirements for construction, i.e., ease of processing in abundance and relatively low cost, and exhibit an extended shelf life.

### RELATED APPLICATIONS

The present application claims priority to and the benefit of U.S. patent application No. 63/047,430, “Nanomaterial And Cellulosic Rheology Modifiers For 3D Concrete Printing” (filed Jul. 2, 2020), the entirety of which application is incorporated herein by reference for any and all purposes.

### GOVERNMENT RIGHTS

This invention was made with government support under Contract No. 1653419 awarded by the National Science Foundation. The government has certain rights in the invention.

### TECHNICAL FIELD

The present disclosure relates to the field of rheology-modified concrete and to the field of additive manufacturing.

### BACKGROUND

3D concrete printing (3DCP) requires fine control of the rheological properties of cement composites, requiring a balance between high static yield stress for buildability and shape stability and low/moderate viscosity for extrudability and pumping. To achieve rheological control, is, however, difficult.

Static yield stress describes the material's resistance to flow and it is typically associated with a material's transition from solid to liquid. Viscosity, on the other hand, describes the material's resistance to flow under deformation and is associated with fluidity and pumpability. Cement colloidal forces via van der Waals and electrostatic forces and early hydration, e.g. C—S—H bridging, have been identified as the main interactions controlling such kinetics. Thus, most rheological additives affect both static yield stress and viscosity proportionally, and achieving the high static yield stress desired for 3DCP can result in excessively viscous, unpumpable composites. Accordingly, there is a long-felt need in the art for concrete systems (suitable for 3DCP) that exhibit desirable static yield stress as well as desirable viscosity.

### SUMMARY

In meeting the described long-felt needs, the present disclosure provides methods, comprising: combining a cementitious material, a cellulosic material, and a nanomaterial so as to give rise to a curable material, (i) the cellulosic material being combined with the nanomaterial before combination with the cementitious material, (ii) the cellulosic material being combined with the cementitious material before combination with the nanomaterial, (iii) the nanomaterial being combined with the cementitious material before combination with the cellulosic material, (iv) the cellulosic material, the nanomaterial, and the cementitious material being combined together, or any combination of (i), (ii), (iii), and (iv).

Also provided is a curable material made according to the present disclosure.

Further provided are methods, comprising: combining a cementitious material, a cellulosic material, and a nanomaterial to form a curable material, the method being performed such that the curable material exhibits at least one of: a pre-selected static yield stress, a pre-selected viscosity, a pre-selected heat of hydration, or pre-selected hydration kinetics, the cementitious material, the cellulosic material, or the nanomaterial being combined with another of the cementitious material, cellulosic material, and nanomaterial before being combined with the third of the cementitious material, cellulosic material, and nanomaterial.

Also disclosed are pre-mixes, comprising: a nanomaterial combined with a cellulosic material.

Additionally provided are methods, comprising combining a pre-mix according to the present disclosure with a cementitious material so as to give rise to a curable material.

Also disclosed are curable compositions, comprising: a cementitious material, a cellulosic material, and a nanomaterial, the cellulosic material and the nanomaterial being present in proportions such that the curable material exhibits at least one of: a pre-selected static yield stress, a pre-selected viscosity, a pre-selected heat of hydration, or pre-selected hydration kinetics.

Further provided are curable materials, comprising a cementitious material; a cellulosic material; and a nanomaterial.

Further provided are methods, comprising the use of a curable material according to the present disclosure in an additive manufacturing process.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In the drawings, which are not necessarily drawn to scale, like numerals can describe similar components in different views. Like numerals having different letter suffixes may represent different instances of similar components. The drawings illustrate generally, by way of example, but not by way of limitation, various aspects discussed in the present document. In the drawings:

FIG. 1 provides an example relationship between MC content and viscosity (to the left) and the chemical structure of MC (to the right).

FIGS. 2A-2C provides example distillation setups (FIG. 2A—Bunsen burner, FIG. 2B—electric heating mantle, FIG. 2C—oil bath) to remove ethanol.

FIG. 3 provides an exemplary distillation combined with magnetic stirring using a hot plate.

FIGS. 4A-4B provides an exemplary dry dispersed cement showing the cake structure after distillation (FIG. 4A—before drying in oven, FIG. 4B—after drying in oven).

FIG. 5 provides an exemplary magnetic stirring of NC creating NC solution.

FIG. 6 provides an exemplary sonication process.

FIG. 7 provides exemplary steps for preparing MC solutions.

FIG. 8 provides an exemplary effect of 1% NC and dispersion method on the static yield stress of cement paste immediately after preparation of the dispersed NC system (Fresh solution), after 1 hour, and after 1 week. Dry mixing represents the case where there is no dispersion process employed, which leads to the weakest effect of NC as they are introduced into the system agglomerated, highlighting the dispersion step.

Solutions prepared by magnetic stirring lose their effect over time due to reagglomeration and NC falling out of suspension, while solutions prepared by sonication remain stable. Results show that dry dispersion leads to the most enhanced effect (increasing static yield stress by ˜170% compared to neat) and remains stable over 1 week.

FIG. 9 provides an exemplary effect of NC dosage on static yield stress of cement paste using different dispersion methods. The slope of linear fit can be taken as the efficiency of NC on the parameter. Dry mixing (dm) where no dispersion method is employed shows the least efficiency. Magnetic stirring (mag) and dry dispersion (dd) show comparable efficiency up to ˜2% NC but then dd goes on to exhibit an enhanced effect beyond 2% NC and ability to achieve dosing up to 4% NC, which is not possible via mag. It should also be noted that these results show the effect of NC solution prepared via magnetic stirring immediately after preparation, so static yield stress values and NC efficiency would decrease with time after solution preparation. Since dry dispersions are stable (as shown in FIG. 8), the same would not be observed in dd.

FIG. 10 provides an exemplary effect of NC dosage on steady state viscosity of cement paste using different dispersion methods. Little change is observed with NC introduced via dry mixing (dm), so no dispersion, and magnetic stirring (mag). There is an increase in viscosity with NC prepared via dry dispersion (dd), However, the increase is very small compared to the increase in static yield stress, which has positive implications on 3DCP.

FIG. 11 provides exemplary rheological properties of MC cement system normalized by plain cement paste with static yield stress of 249 Pa, viscosity of 1.53 Pa·s and storage modulus of 0.26 GPa.

FIG. 12 provides an exemplary effect of NC and MC hybrid system on the static yield stress of cement paste. The slope of linear fit represents NC efficiency at each MC content. Results indicate that NC efficiency increases with increasing MC content, showing synergistic effects on static yield stress. At 1.5% MC and 2% MC the curve starts to decrease or plateau, indicating a threshold limit of 1% NC in these systems.

FIG. 13 provides an illustration of a steady state (plastic) viscosity of cement paste with hybrid contents of NC and MC. Results indicate increase in viscosity with MC addition, and NC has consistent efficiency (i.e. increasing effect) at each MC dosage, indicated by the slope of the linear fit. Similar to the results of static yield stress (FIG. 12), there is a threshold limit of 1% NC at 1.5% MC and 2% MC.

FIG. 14 provides an illustrative effect of different methods of hybridization of 1 wt. % MC and 1 wt. % NC on static yield stress immediately after synthesis, 1 hour after, and 1 week after. All admixture systems employing dd of NC (H6-H9) exhibit high stability over 1 week, while those in solution experience a decrease in performance (H1-H5). Dry dispersion of NC on MC (H9) is the most effective, i.e. highest increase in static yield stress (˜500% compared to neat) and stability.

FIG. 15 provides exemplary isothermal calorimetry results of cement paste with MC only or NC only. NC leads to an overall acceleration in hydration (red line)—faster start of acceleration period, higher rate of acceleration and increased hydration peak with increase in NC content—while MC leads to deceleration (black line)—delay in acceleration period, lower rate of acceleration and lower peaks with increase in MC content.

FIG. 16 provides exemplary isothermal calorimetry results of hybrid cement paste showing the effect of MC addition at 1.5 wt. % NC content.

FIG. 17 provides exemplary isothermal calorimetry results of hybrid cement paste showing the effect of NC addition at 2.0 wt. % NC content.

FIG. 18 provides 7-days and 28-days compressive strength of cement mortar cubes with additions of MC only or NC only.

FIG. 19 provides 7-days and 28-days compressive strength of cement mortar cubes with additions of hybrid NC and MC.

FIG. 20 provides heat of hydration of cement paste at 0.46 w/b containing 4 wt. % SNP replacement of cement at varying sonication energy for dry dispersion when cement is mixed in the nanomaterial suspension

FIG. 21 provides SEM images of NC dry powders in their reference agglomerated state.

FIGS. 22A-22D provide SEM images of nanomodified cement particle through dd at different NC replacement levels (FIG. 22A—unhydrated cement with 1 wt. % NC replacement coating; FIG. 22B—unhydrated cement with 2 wt. % NC replacement coating; FIG. 23C—unhydrated cement with 4 wt. % NC replacement coating; FIG. 23D—unhydrated cement with 10 wt. % NC replacement coating).

FIGS. 23A-23D provide rheological properties of cement pastes with different contents of NC dd cement at 0.46 w/b ratio measuring the effectiveness of partial NC coating via dd when the overall NC content is maintained by comparing the rheological properties of cement paste where all cement is coated with NC versus when some cement particles are coated at 10 wt. % replacement and others are uncoated (FIG. 23A—static yield stress results; FIG. 23B—plastic viscosity results; FIG. 23C—storage modulus results; FIG. 23D—elastic modulus results).

FIG. 24 provides SEM images of MC coated with NC particles a 1MC:3NC ratio.

FIG. 25 provides SEM images of cement coated with ANP particles using dd at 1.0 wt. % content.

FIGS. 26A-26B provide SEM images of cement coated with SNP particles using dd (FIG. 26A—Unhydrated cement with 1 wt. % SNP, FIG. 26B—unhydrated cement with 4 wt. % SNP).

FIGS. 27A-27B provide SEM images of cement coated with CCNP particles using dd at 1.0 wt. % content (FIG. 27A—unhydrated cement with 1 wt. % CCNP; FIG. 27B—uhydrated cement with 4 wt. % CCNP)

FIGS. 28A-28B provide SEM images of cement coated with GNP particles using dd at 1.0 wt. % content (FIG. 28A—unhydrated cement with 1 wt. % GNP; FIG. 28B—unhydrated cement with 4 wt. % GNP).

FIG. 29 provides conductance of fresh cement paste prepared at 0.46 w/b with GNP using dd.

FIGS. 30A-30B provide heat of hydration via calorimetry for dd cement with SNP and CCNP (FIG. 30A—cement paste prepared with CNP; FIG. 30B—cement paste prepared with CCNP)

FIGS. 31A-31B provide compressive and tensile strengths of cement mortar containing 4 wt. % SNP via cube compression and split tension tests (FIG. 31A—compressive strength of cement mortar with 4 wt. % SNP replacement; FIG. 31B—tensile strength of cement mortar with 4 wt. % SNP replacement).

FIGS. 32A-32B provide compressive and tensile strengths of cement mortar containing 4 wt. % CCNP via cube compression and split tension tests (FIG. 32A—compressive strength of cement mortar with 4 wt % CCNP replacement; FIG. 32B—tensile strength of cement mortar with 4 wt % CCNP replacement).

FIGS. 33A-33B provide compressive and tensile strengths of cement mortar containing 4 wt. % NC via cube compression and split tension tests (FIG. 33A—compressive strength of cement mortar with 4 wt. % NC replacement; FIG. 33B—compressive and tensile strengths of cement mortar containing 4 wt. % NC via cube compression and split tension tests).

FIGS. 34A-34F provides 3D print examples utilizing the hybrid system at 1 wt. % NC and 1 wt. % MC using syringe printer (FIG. 34A—buildability test, FIG. 34B—cylinder with braced internal infill, FIG. 34C—rectilinear infill, FIG. 34D—honeycomb infill patterns, FIG. 34E—shell structure, FIG. 34F—internal structure of 3D sample broken in half).

FIG. 35 provides static yield stress measurements of MgO paste at 0.9 and 1.1 w/b ratios.

FIG. 36 provides elastic modulus measurements of MgO paste at 0.9 and 1.1 w/b ratios.

FIG. 37 provides plastic viscosity measurements of MgO paste at 0.9 and 1.1 w/b ratios.

FIGS. 38A-38D provides a print quality test for MgO paste prepared with only NC, only MC and NC with MC (FIG. 38A—3D print of interest, FIG. 38B—print containing NC alone, FIG. 38C—print containing MC alone, and FIG. 38D—printing containing both NC and MC).

FIG. 39 provides printed MgO paste specimen description based on infill pattern and type.

FIG. 40 provides compressive strength of cast in specimens with and without admixture.

FIG. 41 provides compressive strength results of 3D printed specimens.

FIG. 42 provides compressive strength of 3D printed specimens at 1.1 w/b.

FIG. 43 provides percentage change in mass due to carbonation measuring water evaporation losses using mass change of similar specimens stored at ambient conditions.

FIG. 44 provides an example flowchart of material formulations.

FIG. 45 provides an example flowchart of material formulations; shown are are three hybridization methods of adding MC where NC are always dispersed in solution via stirring. M1: MC are added as powder to the cement. M2: Two solutions; MC and NC, where each concentration is in half the total water. M3: Stirring NC in an MC solution.

FIG. 46 provides exemplary results related to illustrative formulations. As shown, the addition of MC causes an increase in plastic viscosity proportional to its content. Addition of NC alone does not increase viscosity; however, addition of NC and MC shows an increase in plastic viscosity proportional to NC content.

FIG. 47 provides exemplary stability results related to illustrative formulations. As shown, all hybrid systems at 1 wt. % NC and 1 wt. % MC show higher increase in static yield stress than reference but also show a decrease in performance when solutions are stored for 1 week before use. M2 shows the highest performance in fresh state but the fastest decay in performance when stored whereas M3 is the best at maintaining performance.

FIG. 48 provides exemplary dispersion approaches. NC can be dispersed in solution (with water) or in powder (with cement). Powder dispersions are performed using dry dispersion or dry mixing whereas solution dispersions are done via stirring or sonication.

FIG. 49 provides exemplary static yield strength values for exemplary formulations, comparing the effect of dispersion method, magnetic stirring (mag), dry mixing (dm) or dry dispersion (dd) of NC on the static yield stress showing higher efficiency of dd, then mag and followed by dm. As shown, the dd approach achieves a given static yield strength at a lower NC content than the mag or dm methods, which methods require 40% and 190% (respectively) more NC than the dd approach to achieve a normalized static yield stress of 6.

FIG. 50 provides exemplary storage modulus values for exemplary formulations, comparing the effect of dispersion method, magnetic stirring (mag), dry mixing (dm) or dry dispersion (dd) of NC on the storage modulus showing higher efficiency of dd, then mag and followed by dm.

FIG. 51 translates static yield stress measurements to stable layer height thickness, showing that because of the higher efficiency of dd, greater layer height can be achieved at 3 wt. % NC than it would in magnetic stirring or at 4 wt. % with dry mixing.

FIG. 52 provides exemplary heat of hydration curves of cement paste at 0.46 w/b ratio and 10 wt. % nanomaterial dosage of NC, CCNP and SNP prepared through the dd approach, showing promotion of hydration and some acceleration despite 10 wt. % replacement of cement.

FIG. 53 provides static yield data showing that dd effectiveness of altering the static yield stress of cement paste is independent of whether NC coat the entire surface of cement or coat some of the cement particles, only as long as the NC dosage is similar.

FIG. 54 provides conductance measurements, showing that using dd to coat the cement with GNP increases conductivity of fresh paste at 0.1, 1 and 10 wt. %.

FIG. 55 illustrates that mechanical performance of cement mortar modified with 4 wt. % SNP via sonication or dd was similar at 28 days, but sonication offers greater strength development rate.

FIG. 56 illustrates that addition of 4 wt. % CCNP (calcium carbonate nanoparticles) yields limited mechanical performance improvements irrespective of dispersion method. Sonication, like the case in 4 wt. % SNP, shows better strength development rate than dd.

FIG. 57 provides the evaluation carried of the origin of thixotropy of NC-cement paste with reference to reference [2].

FIGS. 58A-58F provides simplified 2D-schematics of the interactions that influence cement rheology in NC cement paste system (FIG. 58A—cement-cement, FIG. 58B—cement-NC, FIG. 58C—NC-NC in pore solution, FIG. 58D—NC-NC & NC-cement with no cement-cement, FIG. 58E—NC-NC, cement & cement-cement, FIG. 58F—mixed behavior).

FIG. 59 provides an exemplary rheological protocol (Time is not to scale).

FIG. 60 provides an apparent viscosity evolution during pre-shear at 3 wt. % NC in all three-dispersion method compared to Neat.

FIGS. 61A-61C provide SEM images of NC dry powders in the “as-received” reference state at increasing magnifications: (FIG. 61A) NC agglomerated to the micron scale; (FIG. 61B) individual NC needles clumped together; (FIG. 61C) measurement of individual NC needle.

FIGS. 62A-62B provide SEM images of nanomodified cement particles through dd, showing (FIG. 62A) uniform dispersion of NC on the surface of an unhydrated cement particle and (FIG. 62B) close-up of individual well-dispersed NC needles.

FIG. 63 provides particle size analysis results for reference cement before and after dry dispersion processes.

FIG. 64 provides normalized static yield stress as a function of NC content using different dispersion methods, where the static yield stress is normalized with respect to Neat (141 Pa) for mag and dm and Neatdd (118 Pa) for dd (Linear regression lines with average R2 value of 0.982).

FIG. 65 provides normalized steady state viscosity (plastic viscosity) as a function of NC content using different dispersion methods, where the viscosity is normalized with respect to Neat (1.6 Pa·s) for mag and dm and Neatdd (1.5 Pa·s) for dd (Linear regression lines with average R2 value of 0.86).

FIG. 66 provides normalized storage modulus (G′) results as a function of NC content, where G′ is normalized with respect to Neat (2.1×10⁵ Pa) for mag and dm and Neatdd (2.1×10⁵ Pa) for dd (Linear regression lines with average R2 value of 0.953).

FIG. 67 provides normalized rate of linear increase of storage modulus (G_{rigid}) as a function of NC content, where G_{rigid} is normalized with respect to Neat (173.6 Pa/sec) for mag and dm and Neatdd (177.0 Pa/sec) for dd (Linear regression lines with average R² value of 0.89).

FIG. 68 provides normalized macroscopic elastic modulus as a function of NC content, where modulus is normalized with respect to Neat (1.9×104 Pa) with respect to mag and dm and Neatdd (3.6×10³ Pa) for dd (Linear regression lines with average R2 value of 0.89).

FIG. 69 provides stress-strain curves of cement paste at 3 wt. % NC dosage using dry mixing (dm), magnetic stirring (mag) and dry dispersion (dd) with linear regions representing strain levels where G′_{macro} is measured.

FIG. 70 provides normalized static yield stress and storage modulus (G′) as a function of NC content using dd cement and kerosene, where the reference neat (Neatddkero) has static yield of 656 Pa and storage modulus of 1.4×10⁶ Pa.

FIG. 71 provides heat of hydration kinetics curves of NC-cement paste prepared through dry mixing (dm).

FIG. 72 provides heat of hydration kinetics curves of NC-cement paste prepared through magnetic stirring (mag).

FIG. 73 provides heat of hydration kinetics curves of NC-cement paste prepared through dry mixing (dd).

FIG. 74 provides static yield stress requirement for individual layer thickness based on N. Roussel's τ_y≥μgh_0 [1] assuming density of 2.32 g/cm³.

FIG. 75 provides print structural stability measured by the relationship between the elastic modulus and total print height given different print slenderness ratio (H/6) assuming density of 2.32 g/cm³.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Exemplary methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints, 2 grams and 10 grams, and all the intermediate values). The endpoints of the ranges and any values disclosed herein are not limited to the precise range or value; they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4. Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

Rheological modifiers are a class of admixtures used to alter the rheological behavior of cement-based materials in the fresh state, namely yield stress, viscosity, shear thinning, or shear thickening. Clays are an example of a mineral rheological modifier that is commonly incorporated into cement-based systems to enhance shear thinning. And a special class of clays, nanoclays (NCs), have been found to be particularly effective in introducing high shear thinning and high yield stress development.

In 3D concrete printing, shear thinning and high yield stress development are highly desirable. However, studies have found that an increase in rate and magnitude of static yield stress and improved control of viscosity is needed. One may hypothesize that this may be addressed through enhanced dispersion. NCs exhibit very high specific surface area, which makes them prone to aggregation. Further, their aggregation behavior is highly sensitive to pH, and cement systems are highly alkaline. Therefore, to achieve sufficient rheological performance of 3D concrete printing with NCs, one must have improved dispersion and stability to enhance their effect. Here, our approach to this is to produce a hybrid admixture solution composed of NCs and methyl cellulose through different processing techniques, including a dry dispersion technique to coat cement particles (and dry methyl cellulose) with NC.

Although NC and MC are each utilized as concrete admixtures, there is no existing technique where they are processing together to form a hybrid admixture system prior to addition to the concrete mix (i.e., to the knowledge of the inventors, they are used as separate admixtures only). Common rheological modifiers induce coupled effects on the rheological properties, namely an increase in yield stress is coupled with an increase in viscosity. This coupled effect is not always desirable, especially for 3D concrete printing where a high yield stress is needed for shape stability, but viscosity must be controlled to prevent blocking during the pumping/printing process. The work described herein presents a hybrid mix of MC and NC, and our results are demonstrating that this hybridization allows for:

Decoupling of the rheological properties (i.e. decrease in viscosity and increase in yield stress, and vice versa) and ability to achieve both shear thinning and significant increase in yield stress (up to 5 times control)

Improvement of the efficiency, dispersion and suspension stability of the NCs to prolong the shelf life of the suspended admixture.

As a result, the rheological properties of 3D printing concrete (3DCP) mixes can be engineered to produce specific yield stress or viscosity to maximize print quality. Other techniques are also described to produce ready dry mixes with significantly longer shelf life (greater than several months) via dry dispersion. The following are example mixing methods:
Dry dispersion of NC onto cement and MC.
Hybrid systems composed of NC and MC with different combination of processing techniques.

One can extend the dry dispersion technique (1.) to other nanomaterials (i.e. graphene nanoplatelets, silica nanoparticles, alumina nanoparticles, and calcium carbonate nanoparticles) onto cement for other functionalities.

A comparison was performed to evaluate the effects of dry dispersion with sonication on the compressive and tensile strength of cement mortars at 1, 3, 7 and 28 days to test the strength development rates. Additionally, we looked at the application of NC and MC to improve the rheology and printing performance of magnesium oxide (MgO) binders. The hydration reaction of MgO produces brucite which is physically weak. Brucite can transform with CO₂ into different magnesium carbonates that are physically strong.

Conventional casting techniques creates dense MgO elements that require high pressure and exposure to CO₂ in order to enable carbonation and consequently gain physical strength. This, however, can be avoided by creating internal carbon delivery channels through 3D printing. In this investigation, we studied the rheology of MgO paste at 0.9 and 1.1 w/b ratio at different NC and MC dosages. We then selected a mixture of NC and MC at each w/b to produce similar static yield stress and tested the mechanical performance of printed 1 inch cylinders to compare the effects of 3D printing and infill patterns.

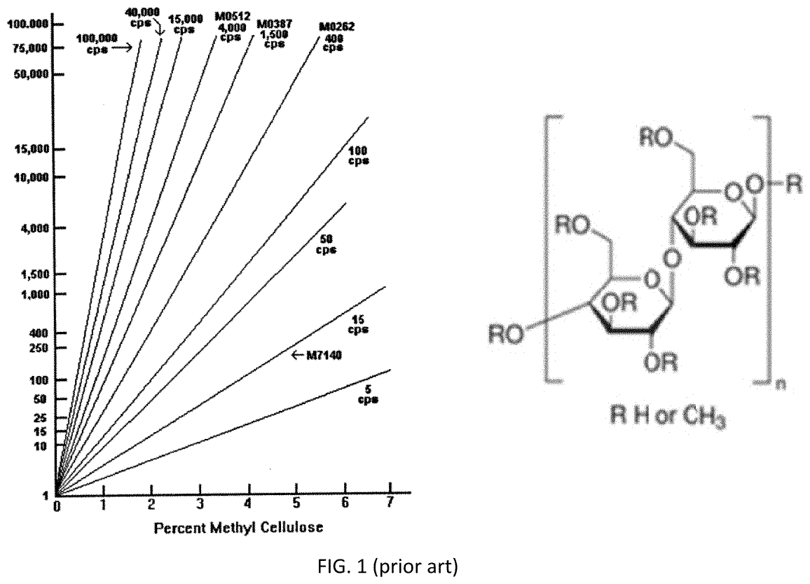

Type I/II ordinary Portland cement and distilled water are used in all cement pastes specimen. The water to cement ratio (w/c) is kept at 0.34 and the additives are added as weight replacement of cement. An exemplary, non-limiting methyl cellulose was purchased from Alfa Aesar and Sigma Aldrich in dry powder form. This type of MC has a molecular weight of 14,000 and viscosity of 15 cPs at 2.0% and 20° C. According to the manufacturer data sheet, MC exhibits a linear relationship between content and viscosity, as shown in FIG. 1. The chemical structure of MC is also shown in FIG. 1 where the cellulose backbone has methoxy substitution between 27.5-31.5 wt. % and degree of substitution between 1.5-1.9. The illustrative (non-limiting) NC used were supplied by Active Minerals under the commercial name Acti-Gel 208. They are a highly purified magnesium aluminum-silicate needle-like particles with an average inner diameter of 30 nm and length in the range of 1.5-2.0 μm. The MgO was high reactivity light burned magnesium oxide powder with >98% purity, and was obtained from Martin Marietta Magnesia Specialties with commercial name MagChem-30.

Both NC and MC are typically supplied in powder form, but solutions can be made or supplied. For NC, they can be either dry mixed (dm) with the cement as powder, or utilize dry dispersion (dd) which is a novel dispersion method that coats cement with NC particles. Dry mixing however is not an effective method to disperse NC. In solution, the most common method used for NC is magnetic stirring, but generally sonication utilizes significantly higher energy and it is the most common method to disperse nanomaterials. For MC, dry mixing is an effective tool since MC powder is micro sized and does not have the same agglomeration behavior as NC. MC solutions can be made with common dissolution processes. Because of the number of ways each additive can be produced, there are a number of ways a hybrid can be formed.

Dry Mixing and Dry Dispersion

Dry mixing is the simplest method that combines cement with NC or MC. This can be achieved using a hand mixer or a cement stationary mixer. In essence, this method utilizes typical mixing equipment used to make cement paste, mortar, or concrete. While this method can be used with both NC and MC, in some cases the methods does not always resolve agglomerates. However, this method is useful in dispersing MC with cement in contents up to 2.0 wt. % by mass of cement.

First, NCs (at a weight replacement of cement) are added to ethanol with 200 proof or higher. Any ethyl alcohol can be used in which cement can not produce any hydrate products and can maintain its liquid state at 40° C. Sonication is a high energy process and subsequent cooling of the solution and heat transfer of the alcohol are parameters to consider. The overall liquid to solid ratio of the ethanol: (cement+NC) should be maintained at 2 for contents up to 2.0 wt. %. For every additional 1 wt. % content, this ratio must be increased by an increment of 0.5. For example, at 3.0 and 4.0 wt. % NC content, the corresponding liquid to solid ratios are 2.5 and 3, respectively. This will ensure adequate heat transfer and energy transfer as NC produce significant colloidal forces that increase the static yield stress. The solution is then placed in an ice bath and cooled to 5° C. or lower. Sonication is then initiated using a probe sonicator operating at 500 W generating around 100 W in solution. The sonication is continuous until 10 kJ/g of NC is achieved. At that state, cement is introduced into the ethanol-NC solution while sonication is undergoing.

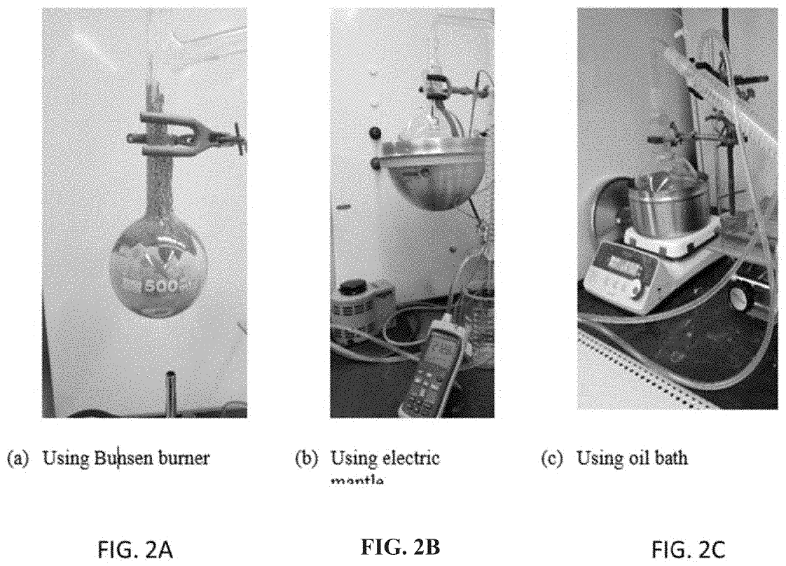

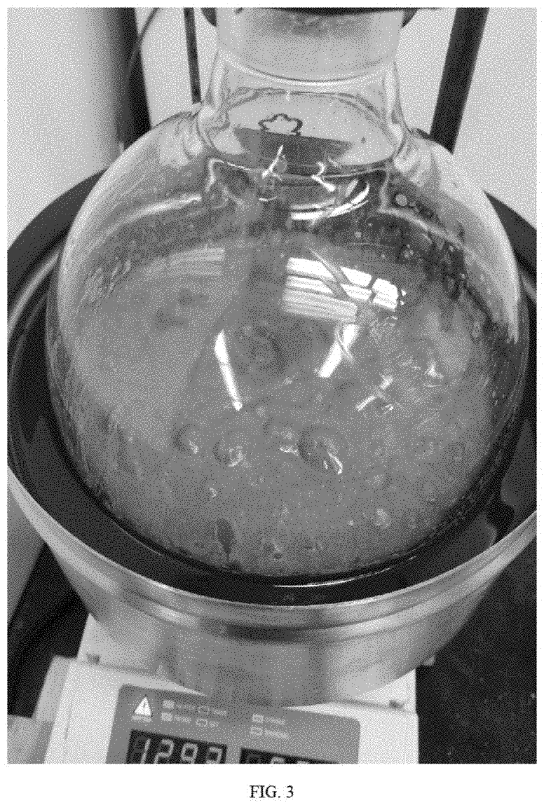

Once all cement is added, sonication is continued in 2 second pulses (2 sec on/2 sec off) until 30 kJ/g of NC is achieved. As soon as sonication is complete, the solution is placed in distillation which can be performed using a Bunsen burner, electric mantle or using a heated oil bath as shown in FIG. 2.

Using the heated oil bath shown in FIG. 3 is a suitable method as it allows for engaging magnetic stirring during the process which ensures maintaining dispersion state and uniform heat transfer across the solution. This process should be accelerated to ensure minimum reagglomeration occurs. The distillation will separate the NC coated cement and recover the ethanol, which can be reused for repeating this process.

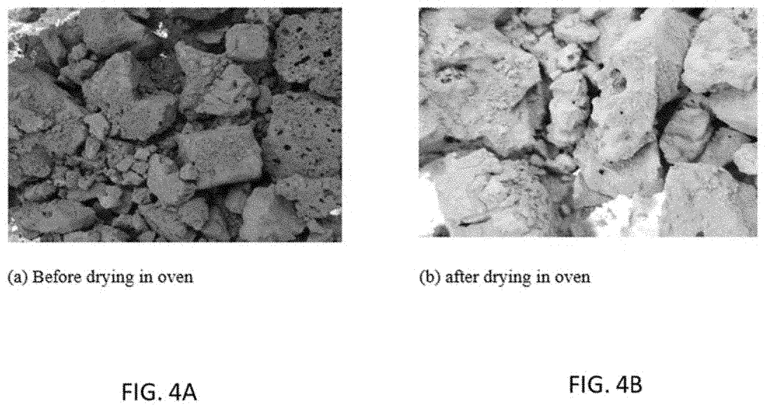

Once distillation is complete, the NC coated cement cake is transferred to the oven at 105° C. for 24 hours to ensure complete removal of ethanol and to prevent hydration with water vapor from air humidity. Photos of the cement before and after oven drying are shown in FIG. 4. Higher temperature can be used as long as the burning/evaporation temperature of chemical compounds within cement are considered.

Upon removal from the oven, the NC coated cement cake is ground using mortar and pestle or any other method that does not significantly impact particle gradation. The resulting NC coated cement is then ready for use and the dispersive state is maintained for months.

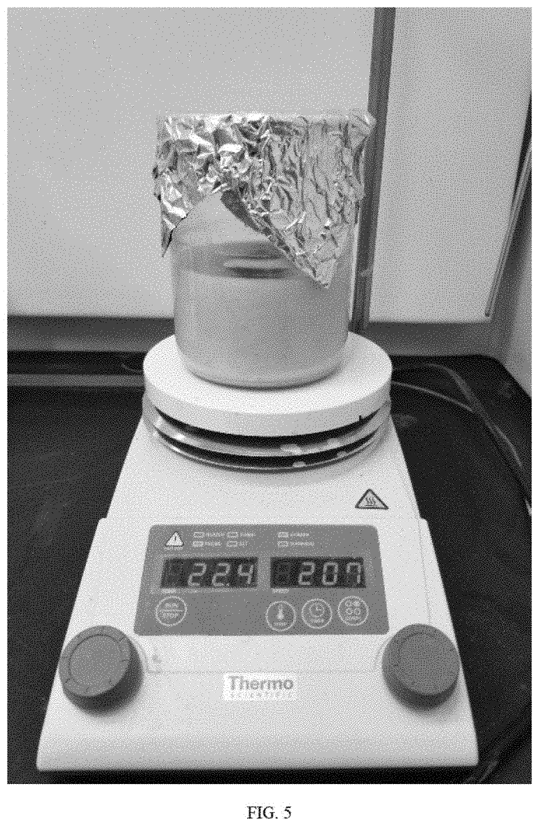

One way to create NC solutions is using magnetic stirring such as the one shown in FIG. 5. To prepare a solution, the specific content of NC is added to water and stirred for a minimum of 5 minutes at 200-800 rpms based on the solution size. Larger solutions can utilize lower revolution speed to minimize spillage. This method is useful due to its ease, availability and lower cost of equipment.

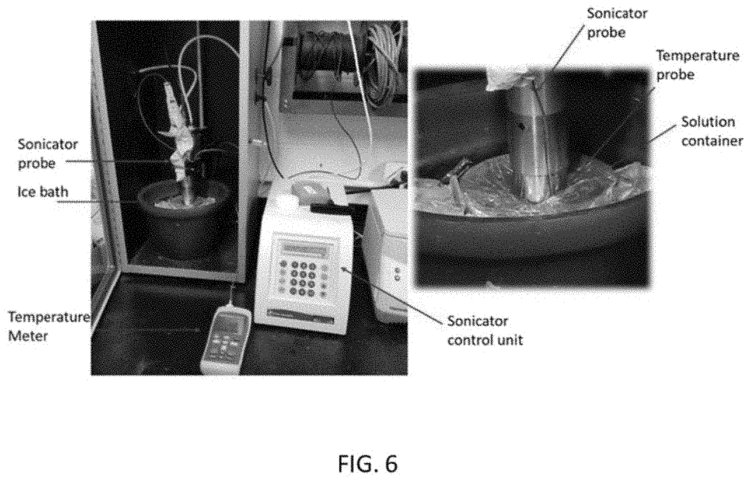

The most common dispersion method of nanomaterials is sonication, specifically using a sonication probe. In this method, the specific content of NC is added to water inside a stainless steel beaker and the sonication probe is inserted. Because sonication generates high energy, there is an associated increase in solution temperature. As a result, the solution may be cooled, e.g. using an ice bath. Sonication is performed continuously at an effective 100 W until 5,000 J/g of NC is achieved. One can use a larger solution to minimize any evaporation that can occur due to overheating. FIG. 6 shows the sonication setup used in this program.

Dissolution

MC is water soluble only at temperatures below 55-60° C. If MC powder is added to water directly, the outer shell of powder agglomerates would dissolve, preventing water to penetrate to the inside of the agglomerate, which prevents complete dissolution. Therefore, the first step is to heat water to 70-80° C. (above the MC dissolution temperature and below water evaporation temperature) and then add the specific content of MC powder gradually while magnetic stirring is underway at 200-800 rpm. Heating and stirring are continued for 30-60 minutes. The beaker can be covered to minimize any evaporation or spillage.

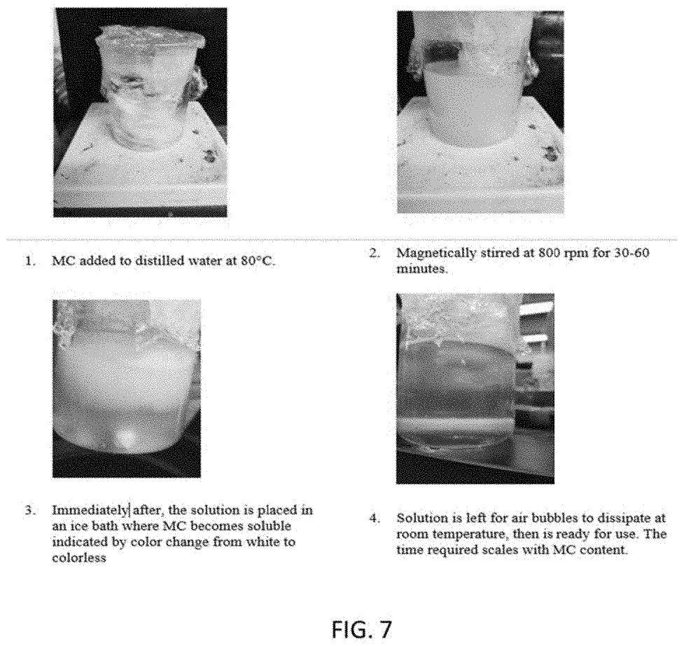

The solution is then immediately transferred to an ice bath to begin dissolution, where stirring is continued to prevent agglomeration until the solution temperature reaches 5° C. The solution during this process shifts from a white color to colorless, indicating complete dissolution. The solution is then sealed and left at room temperature to dissipate the air bubbles accumulated during the last stage, a process that can take up to 2 days without external aid. FIG. 7 shows the steps described. (Any MC solution that is referred to herein is prepared using these steps.)

Admixture Systems

Because there are a number of ways MC and NC can be dispersed and added to cement paste, there are a significant number of combinations to create hybrids. The order in which NC and MC are added can impact their effect on rheology:

NC powder dispersion (dd) with MC powder dry mixed with cement:

Dd is performed on cement first to disperse NC then MC powder is dry mixed with the cement. Water is added as free water.

NC powder dispersion (dd) with MC solution.

Dd is performed on cement first then MC is added as solution. Water can be either added as 100% of the mixing water or at lower percentage maintaining the total MC content in combination with some additional mixing water to meet the target water-to-cement ratio of the concrete mix. Without being bound to any particular theory, the addition of free water is preferable to maximize dissolution of cement; however, attention must be given to the viscosity of the MC solution as critically saturated MC solutions will form gels.

NC Solution with MC Powder Dry Mixed with Cement

MC powder is mixed with cement first then NC solution is added prepared via stirring or sonication. The NC solution can contain 100% of the water or free water in addition to high concentration of NC solution can be used. Solutions with high NC concentrations are more susceptible to deagglomeration.

NC Solution with MC Solution

Hybrid Solution

Dilute MC Solution in NC Solution

Dilution of one solution into the other can be done using magnetic stirring or sonication, as described elsewhere herein. Because sonication utilizes high energy that causes heat generation, which in turn can break the dissolution state of MC. This process is better using magnetic stirring or with short pulses of sonication such as 2 on/5 off or greater.

Dilute NC Solution in MC Solution

Disperse NC Powder in MC Solution

This process replaces distilled water used in magnetic stirring or sonication with MC solution. However, because sonication utilizes high energy that causes heat generation, which in turn can break the dissolution state of MC. This process is better using magnetic stirring or with short pulses of sonication such as 2 on/5 off or greater.

Disperse NC Prior to MC Dissolution

This process takes essentially a NC solution that is prepared using sonication or magnetic stirring as the base solution for MC dissolution described elsewhere herein. In this case, it may be useful to have NC well dispersed when MC powder is introduced into the solution.

Separate Solutions

Adding two solutions at two different stages to the cement. The content of MC and NC in water should be corrected to maintain the overall correct dosages. For example, for every 100 g of cement, 1 g of NC, 1 g of MC and 34 g of water are required. In terms of separate solutions and using 1/1 ratio of solutions, that translates to 1 g of NC in 17 g water and 1 g of MC in 17 g of water.

Dry Dispersion of NC onto MC

The process of dd described herein coats cement particles with NC particles. The same process can be used to coat MC powder with NC particles where the cement is substituted by MC powder. The resulting hybrid powder can then be dry mixed with the cement.

Example Results

To show the efficacy of the hybrid system, we show the results of each of NC and MC systems separately before showing the effect of hybridization. The results herein are from using w/c ratio of 0.34 unless noted otherwise.

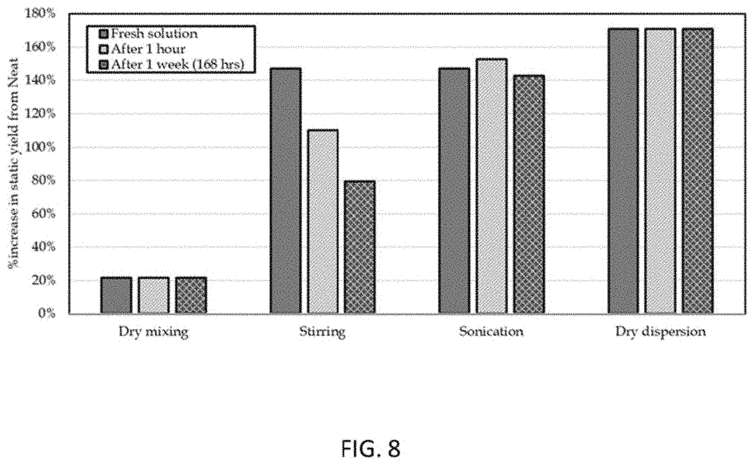

The effect of method of dispersion on the static yield stress of 1 wt. % NC cement paste are shown in FIG. 8. As discussed herein, dry mixing may not in all instances break down agglomerates. On the other hand, all three of the other methods are as effective in dispersing 1 wt. % NC when tested immediately after preparation (labeled “Fresh solution” in FIG. 8). Testing the solution 1 hour after it was prepared and left under controlled conditions, there is a drop in the effect NC for magnetic stirring. This is attributed to reagglomeration of the NC in solution due to low energy used in dispersion. On the other hand, sonication shows no significant difference in the effect of NC on the static yield stress over time. While sonication is an effective way to disperse NC in solution, our results show that further increase can be achieved using dry dispersion. Nanomaterials tend to ultimately reagglomerate when in solution; a behavior that is virtually eliminated when dispersed on solids using dry dispersion.

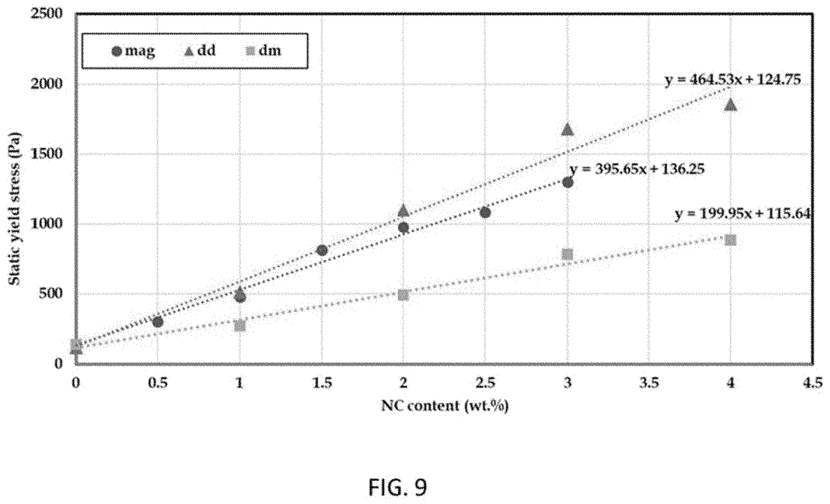

We also compared the efficiency of NC based on the method of dispersion; magnetic stirring (mag), dry dispersion (dd) and dry mixing (dm). Since magnetic stirring and sonication show no differences immediately after solution synthesis, we utilized magnetic stirring to represent solution dispersion via sonication as well. Results of static yield stress, FIG. 9, show that dd has significantly higher efficiency than the other dispersion methods, which becomes more evident at higher contents. Dd also makes higher dosing possible, e.g., 4% is possible via dd but not via dm, without hitting a threshold. As shown, the dd method exhibits particular efficiency and stability.

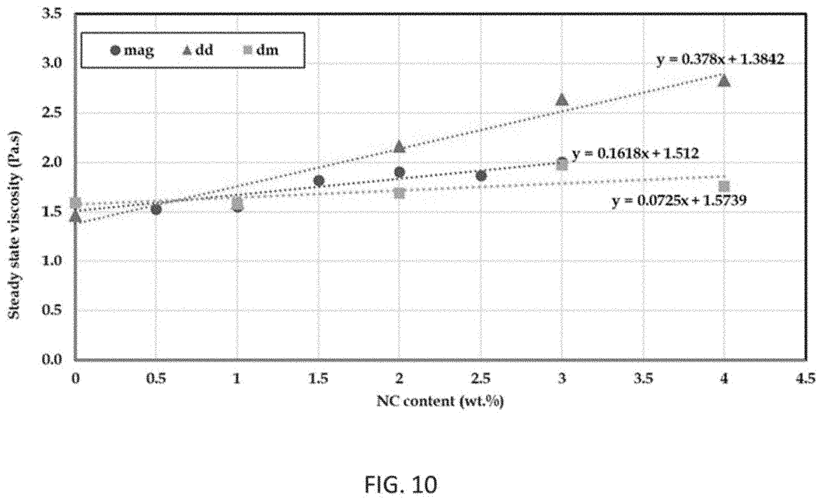

The steady state viscosity was measured for the same cement systems and the results are shown in FIG. 10. At low contents and up to 1.5 wt. %, the increase in viscosity due to the addition of NC is negligible. At contents greater than 1.5 wt. %, there is an increase in viscosity with increase in NC content, which is sensitive to the method of dispersion. Nevertheless, the increase is relatively small compared to the increase in static yield stress. For example, 4.0 wt. % NC added through dd reports the highest increase in viscosity compared to Neat by 93% but with an increase in static yield stress by 1480%. These results support why NC are of significant interest for 3D concrete printing (3DCP), in which the ability to build up is linked to high static yield stress and the ease of flow is related to low viscosity.

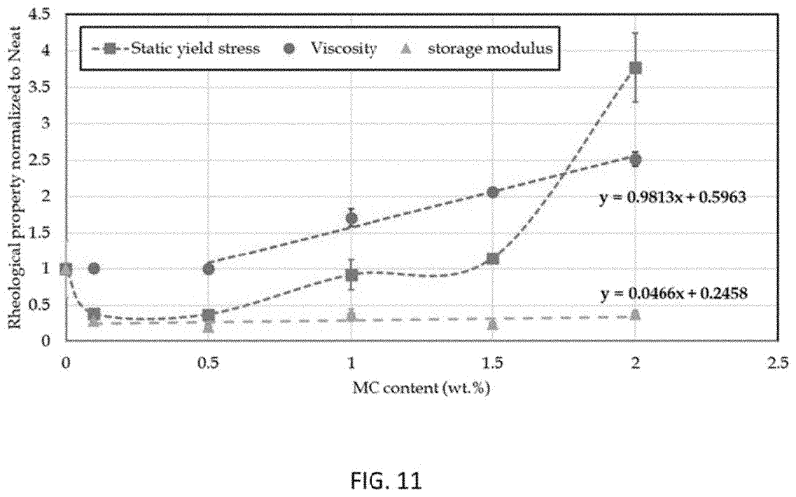

For reference and comparative purposes, we present the effect of MC on cement rheological parameters, i.e. static yield stress, viscosity and storage modulus in FIG. 11. The results show that addition of MC will increase the viscosity proportionally to MC content at 0.5 wt. % or greater. The addition of MC also reduces the storage modulus of cement paste at all dosages. The decrease in storage modulus is attributed to MC adsorption onto the cement paste particles which has been documented by other researchers. The static yield stress of cement paste decreases due to the addition of MC at 0.1 and 0.5 wt. % contents. At 1.0 and 1.5 wt. %, there are no statistically significant differences compared to reference cement. However, there's an exponential increase in static yield stress going from 1.5 to 2.0 wt. % content. This is mainly attributed to the critical overlapping concentration where the MC is in a dilute status at lower contents where the polymer chains act locally compared to a semi-dilute status at 2.0 wt. % content where a network of MC is created.

Rheology—Hybrid Solutions

To study the compatibility between NC and MC, we measured the static yield stress and viscosity. The hybrid mixes utilized NC and MC with contents between 0.1-1.5 wt. % NC and 0.1-2.0 wt. % MC. The hybrids were prepared by using magnetic stirring for NC and dry mixing for MC. This method utilizes the lowest dispersion energy and have been proven to be effective for MC and NC. We also compared this method to other methods and measured the stability of the dispersion by measuring the static yield stress immediately after dispersion, 1-hour after and 1-week (168 hours) after dispersion/synthesis.

Static Yield Stress

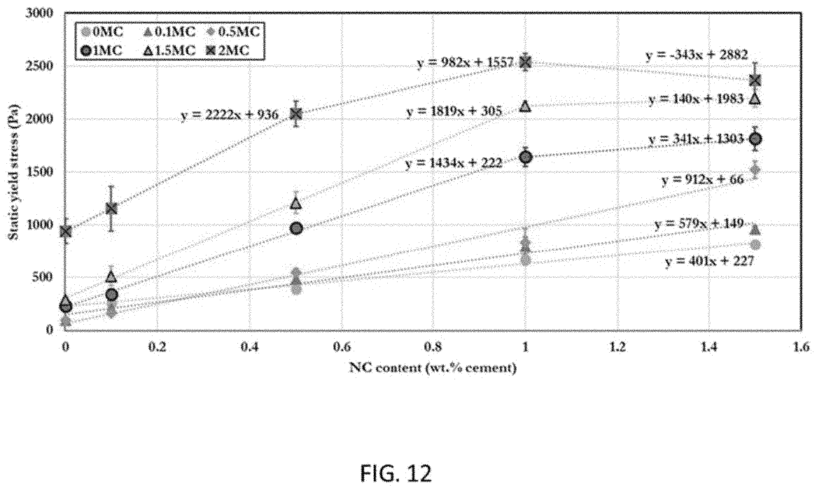

As described herein, the addition of NC increases the static yield stress of cement paste proportionally to NC content up to 4.0 wt. %. We also showed that at 0.1 and 0.5 wt. % MC there's a reduction in static yield stress, insignificant change at 1 and 1.5 wt. % and an increase at 2.0 wt. %. We examine the effect of NC addition at each of the previous MC contents and the results are shown in FIG. 12, where the slopes of the linear regression lines indicate NC efficiency, i.e. increase in static yield stress per 1.0% NC. Systems with only NC show an increase in static yield stress by 401 Pa per 1 wt. % NC content. Hybridization of NC with MC shows an increase in the effect of NC with increase in MC content. It should be noted that static yield stress decreases or plateaus at 1.5% NC with 1.5% MC and 2 MC, which indicates that NC and MC compatibility is maximized in terms of static yield stress within specific ranges. Still, these results show the synergistic effects between NC and MC on static yield stress.

Plastic Viscosity

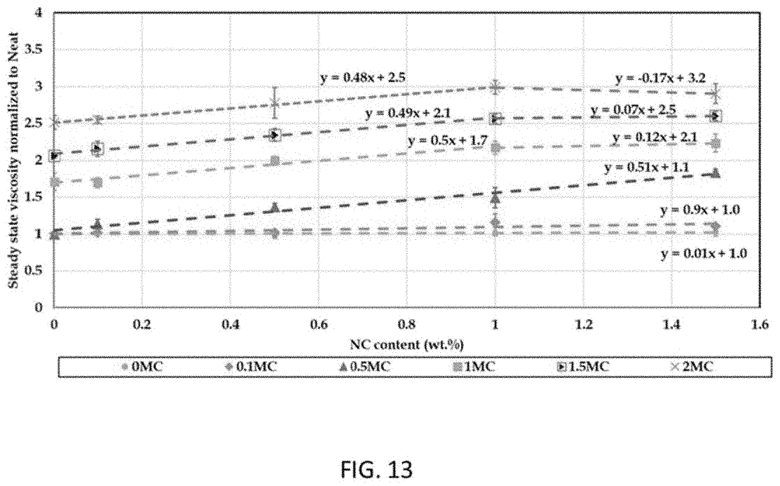

Because the addition of MC increases viscosity, one may wish to characterize the changes in viscosity due to hybridization. This was captured by measuring the steady state viscosity and they are expressed in values normalized with respect to the Neat/reference cement paste in FIG. 13. As discussed elsewhere, systems with only NC show no increase in viscosity up to 1.5 wt. % NC, whereas the addition of MC shows an increase in viscosity at contents greater than 0.5 wt. %. The results show that hybridization of NC and MC results in an increase in viscosity with the increase in NC content when MC content is 0.5 wt. % or higher. The relationship between the increase in viscosity at different MC contents is independent of the MC content, which averages 0.5 Pa·s per 1 wt. % NC content. Similar to the results of static yield stress, a limit of this increase is observed at 1 wt. % NC content or greater when MC content is at 1.0 wt. % or greater. Still, results show that the increase in static yield stress are of significantly greater magnitude than the corresponding increase in viscosity (e.g. at 1 wt. % NC and 1 wt. % MC, the increase in static yield stress and viscosity are 560% and 120%, respectively), showing the potential of this admixture system for 3DCP.

Suspension

TABLE 1
Method of hybridization of 1 wt. % NC and 1 wt. % MC.

| Name | Method of synthesis |
|---|---|
| H1 | 2 wt. % MC solution is prepared via MC |
| | dissolution |
| | 2 wt. % NC solution is prepared via stirring |
| | The NC solution is added to the MC solution via |
| | stirring |
| H2 | 2 wt. % MC solution is prepared via MC |
| | dissolution |
| | 2 wt. % NC solution is prepared via stirring |
| | Each solution is added separately to cement and no |
| | premixing is used |
| H3 | 1 wt. % MC powder is dry mixed with cement |
| | 1 wt. % NC solution is prepared via stirring |
| H4 | 1 wt. % NC solution is prepared via stirring |
| | The NC solution is used in MC dissolution to |
| | create a hybrid solution |
| H5 | 1 wt. % MC solution is prepared via dissolution |
| | Disperse NC powder in the 1MC solution using |
| | sonication |
| H6 | 2 wt. % MC is mixed with cement using dry |
| | mixing |
| | 2 wt. % NC cement is prepared using dry |
| | dispersion |
| | Both cements are mixed at 1:1 ratio |
| H7 | 1 wt. % NC cement is prepared using dry |
| | dispersion |
| | 1 wt. % MC is added to the NC-cement |
| | through dry mixing |
| H8 | 1 wt. % NC cement is prepared using dry |
| | dispersion |
| | 1 wt .% MC solution is prepared using |
| | dissolution |
| H9 | NC are dry dispersed on MC powder using |
| | dd process at 1:1 ratio. |
| | The hybrid powder is added to the cement |
| | at 1 wt. % NC 1 wt. % MC using dm |

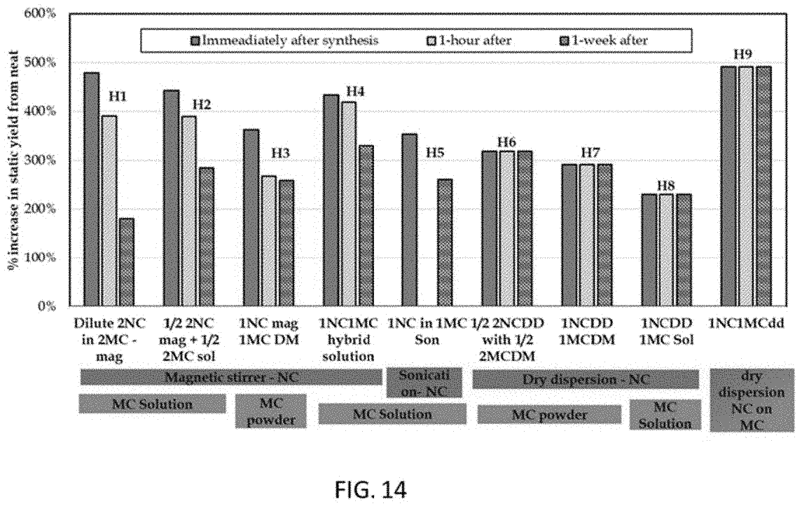

To examine the effect of method of synthesis on the rheological response of cement pastes, we tested for static yield stress immediately after synthesis, one hour after and one week after (168 hours) and the results are shown in FIG. 14. Nine methods of synthesis were utilized as summarized in Table 1. Based on the results herein, there is no significant change in static yield stress at 1 wt. % MC compared with reference cement. Therefore, the stability was measured for 1 wt. % NC with 1 wt. % MC where the increase in static yield stress can be attributed to NC.

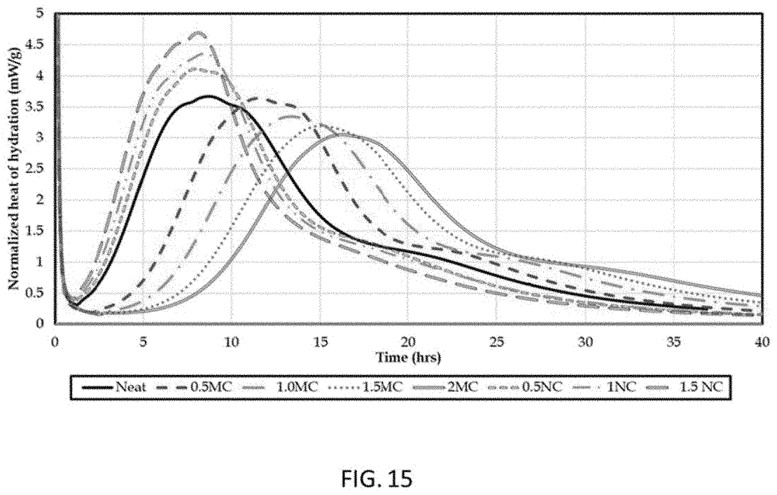

Examining the results immediately after dispersion in FIG. 15, it is seen that the method of synthesis plays a role on the effect of the hybrid system on the cement rheology and specifically static yield stress. H1 and H9 yield the highest increase in static yield stress at 480% and 490%, respectively, compared to H8 at 230%. H9 shows the highest increase in static yield stress where NC are dispersed onto MC. All methods that utilize NC solutions (H1-H5) show higher increase in static yield stress compared to methods that utilize dd on cement (H6-H8). Dd mixes, namely H6-H9, show no time dependency or loss increase in static yield stress. H1 and H2 are the two methods with the highest increase in static yield stress immediately after dispersion within mixes that utilize NC solution. Results show there is at least some dependency on processing method.

The developed admixtures are primarily to control rheological properties. However, we also tested their effect on key concrete properties—hydration kinetics and strength.

The developed admixtures are primarily to control rheological properties. However, we also tested their effect on other properties—hydration kinetics and strength.

Calorimetry

In order to measure the effects of the admixtures on cement hydration, isothermal calorimetry was used to record heat of hydration of cement pastes. Specimen were prepared similarly to how they are prepared for rheology tests of hybrids where NC were added in solution via magnetic stirring, MC were added as powder and hybrids were prepared using a combination of the two. Because NC and MC are added as replacement of cement, some reduction in heat of hydration and delays are expected due to dilution effects that scale with the content. In these calorimetry results, the total heat of hydration (measured by the area under the curve up to 36 hours) is statistically indifferent. And we discuss the effect of NC, MC and combination on accelerating or decelerating hydration, which translates to faster or slower setting, respectively.

To identify the effects of NC only and MC only on hydration kinetics as a baseline, each of the two systems were examined at 0.5 wt. % content increments up to 1.5 wt. % NC and 2.0 wt. % MC. The results are shown in FIG. 15 in comparison with the neat cement paste. The addition of NC generally shows an acceleration that is proportional to the NC content. Mixes that incorporate MC on the other hand showed overall opposite trajectory—reduction in the heat of hydration with increase in MC content and delays in acceleration. These results are similar to other findings, and confirm that possible increase in nucleation/rigidification of NC and the delay in hydration attributed to MC adsorption onto cement.

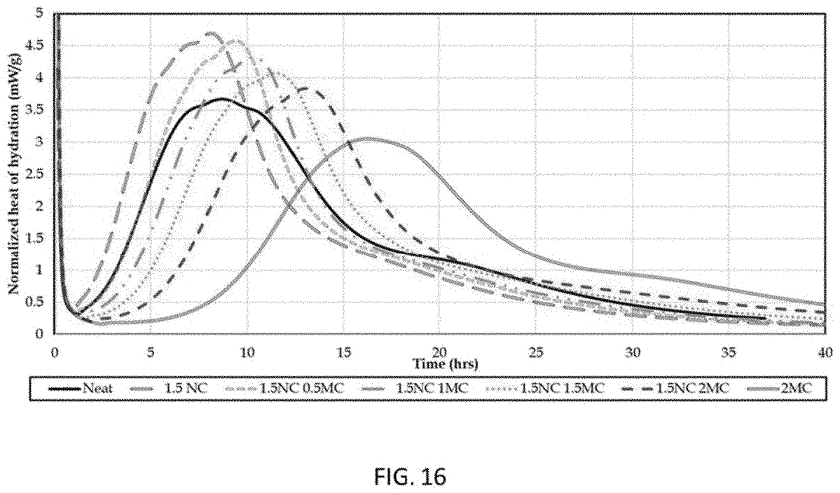

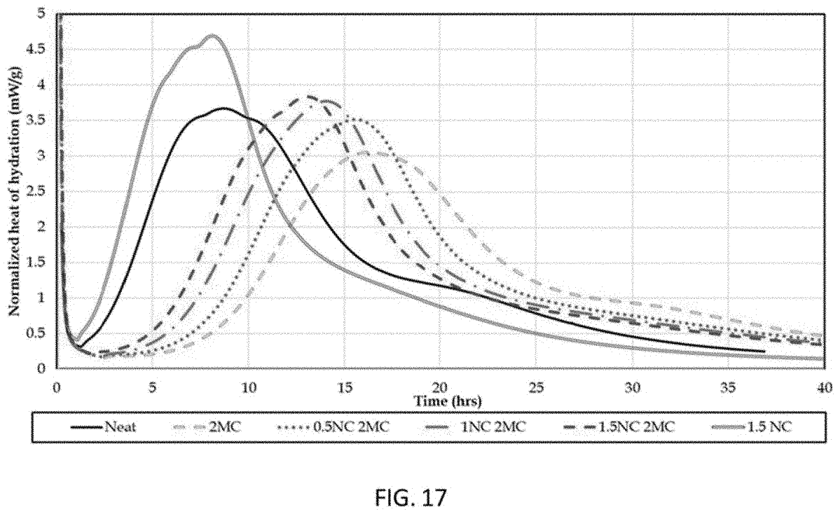

Analysis of the previous results show that the effect of NC and MC on the characteristic hydration kinetics are linear with respect to the content of NC. Thus, in order to understand the effects of hybridization on the hydration kinetics two sets of hybrid systems were tested: i) maintaining the highest content of MC at 2.0 wt. % and varying NC content and ii) maintaining 1.5 wt. % NC content while varying MC content. The heat of hydration of each of these groups are presented in FIG. 16 and FIG. 17, respectively. These results show that the hybridizations mitigate the delays in time to termination and acceleration peaks. The addition of NC increases the heat of hydration proportionally to the decrease caused by MC. In fact, 1.5 wt. % NC and 2.0 wt. % MC has no significant difference from that of Neat. This result is of great significance since as the heat of hydration is preserved despite the replacement of 3.5 wt. % of cement (1.5 wt. % NC+2.0 wt. % MC). Results also suggest that the decrease in heat of hydration caused by 1.0 wt. % MC is 33% lower than the increase in heat of hydration caused by 1.0 wt. % NC. Thus, maintaining a NC:MC ratio of 3:2 or greater ensures that no reduction in heat of hydration will occur.

Mechanical Properties

To test the effect of the rheological admixtures on the mechanical behavior of cement systems, the compressive and flexural strength of cement mortars prepared with NC only, MC only and hybrids of the two were measured at 7 and 28 days. MC were added as dry mixed powders and NC were added as solutions via magnetic stirring. The hybrids were prepared similarly by first dry mixing MC as powder with cement then adding NC as solution via magnetic stirring. In all mixes, the cement paste was prepared first then sand was added to create cement mortar with a sand to cement ratio of 2. For each mix, 6 cubes and 6 prisms were cast using standard 2×2×2 in and 1.5×1.5×6 in molds, respectively. The specimens were air-cured to simulate harsh curing conditions since large applications of 3D printing can't be water-cured. 3 specimens were tested at each age (7 days and 28 days) and the average was taken to be the representative value. Cubes were loaded in compression at 2,000 N/sec and prisms were loaded using three-point bending with a span of 5.5 inches and load rate of 200N/sec. All specimens were prepared using w/c ratio of 0.37 instead of 0.34.

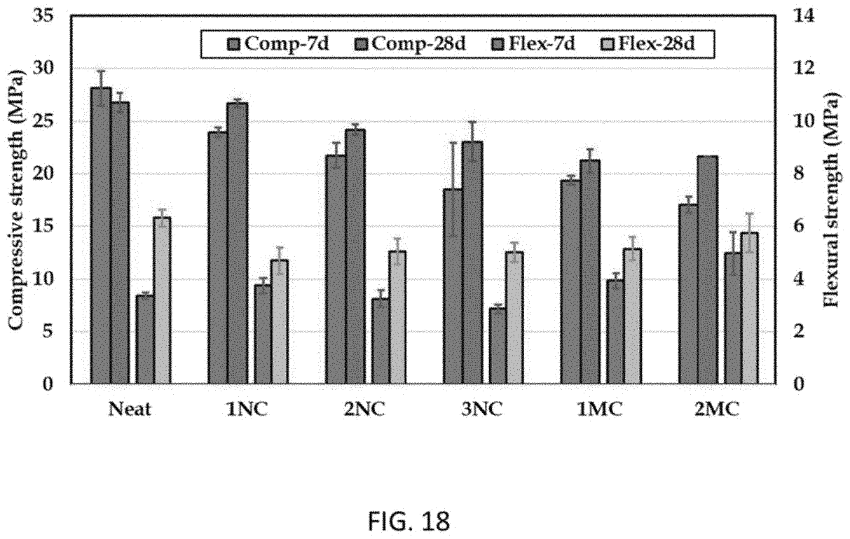

The effect of NC and MC on the compressive strength are shown in FIG. 18. No change in compressive strength of Neat is observed between 7 and 28 days, but an increase in flexural strength by 40% is observed. Without being bound to any particular theory, this may be attributed to air curing that increases water loss leading to potentially increasing porosity. While some curing can be used to mitigate water loss for 3D printed elements, maintaining the required mechanical performance without additional curing ensures that with some curing the critical design strength is achieved. On the other hand, an increase in tensile strength is observed from 7 to 28 days for Neat. Because our admixtures can affect water evaporation, the effects of the admixtures on the mechanical strengths may (again without being bound by any particular theory) be directly linked to the interactions with cement phases and indirectly through the additives' effects on water loss through evaporation.

The addition of NC and MC reduces the compressive strength of cement mortar proportionally to their content by 3 MPa and 5.5 MPa per 1 wt. % content of NC and MC at 7 days strength, respectively. The addition of both NC and MC, however, shows an increase in strength from 7 to 28 days unlike that of Neat. Without being bound to any particular theory, this could be attributed to the improved water retention due to the additives water adsorption properties. Although the addition of both NC and MC results in a decrease in compressive strength at 28 days, the maximum decrease is at 19% from Neat. Furthermore, the decrease in compressive strength at 28 days stays proportional to NC content but is not affected by changing MC content. This could be attributed to the higher static yield stress and stiffness resulting in dry mixtures that are difficult to compact manually. Similar to compressive strength, a reduction in flexural strength is observed with the addition of only either MC or NC. Although some increase is observed between 7 and 28 days strength, only 2MC shows insignificant decrease from that of Neat. Nevertheless, the decrease at 28 days remains under 11% from that of Neat.

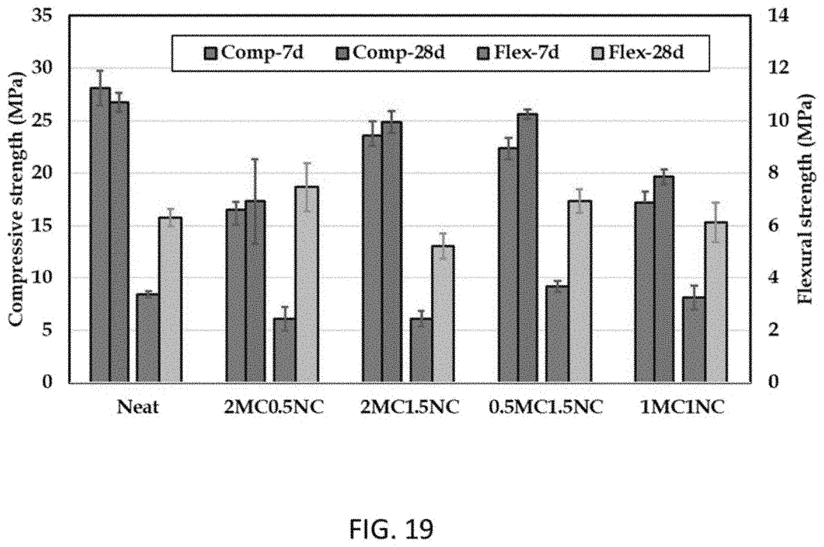

To test the effect of hybridization, we selected four hybrid mixes: 2MC0.5NC, 2MC1.5NC, 0.5MC1.5NC and 1MC1NC, shown in FIG. 19. We show the effect of changing NC from 0.5NC to 1.5 NC when MC content is at 2.0 wt. % content by comparing 2MC0.5NC and 2MC1.5NC, and the effect of changing MC from 0.5 to 2NC when NC is at 1.5 wt. % content by comparing 2MC1.5NC and 0.5MC1.5NC. 1MC1NC is also picked since the method of hybridization was characterized for that mix. Because the effects of NC and MC on cement systems is linear with regard to hydration kinetics and mechanical strength, the relationship of MC and NC content on the mechanical strength can be extraploated with good level of confidence. Comparing 2MC0.5NC and 2MC1.5NC, it can be seen that the addition of 0.5 NC is not sufficient to compensate for the decrease in compressive strength at either 7 or 28 days. In fact, 2MC0.5NC is statistically indifferent from 2MC. Similarly, no significant differences in flexural strengths at 7 days are observed between 2MC0.5NC and 2MC1.5NC. However, at 28 days, further addition of NC from 2MC0.5NC to 2MC1.5NC results in a significant decrease in flexural strength. In fact, 2MC0.5NC is the only mixture exhibiting an increase in flexural strength compared to Neat. On the other hand, the addition of 1.5NC to 2.0MC shows significantly increased compressive strength from 2MC by 39%.

Comparing 2MC1.5NC with 0.5MC1.5NC, reducing MC content from 2.0 to 1.5 wt. % shows no statistically significant difference in compressive strength. In fact, both 2MC1.5NC and 0.5MC1.5NC show no statistical difference with respect to 1NC and 2NC. This can be attributed to the effect of NC in mitigating the loss of heat of hydration, as discussed in the previous calorimetry section. The decrease in MC content from 2MC1.5NC to 0.5MC1.5NC on the other hand reflects positive increase in flexural strength at both 7 and 28 days. At the lower MC dosage of 0.5MC combined with 1.5NC, the flexural strength at both 7 and 28 days are statistically indifferent to that of Neat. On the other hand, the addition of 1NC to 1MC seems insufficient to reverse the adverse effects of 1MC on compressive strength as 1MC1NC shows no statistical difference from that of 1MC but reverses the decrease in flexural strength resulting in strength values that are similar to that of Neat. Examining the results at 28 days of all hybrids, one may discern that the effects of NC on the compressive strength development are proportional to NC content. Mixes containing 0.5 wt. % NC show the lowest increase followed by 1.0 wt. % NC then 1.5 wt. % NC. At 28 days, both 2MC1.5NC and 0.5MC1.5NC show statistically insignificant difference compared with Neat in regards to compressive strength. Furthermore, all hybrids show good flexural strengths comparable to that of Neat. The decrease observed at 2MC1.5NC represents only 15% reduction.

These mixes offer substantially improved rheological properties for 3D printing as well, especially 0.5MC1.5NC as it produces the maximum increase in static yield stress of 515% and only 80% increase in viscosity when compared with Neat. Compared to ordinary 1.5 NC mix, the static yield stress of the hybrid is 80% higher.

Dry Dispersion

As discussed, dd can produce the highest efficiency and longest stability of NC dispersions. Here, we examine the state of dry dispersed NC on cement particles through SEM and expand this method to other nanomaterials: graphene nanoplatelets, alumina nanoparticles, silica nanoparticles and calcium carbonate nanoparticles.

The effects of NC interactions on cement paste, especially its rheological behavior, are unique to NC. The degree of influence of the nanomaterial, targeted property, or added functionality are dependent on their physical and chemical properties. However, it is expected that for any nanomaterial type and application, enhanced dispersion leads to enhanced performance. Because of the geometry of nanomaterials, the surface area of few grams of nanomaterials when well-dispersed can exceed the surface area of cement. This can, in some instances, yield some level of clustering or agglomeration where multiple nanomaterials are present at the same location.

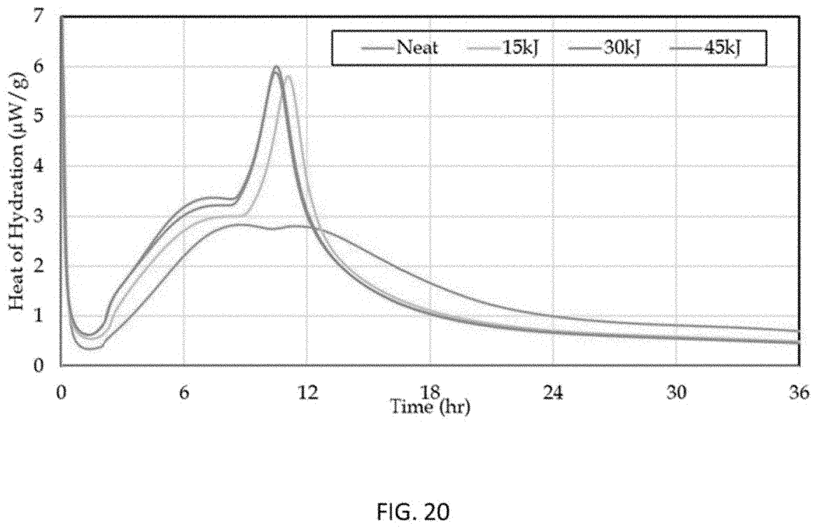

In order to ensure that the dispersion energy utilized in the description earlier is suitable for other nanomaterials, we tested the heat of hydration of cement paste at 0.46 w/b with 4 wt. % SNP at 15, 30 and 45 kJ/g for the step when the sonication is applied when the cement is added while maintaining 10 kJ/g for the first step. The results of heat of hydration are for all mixes are shown in FIG. 20. While some differences may appear between all three energy levels, especially when between 15 kJ and higher energies, those differences remain within the instruments accuracy interval and can be considered insignificant. In order to ensure that all cement had similar processing history, the 30 kJ/g was maintained for all applied dry dispersion mixes. A simple test (e.g., calorimetry) can be used to determine the minimum sonication energy in each step required to successfully disperse any nanomaterial of interest.

Nanoclays

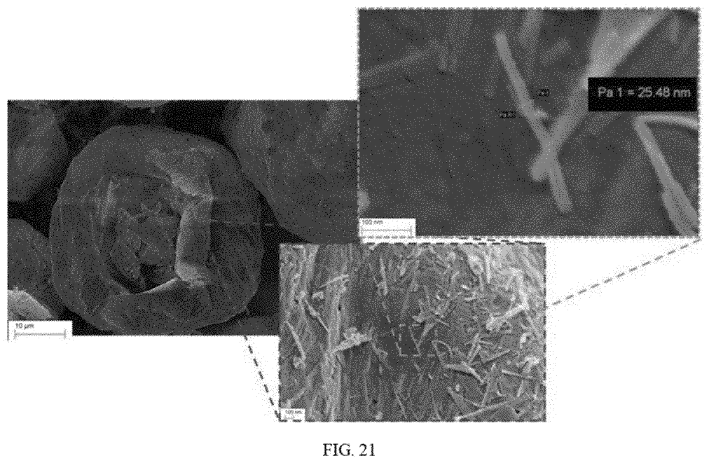

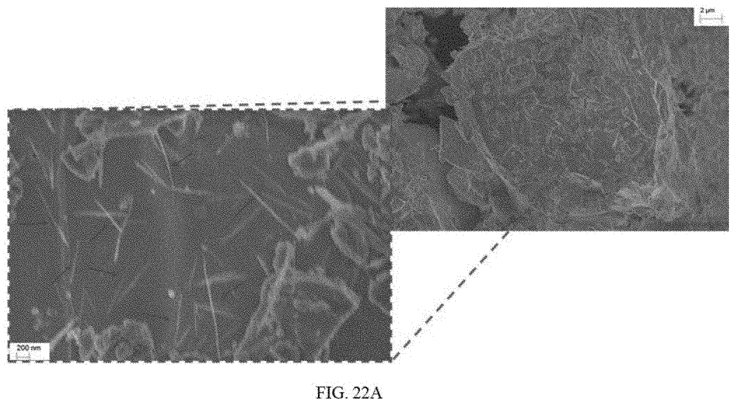

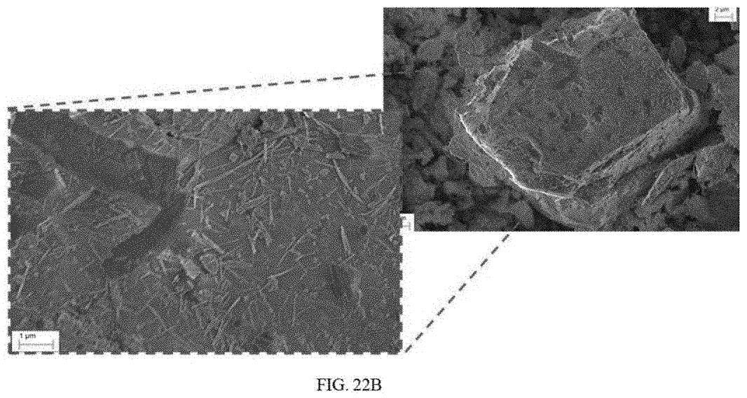

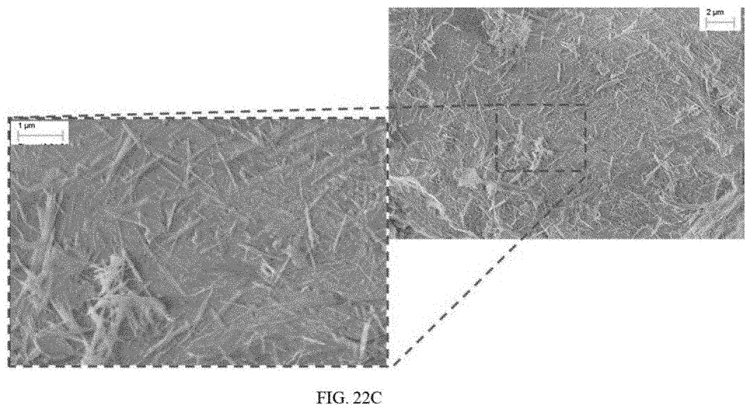

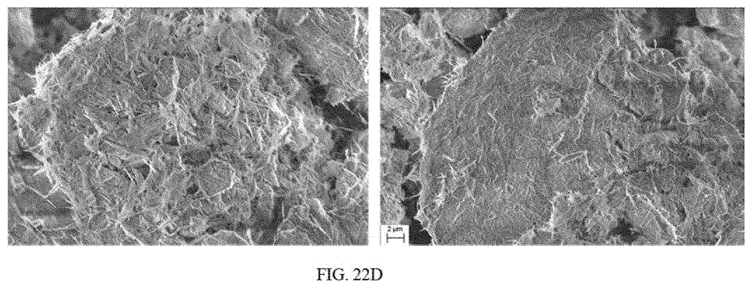

SEM scans of nano-coated cements were collected for all the different nanomaterials. FIG. 21 shows NC in their agglomerated state. In this figure, the spherical agglomerate of NC consists of multiple NC needles such as the one shown in the close-up. FIGS. 22A-22D show the surface of dd cement coated with NC particles at 1, 2, 4 and 10 wt. % replacement of cement. Regardless of the content, the surface of cement is well coated with all NC needles. At lower contents such as 1 and 2 wt. %, single needles are observed in the coating. At higher contents such as 4 and 10 wt. %, the cement surface is nearly entirely covered with NC, and clustering and small agglomerates are observed. However, there agglomerates appear to be of lower density than that observed in FIG. 21.

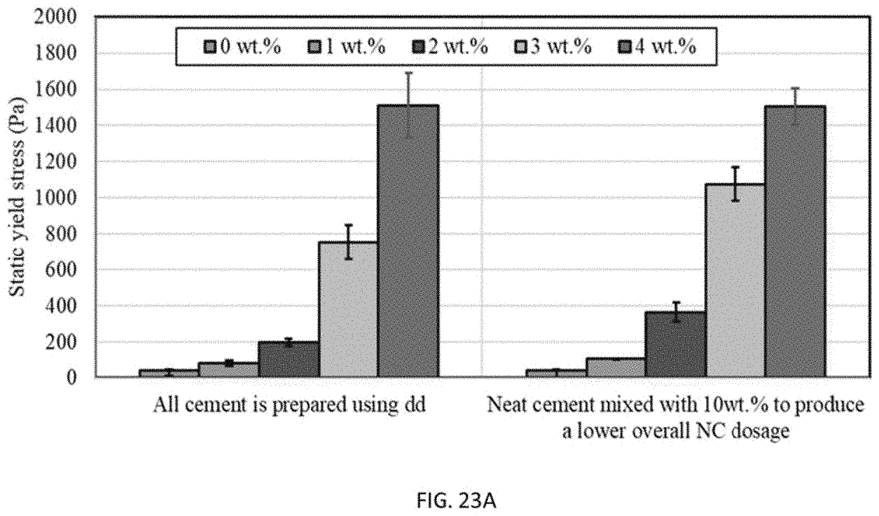

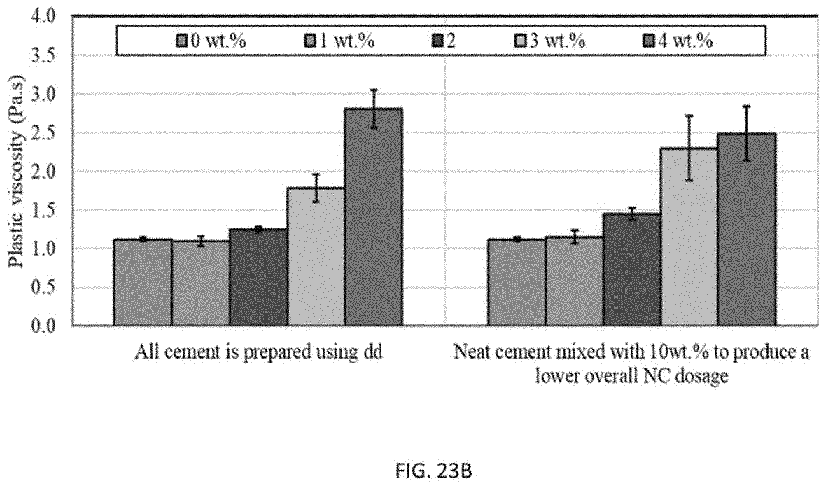

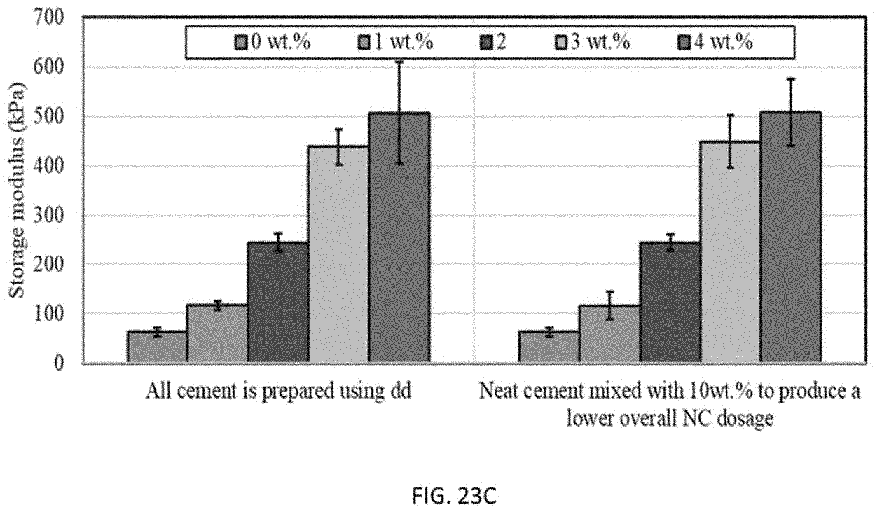

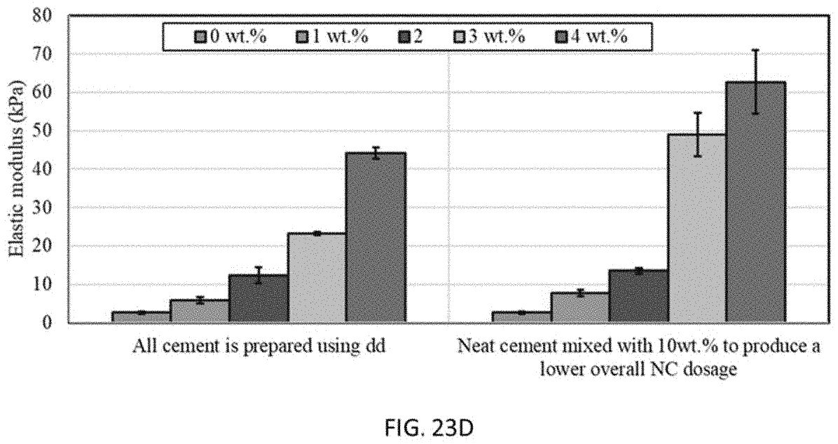

As discussed, dd achieves the maximum increase in static yield stress per NC content for any dispersion method studied in this report. However, dd can also be argued to be of limited scalability if desired at high quantities, as processing can be lengthy and energy intensive. Therefore, we explored the potential of utilizing concentrated systems by mixing high content NC dd cement with plain cement (versus using NC dd cement only with a lower NC concentration) to reach a target NC content. That is, while maintaining the overall NC dosage by weight of cement, we examined the rheological properties of cement paste when NC are used to coat all cement particles versus when NC are used to coat only part of the cement content and the rest of the cement is left uncoated/untreated. To best test this, we examined producing 1, 2, 3 and 4 wt. % contents of NC by mixing 10, 20, 30 and 40% of cement with 10 wt. % NC coatings and the results are shown in FIGS. 23A-23D. In cases where less than 100% NC dd cement was used, the supplementary plain cement is processed dd cement to exclude the effects of the reduced particle size of dd cement.

The results show that the effective dosage of NC, regardless of the percentage of NC dd cement amount used, maintains the same rheological properties or show further enhancement in static yield stress or elastic modulus when some of the cement is uncoated. Without being bound to any theory, these results suggest that dd can be utilized as a partial replacement of cement to minimize cost while maintaining the benefits of increased efficiency. It also allows utilizing different mixes of dd cements with other nanomaterials, such as the ones discussed in the following section.

Dry Dispersion Other than Cement

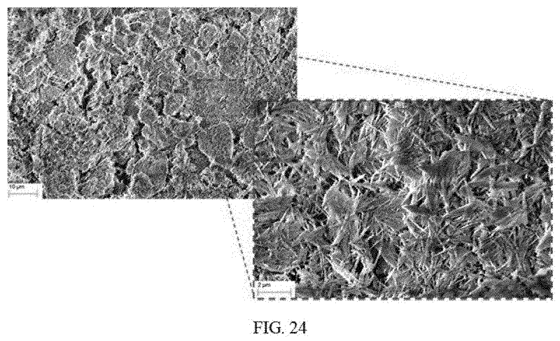

To negate the effects of dd on cement, the same dd process on cement can be used but replacing cement with MC to create hybrid nanomodified polymer powder. This results in nanocoated MC polymers such as the one shown in FIG. 24. Elsewhere, we showed that H9 had the highest efficiency of all the hybridization methods at 1NC:1MC ratio. The hybrid nanocoated MC powder can be added to cement simply through dry mixing techniques that typically results in significantly lower efficiency. This method is useful for industrial application in which the energy required to create nanocoated MC powder is significantly lower than the one used for coating cement since MC is used as 2 wt. % cement content or less.

Other Nanomaterials

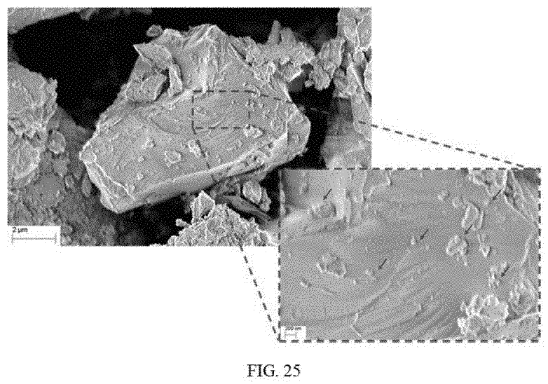

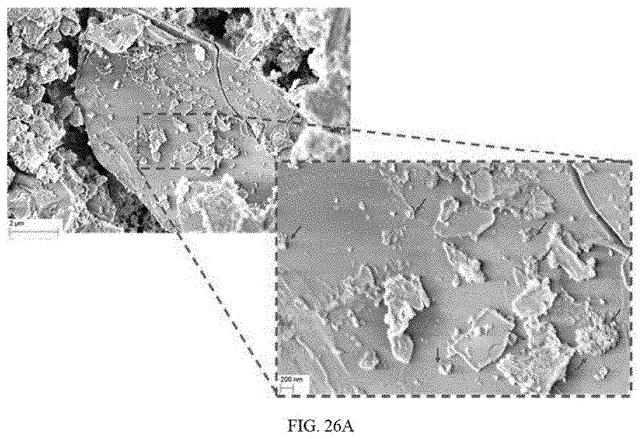

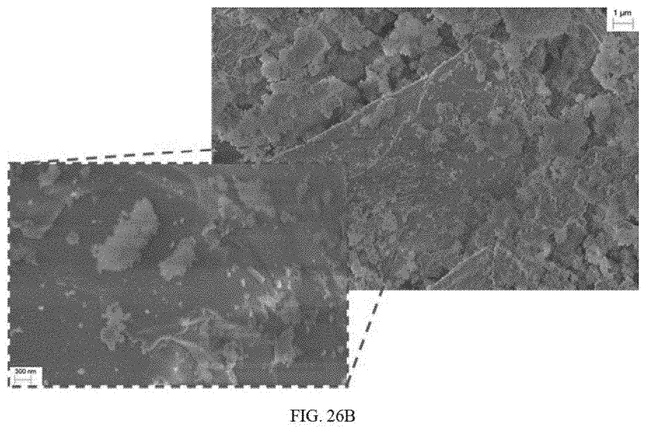

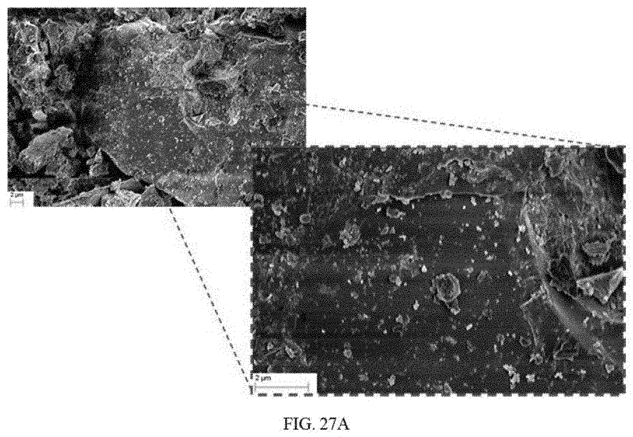

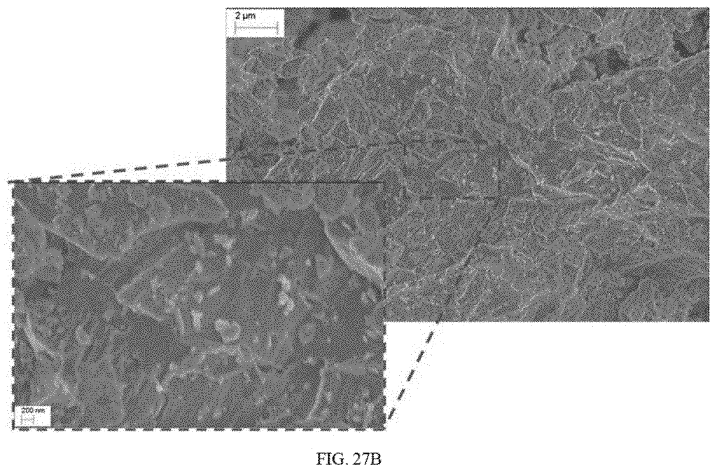

Dd was used to coat cement with other nanomaterials: alumina nanoparticles (ANP), silica nanoparticles (SNP) and calcium carbonate nanoparticles (CCNP), which are 15-20 nm spherical nanoparticles, and graphene nanoplatelets (GNP) with 3-14 nm thickness and length and width <2 μm. These particles are often hard to uniformly disperse at high contents in cement paste due to their extreme small size and high rate of reagglomeration. FIG. 25-FIG. 28 show nano-coated cements with ANP, SNP, CCNP and GNP at different dosages, respectively. In all these examples the dd process was successful in breaking down the nanomaterials' agglomerates and deagglomerating cement to allow the adsorption of nanoparticles onto the cement surface. In fact, up to the authors knowledge, this method of dispersion is the only method that allows examining the dispersive state of nanomaterials with cement prior to hydration. Such is very useful to characterize and study the nucleation effects and the formations of cement hydrates with various nanomaterials through real-time SEM scanning.

Furthermore, one of the most challenging nanomaterials to disperse with cement are GNP. To create a stable GNP solution suspension, the GNP must be functionalized, a dispersion agent must be used or, often, a combination of the two. Dd is unique it which non-functionalized GNP coat the surface of the cement. This offers the potential to create tailorable conductive cement products that can be used as smart self-sensing materials, in which the mechanical stress and damage can be evaluated by recording the changes in conductivity. It should be understood, however, that other conductive materials besides GNP can be used, e.g., carbon nanotubes, carbon black, other carbonaceous nanoparticles, and the like.

Electrical Conductivity

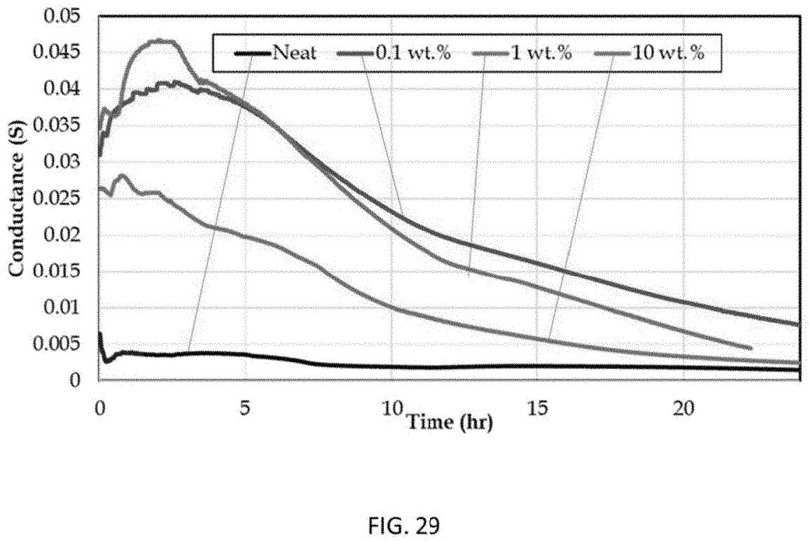

One of the most challenging nanomaterials to disperse with cement are GNP. To create a stable GNP solution suspension, the GNP must be functionalized, a dispersion agent must be used or, often, a combination of the two. Dd is unique it which non-functionalized GNP coat the surface of the cement. This offers the potential to create tailorable conductive cement products that can be used as smart self-sensing materials, in which the mechanical stress and damage can be evaluated by recording the changes in conductivity or capacitance. The increase in conductivity with GNP through dd has been measured with cement paste in its fresh state at as little as 0.1 wt. % dosage as shown in FIG. 29. Further increase in GNP did not translate to an increase in conductance at fresh state but increases thein capacitance.

Heat of Hydration

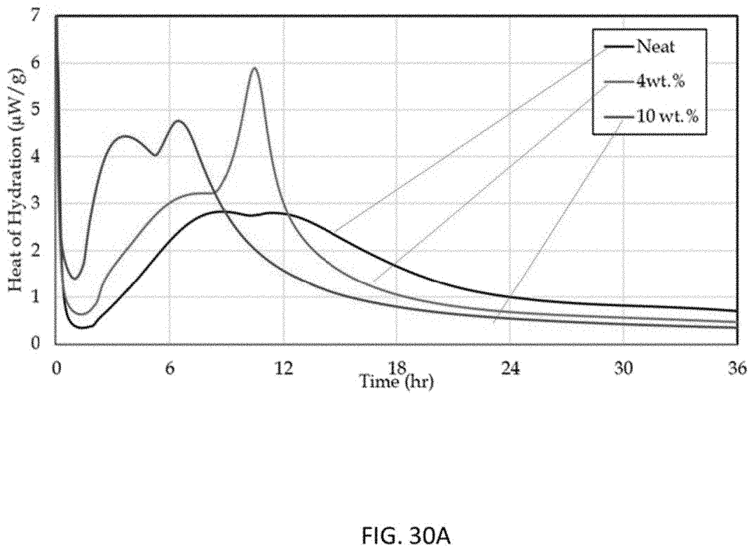

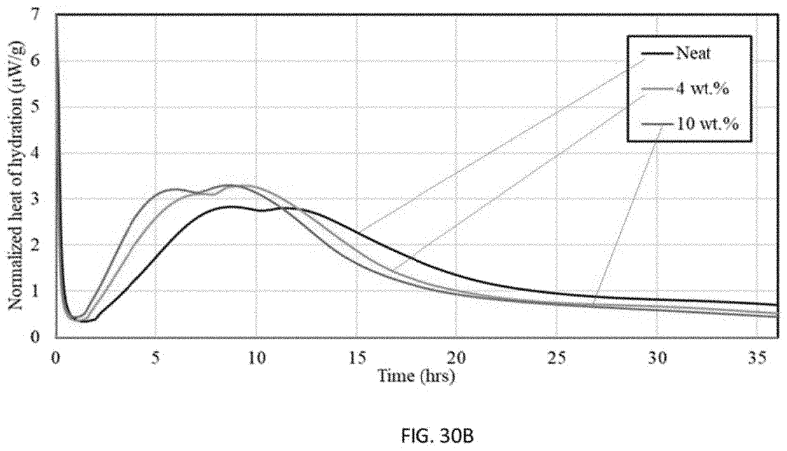

Both SNP and CCNP are nanoparticles that are used in cement applications to promote hydration and improve the mechanical performance. In order to check this, we looked at the heat of hydration via calorimetry of cement paste at 0.46 w/b ratio containing 4 and 10 wt. % replacement of cement and the results are shown in FIG. 30. Despite replacing a big portion of the cement, both nanoparticles promoted hydration through an increase in the heat of hydration during acceleration and a shortening of the induction period. Since both nanoparticles have similar geometries, the difference in heat of hydration observed especially the effects on the C₃A peak are a result of the differences in nanoparticles' chemistry.

Mechanical Performance

In order to measure whether the dispersion of nanomaterials on the surface of cement at high content result in different mechanical performance than when nanomaterials are dispersed in solution, we tested the compressive and tensile strength of mortars at 4 wt. % of SNP, CCNP and NC prepared via sonication and dry dispersion. The compressive strength was measured by the crushing of standard 2 in cubes at 2000 N/sec. The tensile strength was determined through split tension test (also known as Brazilian split tension) for 2 in diameter and 4 in height cylinders at 1.4 MPa/min. Sonicated solutions were used immediately after sonication and all nanomaterials were dispersed without any surfactants or stabilizers. Due to the high static yield stress of mixes with 4 wt. % NC, the w/b ratio examined was raised to 0.46 to produce workable slurries without the use of superplasticizers.

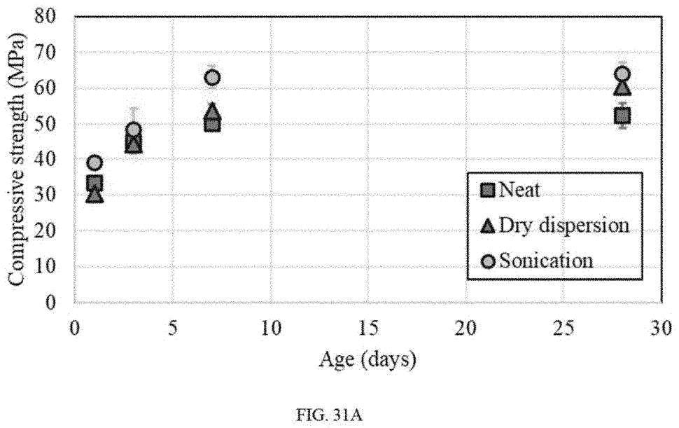

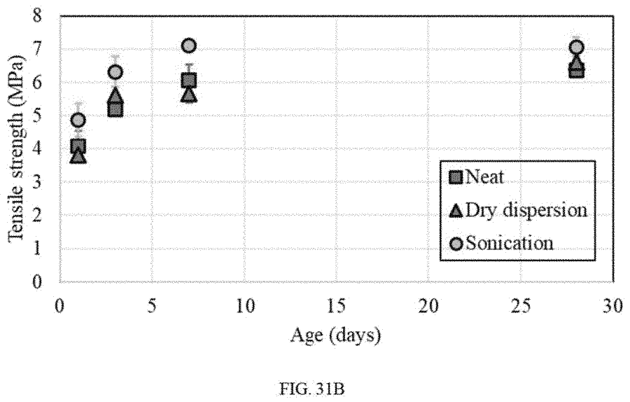

The compressive and tensile strength of mortars prepared at 4 wt. % SNP are shown in FIG. 31. The results show that the addition of SNP can increase the compressive strength of cement mortar at 28 days. More notable, addition of SNP via sonication enhances the strength development rates of both compression and tension where the 28 days strength is reached at 7 days. Specimens prepared via dry dispersion show lower strength development rate than that of sonication but similar 28 days strengths.

Similarly to specimens prepared with SNP, specimens containing CCNP show some improvement in tensile strength at 28 days with insignificant differences in compressive strength. The tensile strength development rate with sonicated CCNP shows similar increase where the 28 days strength was reached at 7 days. All specimens prepared with sonication showed similar or improved mechanical performance regardless of testing age to that of Neat. On the other hand, some adverse effects on the mechanical performance are observed when CCNP are dispersed using dry dispersion. The compressive strength at 28 days however is similar to that of Neat and the decrease in tensile strength is lower than 10%.

Significant decrease in compressive strength is observed due to the addition of NC at 4 wt. % regardless of dispersion method. As indicated in the prior section, addition of NC at contents greater than 1 wt. % result in a reduction in compressive and tensile strengths. The decrease in compressive strength however is much more significant in sonication compared to dry dispersion. The decrease is attributed to the high water adsorption causing the mixture to be excessively stiff resulting in larger air voids and higher porosity. When preparing all mortars with NC, additional compaction was applied compared to the specimen with SNP and CCNP to reduce all voids. Because of the increased porosity due to the mix's dryness, the reduction in tensile strength could be considered critical at 50% compared to that of Neat at 28 days. On the other hand, the compressive strength using dd is only 13% lower than that of Neat. Thus, while the addition of NC is unfavorable for mechanical performance, addition of NC using dd shows better performance than with sonication which increase this method's desirability for concrete 3D printing. Furthermore, as explored in the previous section, the addition of MC to NC can mitigate the excessive dryness and can result in an increase in tensile strength.

Printing Performance

A 60 mL syringe gantry 3D printer is used to produce prints with cement paste incorporating 1.0 wt. % NC with 1 wt. % MC where NC are added as magnetically stirred solution and MC as dry mixed powder. The syringe has a 14-gauge dispensing straight stainless steel needle with an inner diameter of 1.6 mm. Printing layer height varies based on geometry and is in the range of 0.8 mm to 1.5 mm. The gantry speed is set to 800 mm/min during printing and a plunger is used to apply force for extrusion. The gantry system has a printing area of 250 mm×250 mm and vertical height of 100 mm. Printing codes are either manually generated or automatically using commercially available software; Simplify3D.

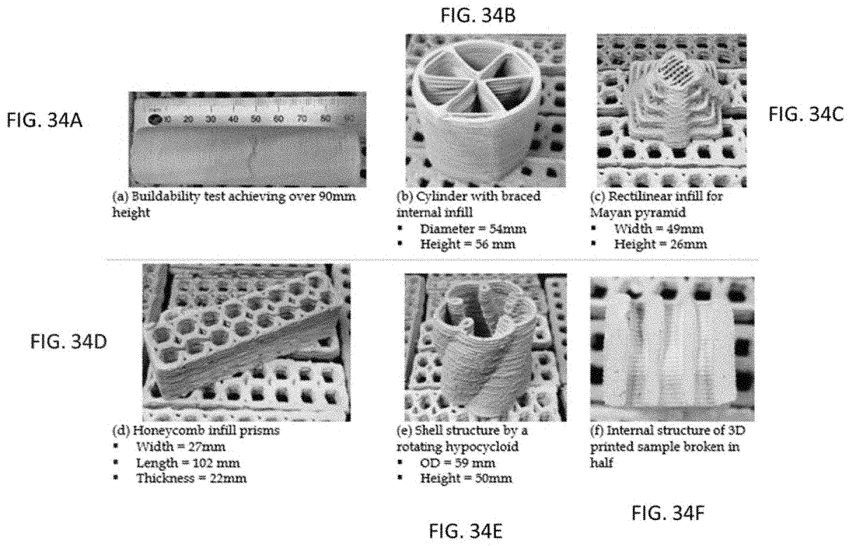

The printing performance of our proposed hybrid system is demonstrated here through a buildability test and producing multiple complex items, as shown in FIG. 34. Buildability is assessed through measuring the maximum achievable height before deformation, where deformation is caused by insufficient rheological properties and not by structural instability such as buckling or thin walls. The result shown in FIG. 34A achieves a maximum height of 92 mm using 1.2 mm layer thickness. (The buildability test must be stopped after 92 mm as that is the maximum height of the gantry system and maximum volume of the syringe.) To prevent thin wall collapse, the cylinder used in buildability has similar internal structure as the enlarged cylinder shown in FIG. 34b.

FIG. 34 shows a miniature of a Mayan pyramid prepared using Simplify3D to demonstrate the applicability of commercial 3D printing software. FIG. 34F shows an example of honeycomb infill pattern producing prisms suitable for flexural testing while FIG. 34F shows an example of a continuously rotating structure with layer height. One may note that the vertical component of many of these prints are limited due to the limited volume of the syringe printer used. Finally, FIG. 34 exposes the cross-section of prints, showing no signs of striation internally as evidence of good bonding in this printing scheme.

Application of MC and NC to MgO Binders

In order to characterize the effects of the NC and MC as a rheological additive for 3D printing, we tested the mixture of NC and MC at different dosages for pastes prepared with MgO at 0.9 and 1.1 w/b ratios. Because of the finer particle size of the MgO powder, the w/b ratio needed for hydration is significantly higher than that of portland cement. As a result, we examined higher NC and MC dosages. To characterize the rheological properties, we examined the static yield stress, plastic viscosity and elastic modulus of fresh paste. We also examined the application of NC and MC on the print quality maintaining similar values of static yield stress.

Rheological Properties

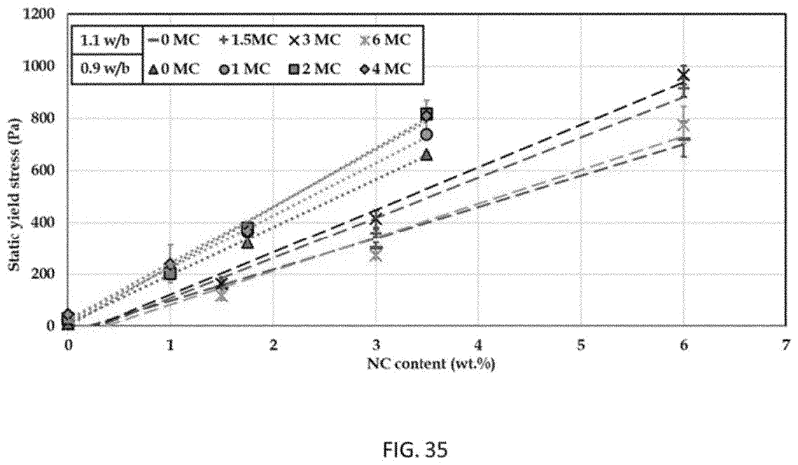

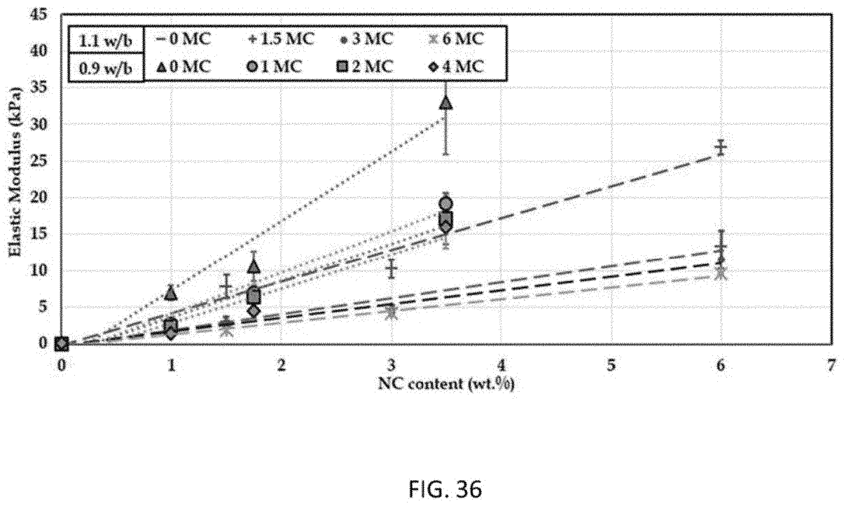

MgO paste at 1.1 and 0.9 w/b ratios has a significantly low static yield stress of 2.4 and 10.4 Pa, respectively. In fact, at such low values, the MgO paste can be considered zero yield stress suspensions reflecting significantly weak colloidal network and forces. Addition of NC increases the static yield stress of MgO paste at 1.1 and 0.9 w/b ratios proportionally to NC content by 120 and 184 Pa per 1 wt. % NC, respectively as shown in FIG. 35. Thus, transforming a non-yield stress paste into high yield stress paste that is suitable for 3D printing. Addition of MC alone increases the static yield stress at much lower efficiency of 1.3 and 9 Pa per 1 wt. % MC for 1.1 and 0.9 w/b ratios, respectively. Addition of MC to MgO paste with NC shows overall higher increase in static yield stress than NC alone. However, the increase compared to NC alone is not significant to warrant the use of MC to increase the efficiency of NC in increasing the static yield stress.

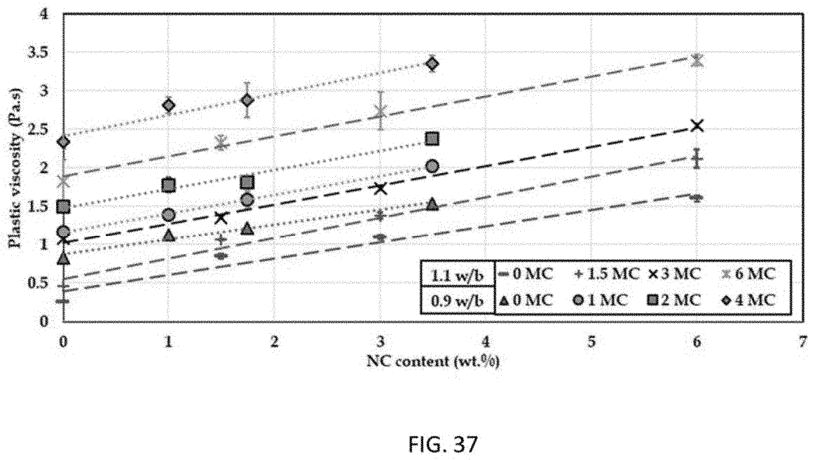

The increase in static yield stress due to the addition of NC causes significant stiffening of the colloidal structure leading to an increase in the elastic modulus proportional to NC content as shown in FIG. 37. The increases in elastic modulus at 1.1 and 0.9 w/b ratios are 9.5 and 4.4 kPa per 1 wt. % NC content, respectively which are of few orders of magnitude higher than the increase in static yield stress. Addition of MC with NC it has lower increase in elastic modulus per 1 wt. % NC content by 47% and 57% for 1.1 and 0.9 w/b ratio, respectively and irrespective to MC content. Addition of MC alone to MgO paste show insignificant differences to the elastic modulus reflecting the weak colloidal structure of the neat MgO pastes.

The plastic viscosity of neat MgO pastes at 1.1 and 0.9 w/b ratios have 0.83 and 0.26 Pa·s values, respectively as shown in FIG. 37. Addition of NC alone increases the plastic viscosity of MgO paste by 0.2 Pa·s per 1 wt. % NC irrespective of w/b ratio whereas addition of MC alone increases it by 0.27 and 0.38 Pa·s per 1 wt. % MC for 1.1 and 0.9 w/b ratios, respectively. Addition of MC into NC increases the effect of NC on viscosity to 0.25 Pa·s per 1 wt. % NC. While an increase in viscosity in generally unfavorable for 3D printing, the addition of cellulose ethers such as MC enhances consistency and cohesion. Pastes at the highest viscosity of 3.5 Pa·s were still extrudable using the printer system used in this study. Furthermore, the effect of NC and VMA on viscosity are marginal compared to the increase in static yield stress where the rate of increase per 1 wt. % NC in static yield stress is 62 and 38 times that of viscosity at 0.9 and 1.1 w/b ratios, respectively.

Printing Performance

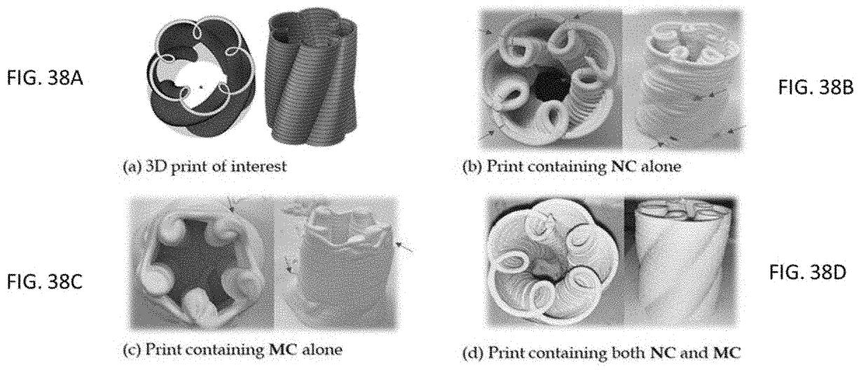

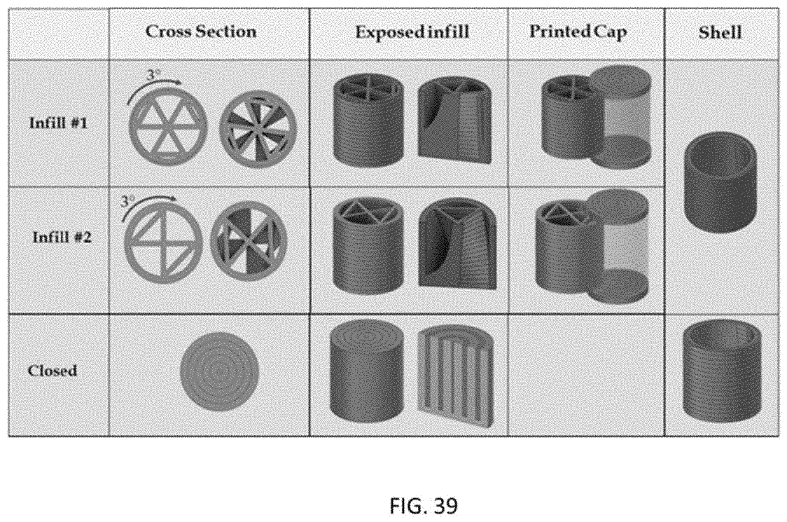

To test the corresponding NC and MC effects on print quality, a rotating spirograph structure shown in FIG. 38A was printed using different doses of only NC, only MC or the combination of both. FIG. 38B shows the print at 0.9 w/b and 3 wt. % NC showing several errors due to filament tearing and splitting due to stiff filaments as recorded in the measurements of elastic modulus. On the other hand, the print produced at 1.1 w/b and 6 wt. % MC in FIG. 38C shows that using only MC yield very soft filaments that cannot maintain shape complexity as well as poor buildability. The mixture of 3 wt. % NC and 1.5 wt. % MC at 1.1 w/b shown in FIG. 38D shows high print quality maintaining complexity and buildability without any filament tearing or splitting. Thus, while the addition of MC may be unfavorable rheologically due to the increase in viscosity without an increase in static yield stress, the effects of MC addition on print quality and integrity are critical. The improved performance could be linked to the increase in viscosity which is often an indicator of increased cohesion as well as the reduction of elastic modulus producing less stiff mixtures.

After rheological characterization, a static yield stress of 360 Pa was chosen to meet the printing requirements to produce 1″×1″ cylinders. The corresponding NC and MC dosages to achieve the static yield stress for 1.1 and 0.9 w/b were 3 wt. % NC+1.5 wt. % MC and 1.75 wt. % NC+1.0 wt. % MC, respectively. Cast specimens were prepared with and without additives in 1″×1″ cylindrical molds and demolded after 24 hours. 3D printed specimens were printed using a syringe gantry system with layer height and width of 1.55 mm. A minimum of four specimens were prepared for each test and all specimens, cast and 3D printed, were covered in plastic for the first 24 hours to mitigate water evaporation. After 24 hours, carbon cured specimens were placed in a CO₂ incubator at 20% CO₂, 25° C. and 80±5% relative humidity (RH). Control specimens were cured at similar ambient conditions at 25° C., 80±5% (RH) and ambient CO₂ (˜0.041%). Printing was performed via a syringe gantry printer with nozzle inner diameter of 1.55 mm and movement speed of 40 mm/sec. One open and one closed infill pattern were chosen to investigate the impact of printed CO₂ delivery channels. The open infill provided four delivery channels whereas the closed infill was made of concentric circles and intended to mimic cast specimens. Additionally, capped open infill specimens where the top and bottom layers are replaced by closed infill layers were printed to investigate whether CO₂ penetration of one layer thickness is sufficient to mimic fully exposed internal structure. A second open infill specimen set with six channels was introduced to examine the effect of exposed infill pattern on the compressive strength with similar capped and uncapped profiles. To ensure that any strength differences between open and closed infills are due to increased carbonation of the interior elements, the shells (without any infill) were printed and tested as well. The exposed infill shell has an average 2.85 mm thickness whereas the closed infill shell has an average 3.1 mm thickness. The differences in thickness are caused by different line overlap parameters to achieve the required geometries. Up to twelve specimens were prepared for each specimen type and the results reported are the average of minimum of four specimens. For sample sizes greater than four, sampling was held at one standard deviation from the population.

Cast-in and Role of Admixtures and Carbon Curing

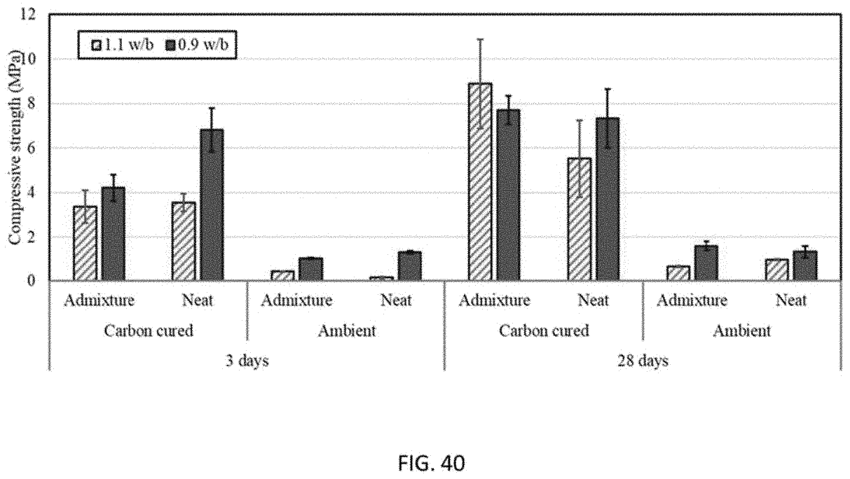

This study was aimed towards examining whether enabling 3D printing of MgO cement through the utilization of NC and MC as rheological additives can increase CO₂ penetration leading to an increase in compressive strength. As a result, the additives selected for printing at 1.1 and 0.9 w/b were chosen to maximize printing performance by reaching similar static yield stress. Thus, the dosage of NC and MC is not similar between both w/b ratios and they may impact compressive strength differently. To analyze the effect of admixtures on the compressive strength, cast specimens were prepared with and without admixture at their respective w/b ratios and tested for 3- and 28-days strengths as shown in FIG. 40. For both w/b ratios, the effects of admixtures on compressive strength are insignificant except for 0.9 w/b carbon cured at 3 days where admixtures show a decrease by 38% and 1.1 w/b carbon cured showing an increase by 61%. Reducing the w/b ratio of MgO pastes show higher compressive strength at younger age similarly to Portland cement whereas at 28 days cured specimens show statistically indifferent results. More notably, carbon cured specimen show an increase in compressive strength due to carbonation by 310% and 710% at 3 days and 390% and 1280% at 28 days for 0.9 and 1.1 w/b ratios, respectively. Thus, showing that accelerated carbonation is useful for compressive strength development of MgO concrete and the need to increase carbon penetration and the rate of carbonation. Therefore, we will focus our discussion for the effects of 3D printing on compressive strength to only carbon-cured specimens in contrast to cast ones containing similar dosage of admixtures.

3D Printing Effects

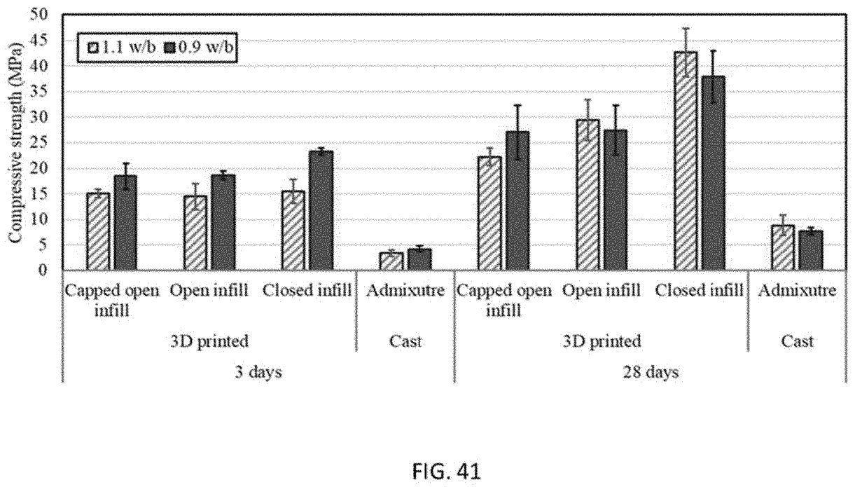

3D printed specimens show significantly higher compressive strength than cast ones with similar mixture by up to 360% and 455% at 3 days and 380% and 390% at 28 days for 1.1 and 0.9 w/b ratios, respectively as shown in FIG. 41. This indicates that 3D printing is highly effective in increasing carbon penetration enabling additional magnesium carbonate formations. With respect to printing pattern, closed infill shows higher compressive strength than open infill at 3 and 28 days whereas the effect of capping shows statistically insignificant differences for both w/b ratios. However, at 28 days, closed infill specimens show higher compressive strength than open infill for both w/b ratios. Therefore, it could be that carbon penetration is increased interfilamentous and interlayer porosity rather than by specific carbon delivery channels. The closed infill could be exhibiting higher compressive strength due to improve structural load transferring mechanism compared to open infill rather than differences in carbonation. Printed caps show overall insignificant effect on compressive strength at 3 and 28 days for both w/b except for 1.1 w/b at 28 days showing a 24% decrease. Nevertheless, one may observe that 3D printed MgO specimens show high compressive strength suitable for structural load bearing applications.

Comparing 0.9 and 1.1 w/b ratios, 0.9 w/b specimens show overall higher compressive strength at 3 days whereas 1.1 w/b specimens show overall higher strength at 28 days (capped open infill are statistically indifferent). We suspect this to be due to difference in porosity between the two. Since all specimens are cured at 80% RH, water evaporation due to drying continues to occur for the duration of curing. Because specimens made with 1.1 w/b have higher water content, higher evaporation could be expected creating higher microstructural porosity increasing CO₂ penetration and creating larger space for magnesium carbonates to form.

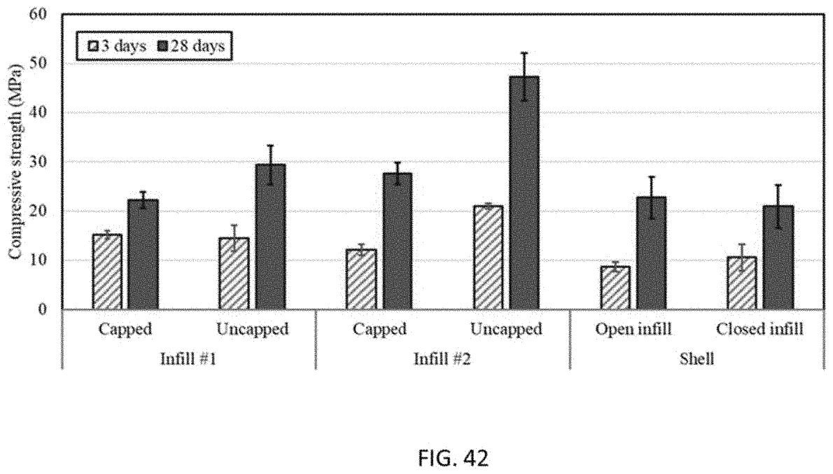

To further investigate the differences between 3D printed specimen, an additional open infill was introduced at 1.1 w/b and the shells of both open and closed infills were tested and the results are shown in FIG. 42. Changing the infill pattern does not change carbon penetration but changes the structural load bearing capacity of the internal structure. The results show that increasing the infill percentage by 50% results in an increase in compressive strength for exposed uncapped infill by 45% and 60% for 3 and 28 days respectively. At 28 days, exposed infill #2 shows statistically indifferent compressive strength to that of closed infill indicating that the load bearing mechanism of infill #2 is more optimal than infill #1. Capping infill #2 shows negative effects with a decrease in compressive strength from that of the uncapped by 41%. The decrease only observed at infill #1 rather than Infill #2 could be the result of worsened load transfer rather than worsened carbonation. Both open and closed infill shells show statistically indifferent compressive strengths irrespective of the age of testing. Since the shells are ˜2 times the thickness of the cap, it is unlikely that capping has resulted in worsened carbon penetration and rather the decrease in strength observed due to capping is due to worsened load transfer.

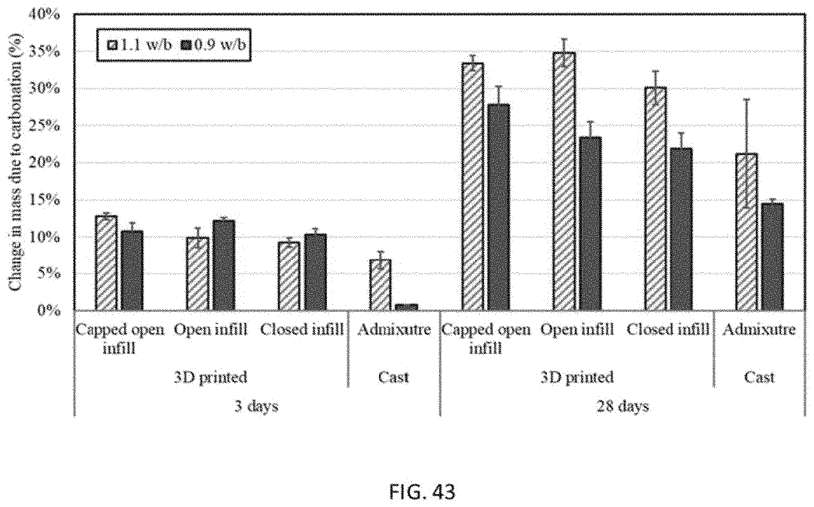

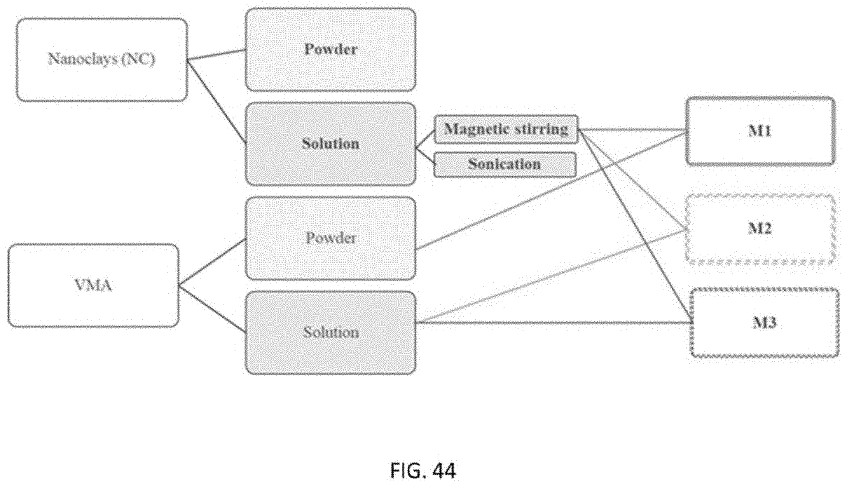

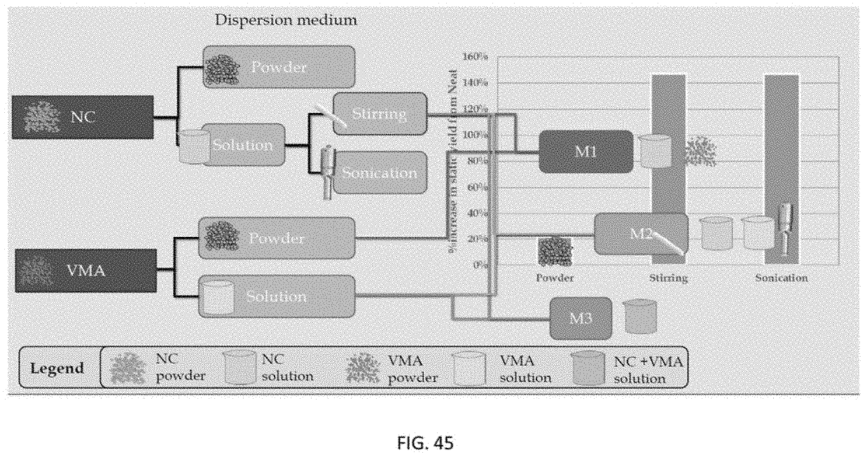

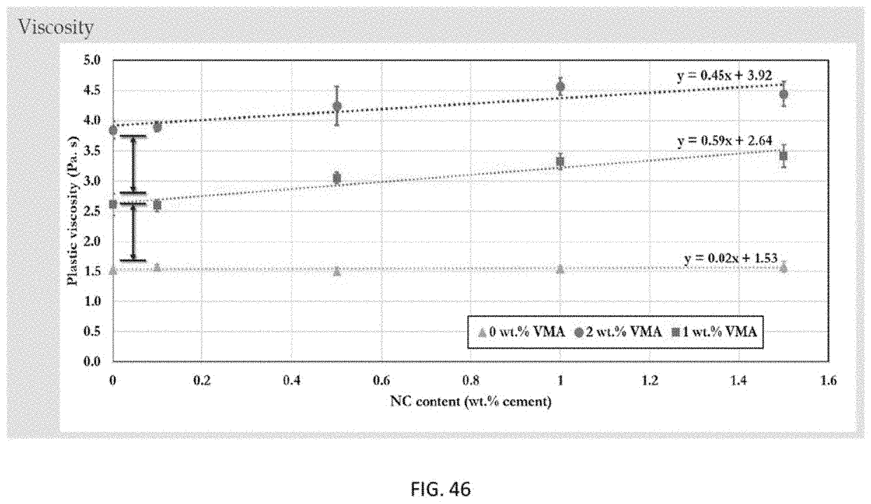

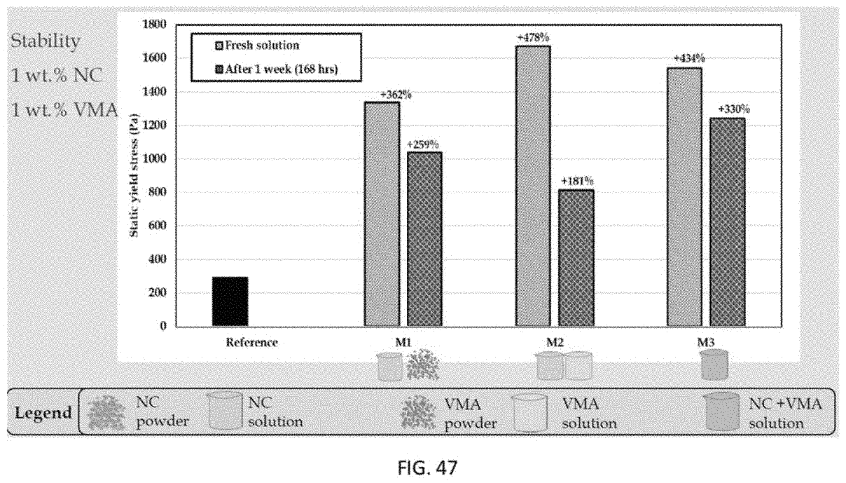

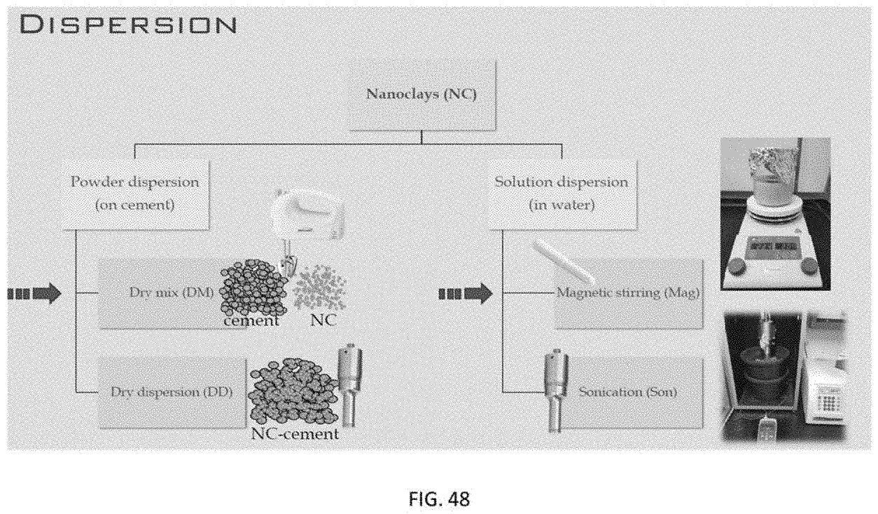

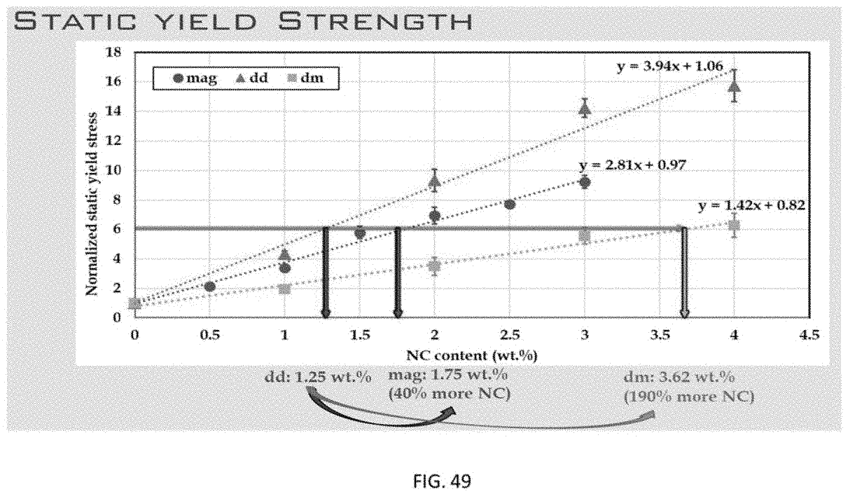

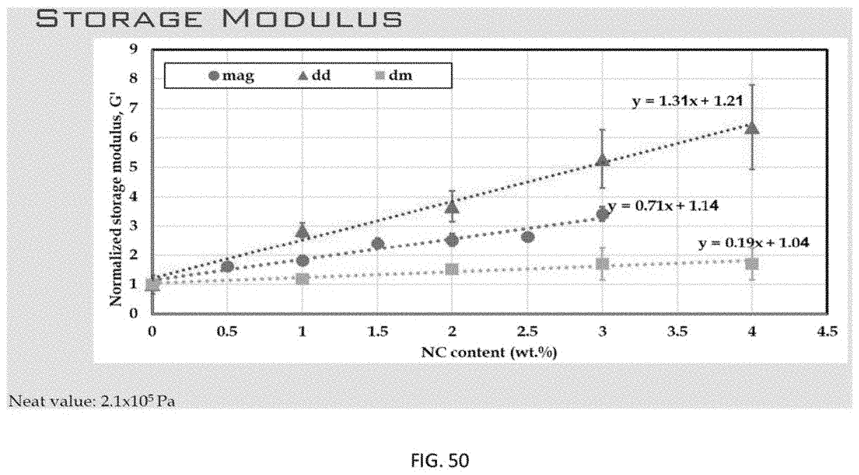

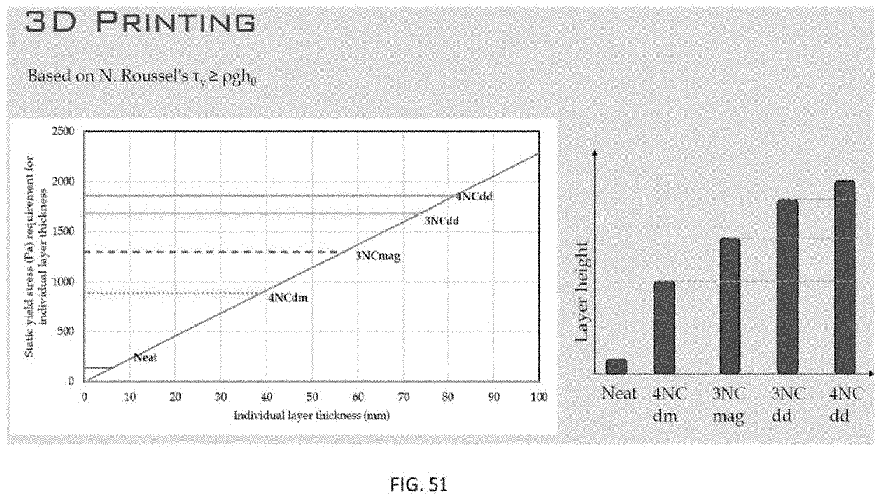

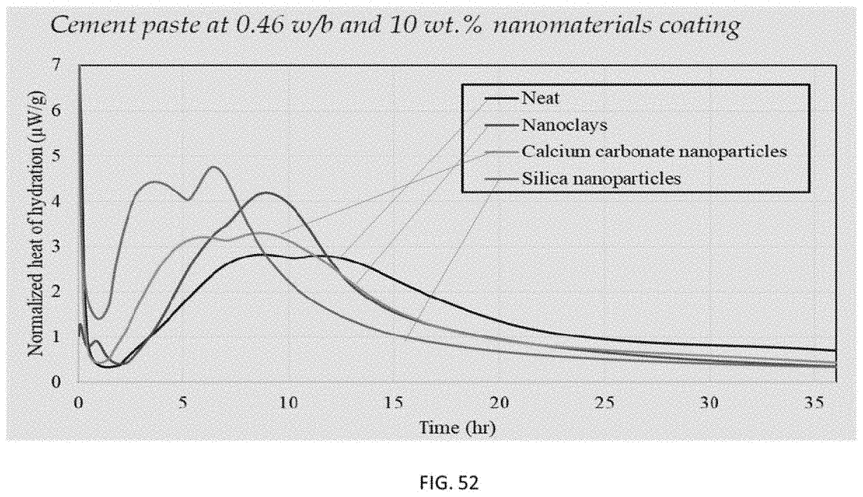

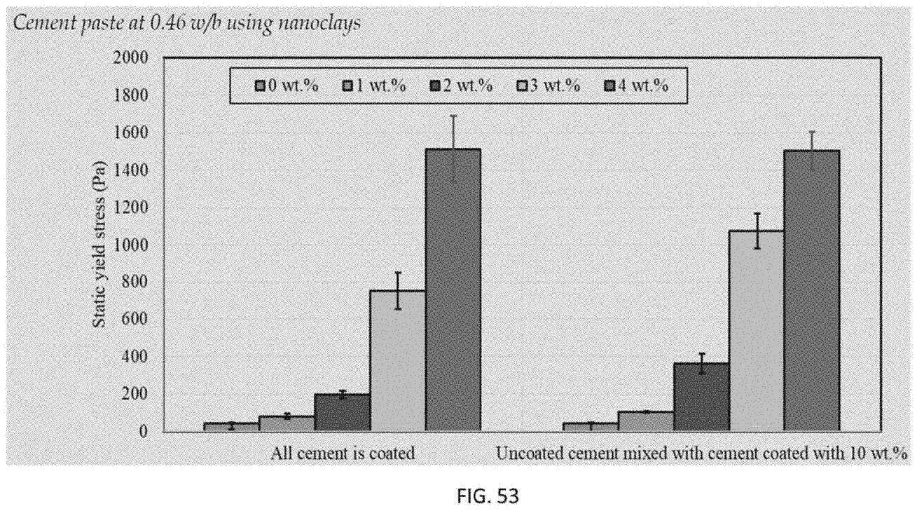

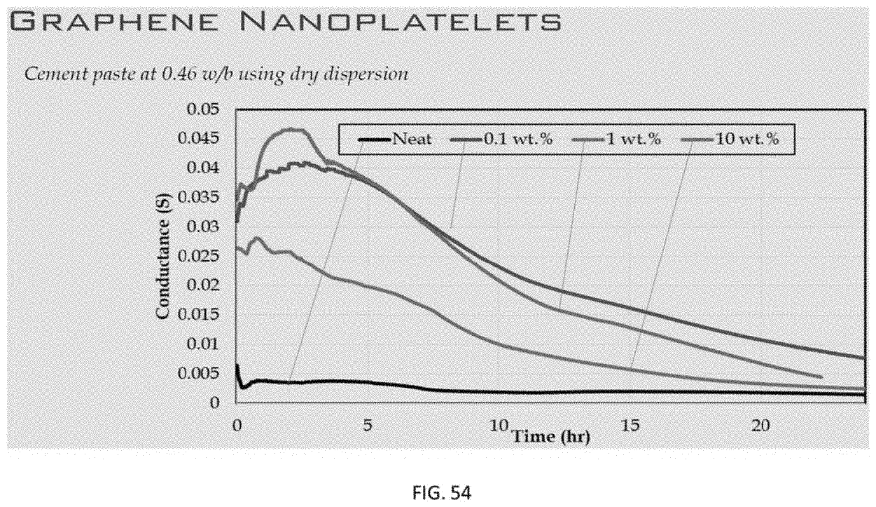

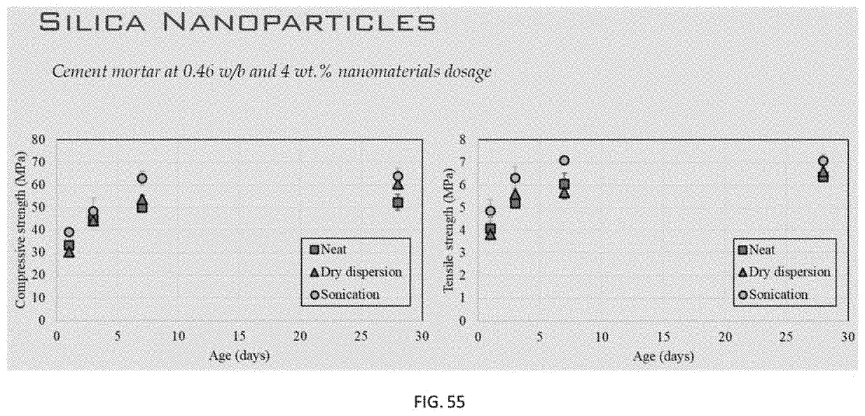

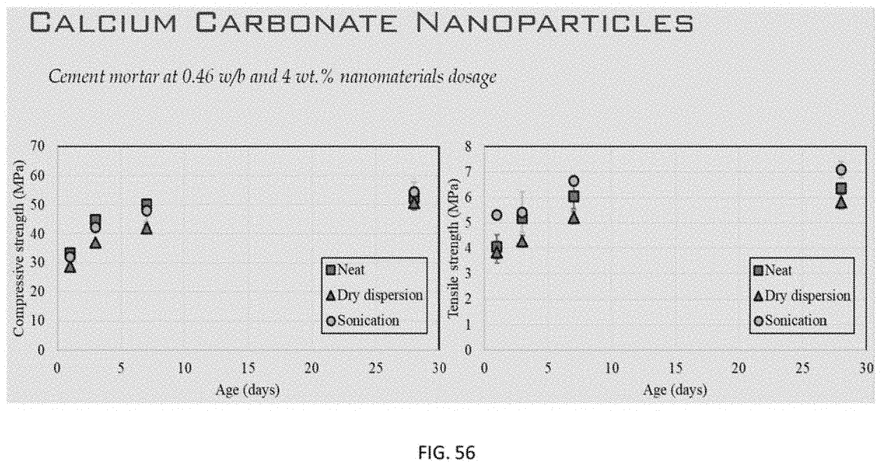

The mass of carbon-cured and ambient condition specimens was recorded at 1, 3 and 28 days. Since both carbonation and ambient conditions are controlled for similar temperature and relative humidity, water evaporation rate in both conditions should be similar before carbonation and will result in a decrease in mass over time while carbon curing can result in an increase in mass due to the formation of new products of magnesium carbonates. The change in mass of carbonated specimen measured then is the overall increase in mass due to carbonation and the reduction in mass due to water evaporation. The loss of water can be estimated by the change in mass of ambient condition. However, since carbonation can decrease surface porosity due to the formation of new magnesium carbonate products on the surface, carbonated specimens are likely to experience less water evaporation. Therefore, the analysis of change in mass shown in FIG. 43 is only qualitative to compare different infill patterns, effect of printing and the change in w/b ratio.

The higher surface area of 3D printed specimens makes them susceptible to higher water evaporation as well as increased carbon penetration. However, results show that all 3D printed specimens show higher percentage increase in mass due to carbonation than cast specimen regardless of age and no significant differences between infill patterns are observed. At 3 days age, there are no significant differences in mass change between both w/b ratios. However, all specimens (printed and cast) show higher mass change at 1.1 w/b compared to 0.9 w/b at 28 days. These results support that higher w/b ratio can result in higher water evaporation increasing porosity and enhancing carbon penetration yielding higher compressive strength as discussed previously.

Additional Disclosure—Hybrid System

As described elsewhere herein, here, we combine NC with a water soluble viscosity modifying admixture (VMA) to increase cohesion, increase static yield stress and improve overall printing performance of cement composites. We further examine different ways of synthesizing our hybrid system and test their efficiency after 1 week of producing the admixture.

The NC used in this study are palygorskite or attapulgite clays supplied in highly purified powder form. They are 30 nm in diameter, 1.5-2.0 μm in length and carry a uniform negative charge along their length with positive charges at the ends. The VMA used is a soluble low molecular weight cellulose ether supplied commercially in powder form. Cement is type 1/II Portland cement and its chemical composition is shown in Table 2 below. The water to cement ratio (w/c) is kept at 0.34. Additions of NC and VMA are 0-2% by mass of cement are tested.

TABLE 2
Chemical composition of cement.

| Content (%) | | | | | | Loss on ignition |
|---|---|---|---|---|---|---|
| SiO₂ | Al₂0₃ | Fe₂O₃ | CaO | MgO | SO₃ | (LOI) |
| 19.27 | 4.68 | 3.51 | 63 | 3.21 | 2.72 | 2.09 |

Both VMA and NC used in this study are supplied in powder form and can be added to the cement paste in either powder or solution form, where the latter is suspending or dissolving the material in water. To synthesize NC solution, magnetic stirring is one of the most commonly used methods and is suggested by the manufacturer. However, sonication remains the most common method to disperse nanomaterials, as it offers significantly higher energy than shear mixing. In this study, we compare all three methods; mixing NC as powder with cement and producing NC solution by either magnetic stirring or sonication. When magnetic stirring is used, the solution is mixed at 500 rpm for 1 hour. Sonication is performed using a sonicator probe at 300 Watts achieving 6,500 J/g of NC. On the other hand, a VMA solution can only be prepared via magnetically stirring the powder in high temperature water, then continuing stirring as the temperature drops to solubility levels.

To produce hybrids, we select magnetic stirring to prepare the NC solution and combine it with VMA via three methods. The first method, M1, is adding VMA as powder mixed with cement and adding NC in solution form. The other two methods M2 and M3 create hybrid solutions of both VMA and NC. In M2, two separate solutions are prepared and then the solutions are combined together. The resulting solution has half the original concentration of each of its constituents.

For example, to prepare 1 wt. % NC with 1 wt. % VMA, two separate solutions of 2 wt. % NC and 2 wt. % VMA are prepared, then the NC solution is added and mixed in the VMA solution. In the third method, M3, both NC and VMA are added as powder to one solution creating one hybrid solution. FIG. 1 summarizes all processes used in this study. We have previously tested the effect of adding VMA in powder and solution form to cement pastes and differences were found to be negligible on the rheological properties.

The vane and cup setup is used to measure the effect of the additives on the rheological properties of cement paste. The protocol for producing cement paste is kept consistent between all specimen and fresh paste is prepared for every test. A pre-shear at strain rate of 260 sec⁻¹ is applied for 1800 seconds to ensure all samples are at deflocculated state. At the end of the pre-shear, the steady-state viscosity is collected. A zero-stress condition is then applied for 300 seconds to allow structural build-up. A strain rate of 0.1 sec⁻¹ is applied afterwards to measure the static yield stress where the material transitions from solid to fluid. A minimum of 3 tests are performed and averaged to quantify the rheological properties. All tests are performed at 25° C.

In order to examine the shelf-life effect of our hybrid system we test the static yield stress immediately after synthesis of the hybrid solution or dispersion of NC in solution, as well as exactly 1 week after (168 hours). Solutions are kept covered in controlled lab conditions (24° C.) with minimal handling. Similar mixing and rheological protocols are used for both specimens.

A 60 mL syringe gantry 3D printer, shown in FIG. 30, is used to produce prints with cement paste incorporating the hybrid additive system described in this work with a 14 gauge dispensing straight stainless steel needle with an inner diameter of 1.6 mm. Printing layer height varies based on geometry and is in the range of 0.8 mm to 1.5 mm. The gantry speed is set to 800 mm/min during printing and a plunger is used to apply force for extrusion. The gantry system has a printing area of 250 mm×250 mm and vertical height of 100 mm. Printing codes are either manually generated or automatically using commercially available software; Simplify3D.

To study the effect of combining VMA with NC on cement paste rheology, NC contents of 0.1, 0.5, 1.0 and 1.5 wt. % are tested with VMA contents of 0, 1.0 and 2.0 wt. %. For this investigation, the simplest hybridization method of adding NC as solution and VMA as powder (referred to as M1 in FIG. 29) is selected. We then select 1 wt. % NC and 1 wt. % NC+1 wt. % VMA to examine the influence of different dispersion/hybridization methods; M1, M2 and M3 and measure static yield stress right after solution synthesis and again exactly 1 week (168 hours) after to measure stability. Finally, we show some examples of 3D printed shapes using the hybrid system.

FIG. 31 presents the results of static yield stress, where the result of NC without any VMA is shown in the dashed-dot line with triangles. As expected, we observe an increase in static yield stress with increase in NC content—up to 228% at 1.5 wt. % NC compared with the plain paste. It is also apparent that without NC, 1 wt. % VMA leads to no measurable change, while 2 wt. % VMA increases static yield stress by 280% compared with the plain paste. Combining both NC and VMA increases the static yield stress further—up to 628% and 918% with the combination of 1.0 wt. % VMA+1.5 wt. % NC and 2.0 wt. % VMA+1 and 1.5 wt. % NC, respectively.

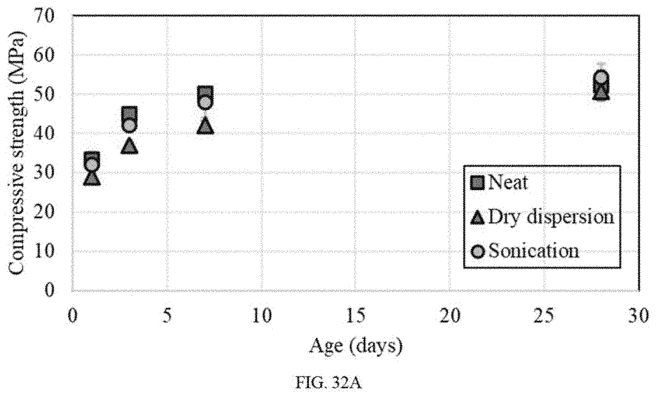

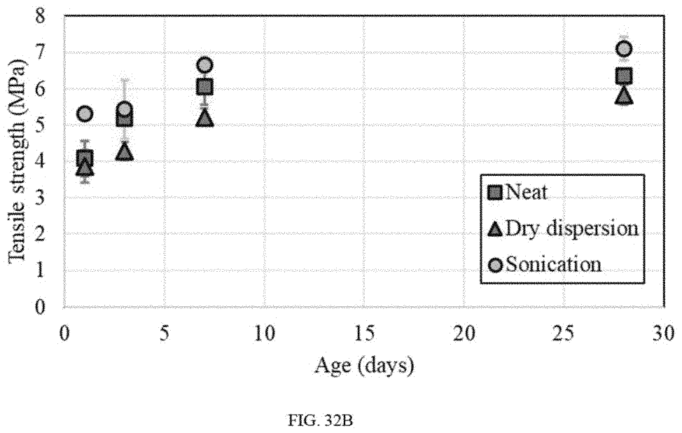

The addition of VMA to cement paste results in an increase in viscosity proportional to VMA content, as shown in FIG. 32, and is associated with higher VMA interactions. On the other hand, addition of NC alone does not notably alter the viscosity of cement paste up to 1.5 wt. % content. At even the highest increase in viscosity of 300% at 1.0 wt % NC with 2.0 wt. % VMA, the corresponding increase in static yield is almost an order of magnitude higher than plain paste at 918%. We further show that such viscosities are still suitable for pumpability and extrudability, where pastes incorporating 1 wt. % NC and 1 wt % VMA with a viscosity of 3.35 Pa·s are printed.

The increase in static yield stress of all hybrid mixes can be attributed to an increase in effectiveness of NC interactions, VMA interactions or new interactions between NC and VMA. Since changes in NC content does not affect viscosity while increasing VMA content increases viscosity, the change in viscosity can be associated with proportional change in VMA interactions. Comparing the change in static yield stress in FIG. 31 from 1 to 1.5 wt. % NC at 0, 1 and 2 wt. % VMA, there is less increase in static yield stress with increasing VMA content until no increase is observed at 2.0 wt. %. Similar behavior is observed for viscosity, shown in FIG. 32. Thus, increased VMA interactions can increase the static yield stress. However, since 1.0 wt. % VMA alone shows no change in static yield stress from the reference, there must be a critical concentration of VMA to enable such effects.

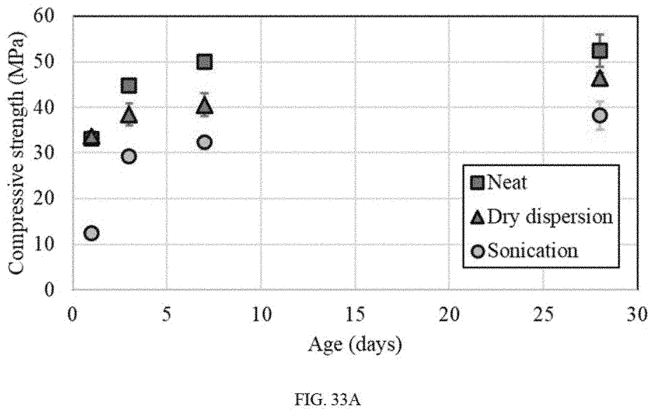

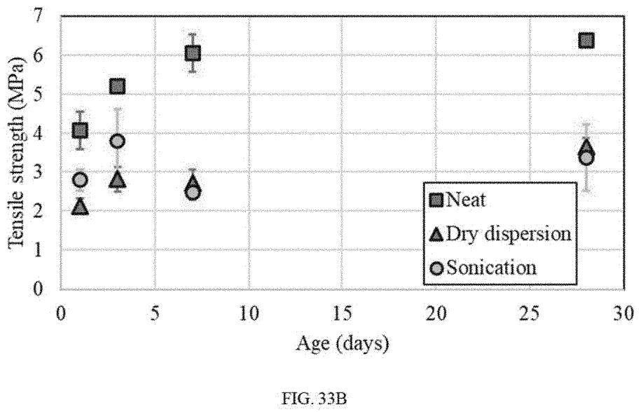

The static yield stress of cement pastes prepared with 1 wt. % NC alone and a hybrid of 1 wt. % NC+1 wt. % VMA using three dispersion/hybridization methods are compared. The results of static yield stress measured immediately after solution preparation and exactly 1 week after are summarized in FIG. 33. Mixing in NC as powder does not show any decay in performance, as there are no issues with stability with powders. However, as-received, dry NC will be aggregated and thereby not well dispersed in the cement paste, which explains the moderate 21% increase in static yield stress. In contrast, both magnetic stirring and sonication significantly improve NC efficiency and offer similar responses immediately after dispersion, leading to a 147% increase in static yield stress compared to the reference. However, after 1 week of preparing NC solutions, the dispersive state of NC using magnetic stirring decays, losing half of its effectiveness, while sonication maintains a similar performance after 1 week, indicating it remains well-dispersed in solution.

Since magnetic stirring shows a decay in performance and a common method used with NC, we utilize it in examining the three hybridization methods, as discussed. In the fresh solution state, M2 offers the highest increase in static yield stress. However, this method goes on to exhibit the largest loss of efficiency at 62% after 1 week. Because M2 combines two separate solutions to synthesize a new hybrid one, each constituent solution has higher content of additive in its original state. That is, to produce 1 wt. % NC and 1 wt. % VMA hybrid solution in M2, the constituent solutions each has 2 wt. % NC and 2 wt. % VMA. Maintaining dispersion at higher nanomaterials content is harder and the decay in dispersion of NC is worsened. Hybrid solutions via hybrid synthesis (M3) on the other hand show significantly higher stability, indicating that solubilizing VMA when NC is in the well dispersed state not only significantly drives static yield stress but further improves the stability of NC dispersion. This is evident when comparing the loss of 24% of M3 compared to 48% with NC dispersed via magnetic stirring. Finally, combining NC solution with VMA powder (M1) seems to offer a median performance both as a fresh solution and after 1 week. This method is the most suitable for scaling for industrial use as it utilizes the lowest energy, ease of processing and offer rheological properties suitable for 3DCP processes. If longer shelf-life is required, NC solutions prepared via sonication show no loss of performance after 1 week. Without being bound to any particular theory, the M1 method of synthesis utilizing sonication can provide a high stability and a high performance after 1 week.

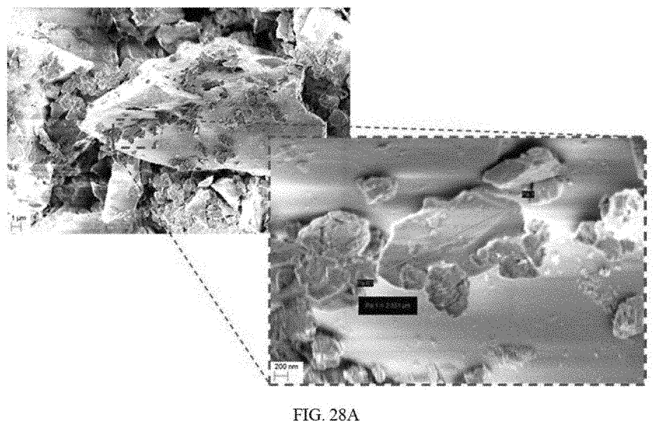

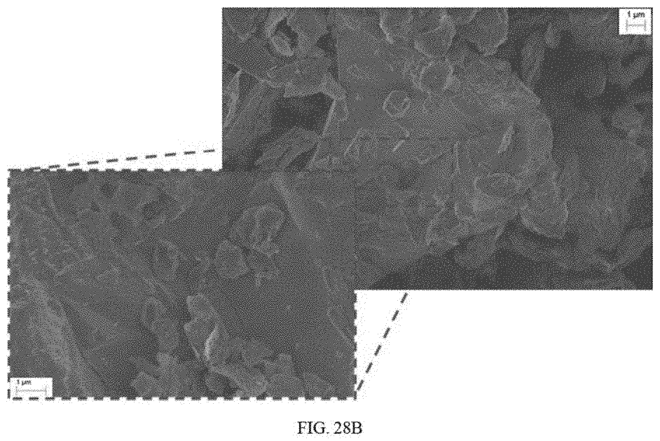

The printing performance of our proposed hybrid system is demonstrated here through a buildability test and producing multiple complex items, as shown in FIG. 28. 1 wt. % NC with 1 wt. % VMA is chosen following M1 hybridization, as it represents median viscosity and static yield stress. Buildability is assessed through measuring the maximum achievable height before deformation, where deformation is caused by insufficient rheological properties and not by structural instability such as buckling or thin walls. The result shown in FIG. 28a achieves a maximum height of 92 mm using 1.2 mm layer thickness. (The buildability test must be stopped after 92 mm as that is the maximum height of the gantry system and maximum volume of the syringe.) To prevent thin wall collapse, the cylinder used in buildability has similar internal structure as the enlarged cylinder shown in FIG. 28b.

While not shown here, printing with NC system alone often results in clogging of the syringe due to segregation resulting in water bleeding. We acknowledge that such effects are due to the nature of the syringe extrusion system, which creates an uneven pressure profile within the syringe. However, such problems are uncommon in this study when utilizing the hybrid system. These results suggest that NC alone, despite having high static yield, may not be sufficient for syringe-based 3DCP.

Thus, the present disclosure provides, inter alia, a new hybrid additive system using nanoclays and VMA. We show that the hybrid system significantly outperforms NC or VMA alone in increasing the static yield stress, reaching almost an order of magnitude increase from the reference cement paste—918% increase with 1 wt. % NC with 2 wt. % VMA. We also show that while utilizing the VMA there is an increase in viscosity, although the increase is not proportional to the increase in static yield stress. Further, during 3D printing the use of VMA increases printing ink cohesion, reducing clogging and gaps in the print, as opposed to using NC alone. We also look at the stability of dispersed/synthesized solutions, comparing static yield stress using freshly prepared solutions versus week old solutions. Results show a decay in performance except when mixing NC as dry powder or when using sonication. While a decay in performance is observed in all hybrid mixes, it is essential to highlight that regardless of the method of synthesis, all hybrid mixes significantly outperform 1 wt. % NC alone, even after decay. The proposed hybrid system is used to produce a number of complex prints showing high level of control over the rheological properties, translating to high buildability, shape stability, extrudability and detail. The method of hybridization we suggest is to prepare NC solution via magnetic stirring or sonication and combine it with VMA, where the VMA is premixed in powder form with cement. Thus, the disclosed technology allows for control over rheology, static yield, and curing kinetics, allowing users unprecedented control and choice over these parameters and the ability to satisfy a broad range of use cases.

Additional Disclosure

Nanoclays (NC) can serve as thixotropy modifiers for fresh concretes, and show potential to meet the rheological demands of 3D concrete printing. Here, we propose a dry dispersion technique that produces NC-coated cement and compare to conventional methods of dispersion. Pastes incorporating NC were tested via shear rheology, scanning electron microscopy, and isothermal calorimetry. Dry dispersion was found to be the most effective method, where incorporating 4.0 wt. % NC increased the static yield stress and storage modulus of cement paste by 1500% and 550%, respectively, with a minimal increase in viscosity of 90%. Results of small amplitude oscillatory shear and isothermal calorimetry indicated NC can enhance fresh-state stiffening through seeding, although shear rheology results of kerosene-based cement systems indicated the increase in static yield stress by NC is mainly due to ionic forces. Finally, we discuss how these properties translate to high buildability and stable layer deposition.

Fresh concrete is a non-Newtonian fluid material with rheological properties that vary vastly with respect to chemical composition, particle gradation, environmental conditions, method of preparation and shear history. The interest in 3D concrete printing (3DCP) has generated significant demand for increased understanding of cement rheology and the role of admixtures. Roussel recently identified several rheological properties to be critical for 3DCP, namely static yield stress, dynamic yield stress, critical strain, viscosity, elastic modulus and structuration rate [1]. These rheological properties can be described by colloidal forces driven by Van der Waals attraction and electrostatic forces from adsorbed ions, and progression of cement hydration (e.g. calcium silicate hydrate (C—S—H) bridging) that originate in colloidal flocculation with characteristic time of few seconds [2-4]. The main intrinsic rheological properties resisting failure in 3DCP are static yield stress and structuration rate, as shown in Eq. (1) [1], for systems that do not rely solely on accelerated hardening:

τ_{c}(t)=T_{c0}+Aₜₕᵢₓt>ρgH/\sqrt{3} Eq. (1)

where τ_{c}(t) is static yield stress at time t after deposition, τ_{c0} is the static yield stress just after deposition, Aₜₕᵢₓ is the structuration rate, p is the density, g is gravitational acceleration, and H is the total object height. Some more recent works indicated that this equation gives a rather conservative estimation of the desirable static yield stress for the total object height [5, 6]. Of course, other properties such as critical strain, elastic shear modulus and Young's modulus control other factors limiting layer width, height and velocity [1]. Static yield stress, structuration rate, critical strain, and elastic modulus can be further used to describe shape stability—the ability to maintain the deposited layer's shape within tolerable deformation.

In order to meet the high rheological demand of 3DCP, four approaches can be adopted. The first approach is to utilize a number of supplementary cementitious materials (SCMs), such as silica fume (SF) [7-14], fly ash or volcanic ash [9, 11-13, 15], or ground granulated blast furnace slag (GGBS) [11, 12, 14, 15]. The second approach is to rely on retarder/accelerator systems in which wet concrete supports only a few layers before it completely hardens [9, 16-18]. The third approach is to rely on chemical admixtures such as polycarboxylates (PCE) and high-range water reducing admixtures (HWRWA) [8, 9, 14], or nanomaterials such as purified alumino magnesium silicates (nanoclays (NC) or attapulgite clay) [7-9, 11, 14, 15, 19], nanosilica (NS) [10, 14] or nanobentonite [10, 13]. Of course, these approaches are not mutually exclusive and can be used simultaneously. The variation in cement additives and replacements combined with the scarcity of concrete 3D printers and lack of standards introduce large variations, creating challenges in fully characterizing their effect on printing performance. Furthermore, because cement rheology is shear history dependent, the vast configurations of extrusion and pumping systems in printers can cause additional variations in printing performance.

One of the main challenges faced in 3DCP additives is the coupling effect between rheological properties. For example, an increase in static yield stress and structuration rate is often coupled with an increase in viscosity, potentially compromising pumpability [20]. NC offers great potential for increasing static yield stress and rate of structuration [21-23] with minimal effects on viscosity [8, 24, 25], also described as exhibiting enhanced thixotropy, and have been shown extensively to improve the printing performance of cement-based composites in terms of buildability [9, 11, 14, 15, 19], shape stability [7, 8, 15], robustness (low variability in static yield stress) [7] and stiffness [19]. Highly purified NC are negatively charged uniformly along their length with high positive charges at their ends that produce a house of card effect in idle solutions [14, 24]. It is hypothesized that a similar mechanism is active within the pore solution in NC-cement composites that causes the increase in static yield stress [14, 24]. While such claims have not been verified, they will induce strong ionic interactions nonetheless.

As a nanomaterial, the effectiveness of NC is highly dependent on dosage and method of dispersion. Typical contents used in literature are in the range of 0.01-0.5 wt. % [7-9, 15, 19, 26, 27] while some authors used up to 1.0 [28], 1.2 [11], 2 [14, 25], 2.5 [24] and 3 [29] wt. %. [11, 14, 15] showed that NC has no significant effect on viscosity while [8, 24, 25] showed an increase in viscosity. Such discrepancies can be partially explained through differences in preshear conditions [23]. However, they are also a result of the variation in NC dispersion. For example, blending NC in water is the most common way of preparing NC-cement composites [8, 9, 14, 15, 19, 24, 27] while others blend NC dry with cement [7, 28, 29]. The blending time ranges from 1 to 5 minutes [15, 24, 27] or is unreported [8, 9, 14, 19]. The speed of blending also varies between 140 rpm (1 min) [24], 400 rpm (5 min) [9], and 12,000 rpm (2 min) [27]. Thus, the level of dispersion of NC can be a key reason behind discrepancies in literature. It should be noted that NC also comes in colloidal/liquid pre-dispersed form [30].

Quanji et al. studied the effect of NC dosage and showed that higher contents of NC result in higher static yield stress and degree of thixotropy up to 3.0 wt. % [29], but that increasing the dosage of NC beyond 1.3 wt. % resulted in a decreased rate of thixotropy. However, dispersion was not the focus of this work and their method of dry mixing NC with cement does not guarantee optimum dispersion. Parveen et al. reported that typical mixing processes employed for mixing in cementitious mortars are insufficient in producing uniform dispersion of nanomaterials such as CNTs [31]. On the other hand, sonication horns/probes are typically classified as the most effective method in deagglomerating and producing uniform dispersion of nanomaterials [32]. However, even when NC are well dispersed in water, achieving a state of uniform dispersion in solution does not guarantee uniform dispersion in the composite [31]. In fact, Yazdanbakhsh and Grasley showed through simulations that achieving uniform dispersion in cement composites requires homogeneous and deagglomerated cement particles [10], which cannot be achieved by adding NC solutions to cement gradually. In order to meet the high rheological demands of 3DCP, high dosage and high efficiency utilization of NC is desired.

In this disclosure, we provide a dry dispersion method to coat cement grains with NC, producing nanomodified cement. Although this method has been implemented for carbon-based nanomaterials in ceramics [33] and cements [34-37], to the knowledge of the authors it has not been implemented for nanoclays or other inorganic particles in cements. The influence of NC prepared via dry dispersion are compared with that prepared via other methods, i.e. dry mixing and magnetic stirring in solution. NC are incorporated into cement pastes and the pastes are tested for rheological properties, i.e. static yield stress, storage modulus, storage modulus evolution and viscosity, heat of hydration via isothermal calorimetry and scanning electron microscopy (SEM) imaging. We also examine kerosene-based NC cement systems to distinguish Van der Waals from ionic and electrostatic forces. Through the obtained results, we aim to expand upon Roussel's work on the origin of thixotropy to account for NC interactions, and break down the working mechanisms of NC in cement pastes. Finally, we discuss how the attained rheological properties with NC translate to high buildability potential and stable layer deposition with slenderness ratios of up to 10 for 3D concrete printing.

Motivation and Background

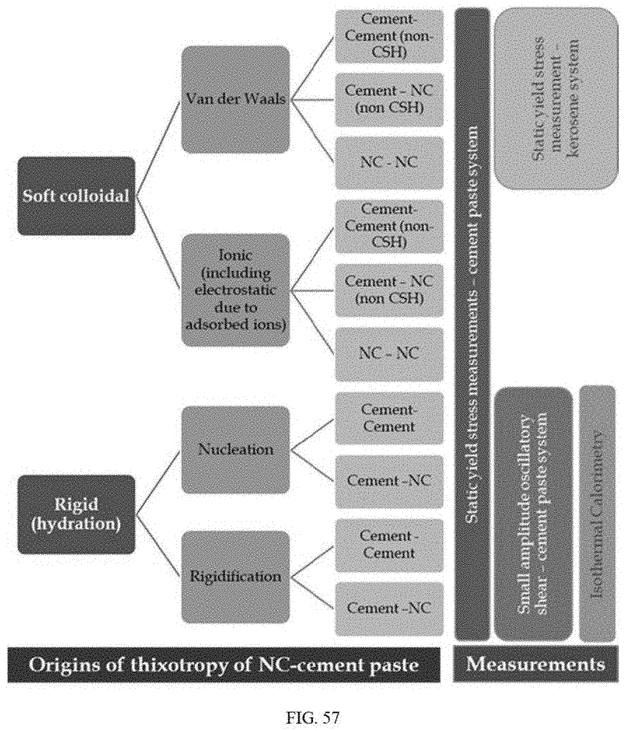

To fully characterize the kinetics of NC influence on cement rheology, we have used the characteristic soft and rigid interaction mechanisms described by Roussel et al. [2] and expanded it to include the effects of NC by introducing NC-cement and NC-NC interactions. In this work, we refer to all early hydration products including early ettringite formations as C—S—H bridge forces for simplicity. The origin and classification of rigid interactions warrants significant more in-depth analysis of the internal structure that are outside the scope of this work but are subject of future research. Our analysis of the origin of thixotropy of NC-cement paste is depicted in FIG. 57. The static yield stress is sensitive to all soft and rigid interactions, whereas calorimetry and storage modulus measurements are sensitive only to rigid interactions that govern hydration kinetics. Rigid interactions include nucleation, which is surface-based C—S—H precipitation, and rigidification, which is C—S—H growth. We utilize storage modulus and its evolution similarly to [23] to rheologically probe and characterize these two phenomena. calorimetry provides a second layer of investigation as shifts in termination peak time correlate to surface-based C—S—H nucleation and shifts in heat of hydration at the acceleration period correspond to C—S—H growth [38]. On the other hand, the soft interactions that mainly dominate rheological behavior are Van der Waals and ionic forces. To separate NCs effect on the different soft interactions, we study cement systems in kerosene where rigid C—S—H forces are eliminated due to the absence of hydration. Because kerosene is a non-polar solvent, soft colloidal ionic adsorption and electrostatic forces are minimal whereas Van der Waals forces remain unaffected. By comparing NC efficiency in static yield stress and storage modulus, the contribution of soft colloidal forces and rigid interactions can be estimated.

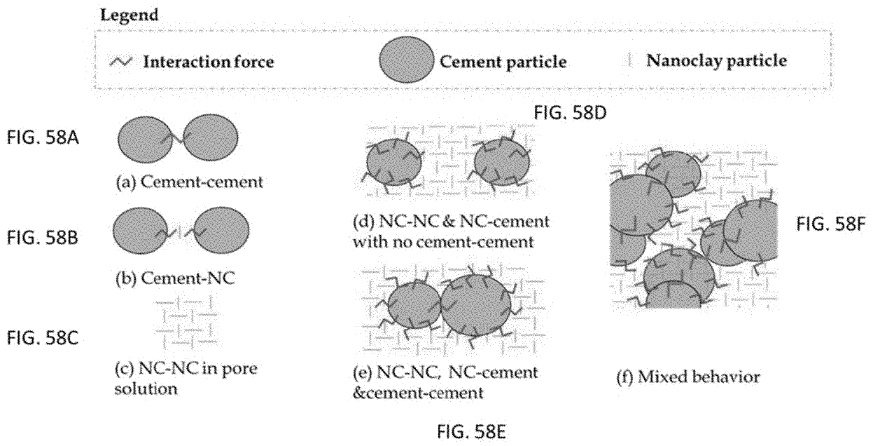

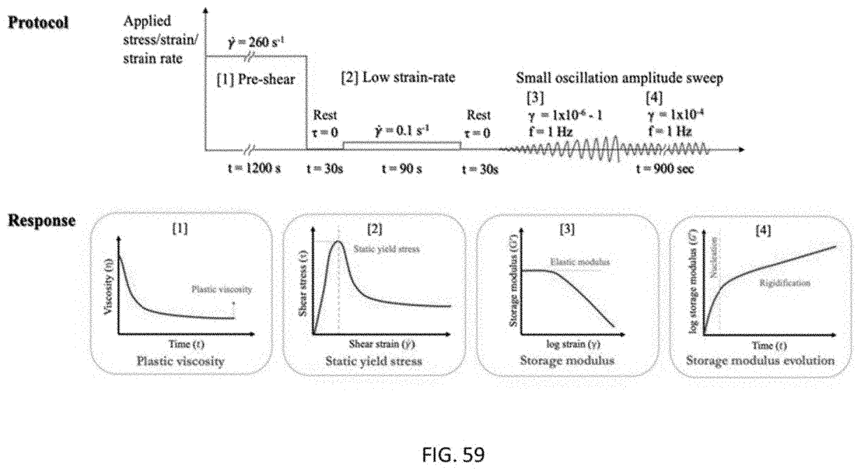

Addition of NC into cement leads to three types of interactions: cement-cement, cement-NC and NC-NC, represented in 2D simplified schematics in FIG. 58A, FIG. 58B, and FIG. 58 C, respectively. According to Flatt's analysis of the measurements of Sakai and Daimon [39], only particles at interparticle distances <15-30 nm significantly influence and control cement rheology [3, 39]. Because NC's smallest dimension is around the limit of 30 nm, if a cement particle interacts with NC within that linear distance, its interaction with another cement particle within the same linear distance is insignificant to the rheological response. In other words, if an NC needle is sandwiched between two cement particles (as shown in FIG. 58B, the linear distance between these two cement particles must be greater than the width of NC and exceed the 30 nm limit. Hence, there will only be two NC-cement interactions and no cement-cement interactions. Without loss of generality, we can expand on this concept and safely assume that cement-cement interactions are mutually exclusive from NC-cement interactions. Of course, multiple NC needles can be between cement particles and induce additional NC-NC interactions. Therefore, a cement particle will either interact with another cement particle or NC particle but NC particles can interact with cement and other NC particles simultaneously. The mix of these interactions are visualized in FIG. 58D and FIG. 58E. Ultimately, cement paste is a complex system that utilize a mix of all such forces within a 3D space as visualized in (f). Nevertheless, such analysis remains a simplified first-order approximation and further rigorous analysis can be used to gain more quantitative interpretation of the system.

To better understand the relationship between cement-NC and cement-cement interactions, we can estimate the percentage of cement particle surface area that can be theoretically covered by well dispersed NC, % A_{cover}, measured according to Eq.(2):

$$\% {A}_{c o v e r} = \frac{\begin{matrix}Total surface \\ area of NC\end{matrix} }{ \begin{matrix}Total surface \\ area of Cement\end{matrix}} = \frac{\begin{matrix}SSA of NC * wt . \% * \\ solid density of NC\end{matrix}}{\begin{matrix}\begin{matrix}SSA of cement * \\ ( 1 - wt . \% ) *\end{matrix} \\ solid density of cement\end{matrix}} \qquad Eq . ( 2 )$$

The specific surface area (SSA) is defined as the surface area per unit volume. Cement has an SSA around 1 m²/g [40] while NC similar to the one used in this paper have been measured as 107 m²/g using BET method [41]. Given that the solid density of NC is 2.287 g/cm³ [26] and the solid density of cement is 3.15 g/cm³, % A_{cover} for the different NC dosages used is shown in Table 2. The first limit of % A_{cover} represents the case where NC is sandwiched between two cement particles, while the second limit represents the case where NC covers the surface of cement on one side and is free on the other, effectively reducing the contact SSA by half. While the second limit seems more likely, it also assumes that all NC needles will be densely packed on the surface of the cement. However, because NC needles are negatively charged along their length, such dense packing is energetically unfavorable. Thus, the values of % A_{cover} presented aim to provide limits to when all the surface of cement will be covered. In actuality, % A_{cover} decreases due to NC and cement agglomeration and increases due to cement dissolution. Therefore, we consider our theoretical limit only at the beginning of dissolution processes and with effective dispersion.

TABLE 2
percentage of cement particles surface area that can
be covered by NC in well dispersed state

| NC (wt. %) | | 1% | 2% | 3% | 4% |
|---|---|---|---|---|---|
| % A_{cover} | First limit | 78% | 159% | 240% | 324% |
| | Second limit | 39% | 80% | 120% | 162% |

The extreme dimensionality of NC is clearly reflected by the exceptionally high values of % A_{cover} exceeding 100% within the tested NC dosage. In fact, within 1.27-2.54 wt. %, well dispersed NC have an effective surface area to cover the surface area of cement particles completely. Hence, if all cement particles are covered by NC particles, the interaction between two cement particles is insignificant to cement rheology, as they exceed 30 nm in spacing. This means that increasing the content above 1.27-2.54 wt. % in well dispersed states allows only for additional NC-NC interactions where cement-NC are maximized and soft cement-cement interactions are eliminated. However, due to nucleation and seeding effects of NC, some additional rigid cement-cement interactions can still occur. Because cement dissolution and hydration are such complex phenomena and the challenges in measuring the state of NC dispersion within cement paste at a few 10s of seconds after deflocculation, this theoretical model cannot be verified experimentally. However, this discussion highlights some key aspects on the effect of NC addition to soft colloidal cement interactions.

There is a theoretical limit at which nanomaterials in general can interact with cement. Beyond such limit, the main additional interactions within the system are nanomaterial interactions like NC-NC.

There is an exchange between soft cement-cement and NC-cement interactions due to the addition of NC given their geometry.

The state of NC dispersion plays a key role in controlling the mechanisms of NC interactions, as such has a direct influence on their effective SSA and in turn the dosage at which % A_{cover}=100% is achieved.

Materials and Methods:

2.1 Materials:

Ordinary Type I cement and distilled water were used to prepare pastes. The chemical composition of the cement is provided in Table 3. Different levels of NC substitution by weight of cement were used in this study ranging from 0.5 to 4.0 wt. %. Table 4 summarizes all mixes with NC content based on their dispersion method. The prefix in NC mixes represents the content as weight replacement of cement and the suffixes are; “mag” referring to NC dispersed in water via magnetic stirring, “dd” referring to NC dispersed on cement via dry dispersion, and “dm” referring to NC that is added in the dry, as-received state during mixing. Neat refers to the reference paste that is unprocessed and Neatdd is reference cement that undergoes the dry dispersion process without NC presence. Neat, mag, dd and dm mixes were prepared using water-to-binder (w/b) ratio of 0.34 by mass. Additionally, in some mixes the water content was completely replaced with kerosene, a nonpolar solvent (dielectric constant ε=1.8) and absolute viscosity of 0.00164 Pa. s, as the liquid phase to diminish the influence of electrostatic force between particles and hydration. They are denoted with “_kero”. Kerosene mixes were prepared using similar mass ratio of 0.34. The cement-kerosene pastes stayed homogenous and no bleeding was observed during the tests. The negative and positive charges along NC lengths and ends introduce dipole-dipole forces in polar solvents such as water allowing dispersion without introducing additional chemical forces from surfactants. Because kerosene is non-polar, all kerosene systems used dd cements, as a stably dispersed NC suspension cannot be achieved in kerosene at the studied addition rate without introducing additional chemical forces. Because NC are added as replacement of cement, a dilution effect is expected decreasing cement-cement interactions and reducing the maximum heat of hydration similar to increasing the w/b from 0.34 to 0.354 at 4 wt. %.

TABLE 3
Chemical composition of cement.

| Content (%) | | | | | | Loss on ignition |
|---|---|---|---|---|---|---|
| SiO₂ | Al₂0₃ | Fe₂O₃ | CaO | MgO | SO₃ | (LOI) |
| 19.27 | 4.68 | 3.51 | 63 | 3.21 | 2.72 | 2.09 |

TABLE 4
Mixes list and reference information.

| Mix type | | |
|---|---|---|
| Magnetic | Dry | Dry |
| stirring | mix | dispersion |
| (mag) | (dm) | (dd) |

| Information | Cement | Unprocessed | Cement processed | |
|---|---|---|---|---|
| | type | cement | through | |
| | | | dry dispersion | |
| | Solution liquid | Water | | Kerosene |
| | Reference mix | Neat | Neatdd | Neatddkero |

| NC content (wt. %) | Abbreviation | | | |
|---|---|---|---|---|
| 0.5 | 0.5NCmag | — | — | — |
| 1.0 | 1NCmag | 1NCdm | 1NCdd | 1NCdd_kero |
| 1.5 | 1.5NCmag | — | — | — |
| 2.0 | 2NCmag | 2NCdm | 2NCdd | 2NCdd_kero |
| 2.5 | 2.5NCmag | — | — | — |
| 3.0 | 3NCmag | 3NCdm | 3NCdd | 3NCdd_kero |
| 4.0 | — | 4NCdm | 4NCdd | 4NCdd_kero |

2.2 Mixing:

Magnetic stirring (mag) was used to prepare a solution dispersion of NC in distilled water at 400 rpm for a minimum of 1 hour. A large solution of 350-400 mL was produced, which was always stirred immediately before use to prepare cement pastes. Dry mixing (dm) cement paste was prepared by using a hand mixer for 15 seconds to combine cement with NC powder, before adding distilled water. Dry dispersion (dd) is detailed in the following section.

Special care was taken to ensure all pastes had similar shear history leading up to rheological testing. To prepare mag cement paste, the NC solution was added to the cement, whereas in the case of dm or dd paste distilled water was added to the cement and NC composite. This process was done within 30 seconds and NC, cement and water were then mixed for 120 seconds at similar speed using a hand mixer. The highest mixable content of NC in solution was 3.0 wt. %. The paste was then loaded into the cup and vibrated for 5 seconds to remove air bubbles before loading into the rheometer. The vane was inserted 600 seconds from the time of contact between cement and water. A similar mixing approach was used for calorimetry but the paste was added to a glass vial and inserted in the calorimeter 300-330 seconds from the time of contact between cement and water.

2.3 Dry Dispersion:

The basics of the approach reported by [33-37] were further developed to ensure ease of repeatability and applicability to a diverse selection of nanomaterials. Isopropyl alcohol was replaced with ethyl alcohol, magnetic stirring was used in conjunction with probe sonication, distillation was used in place of desiccation or evaporation, and magnetic stirring was used through distillation. NC were first sonicated continuously in ethanol solution at 10 kJ/g NC while being simultaneously stirred using a magnetic stirrer. The energy used in this step is twice the one reported by [10] since dispersion in ethanol is more challenging than in water due to its lower polarity at relative polarity of 0.654. Ethanol was used instead of other alcohols due to its low boiling temperature and polarity. The solution was kept inside an ice bath to prevent excessive evaporation of the ethanol. Cement was then introduced to the solution maintaining continuous sonication and stirring. Sonication was applied to achieve 30 kJ/g NC after addition of cement at 2 second pulses. The NC-cement ethanol solution was then moved to a distillation apparatus to recover the ethanol. During distillation, the solution was also stirred to minimize sedimentation. 80% of the original ethanol was recovered within 30 minutes. The NC coated cement cake was then broken down and placed in a drying oven set at 260° F. (126° C.) for 24-48 hours to ensure complete removal of ethanol and to prevent hydration with air moisture. Upon removal of cement, the cement grains were further processed using mortar and pestle and kept in airtight bags until mixing with water to produce NC-cement pastes.

2.4 Rheological Protocol:

A four-blade vane and cup geometry were used in a stress-controlled HAAKE MARS III rheometer set at 25° C. The cup had an inner diameter of 26.6 mm, the vane blades were 21.9 mm wide and the gap between the vane and the cup was 8 mm. At least three different measurements were collected per mix, where additional tests of up to 7 tests per mix were carried out when variance was greater than 10%. These parameters ensure that results with means greater than 1±0.074 times the mean are different with 95% confidence interval which have been sufficient based on the authors experience when shear history was similar. Five mixes required additional tests namely 1NCmag, 1.5NCmag, 2NCmag, 2NCdm and Neatddkero. Shear history of 3DCP materials depend on the type of reservoir, pump, transportation and extrusion system of the printer. Thus, it is critical for rheological studies to examine the rheological properties of cement-based materials from a reference deflocculated state. High contents of additive that target high structural build up (as demanded by 3D printing processes) require significantly longer preshear to reach a deflocculated steady state [23]. Such is especially critical for NC, which are charged particles that significantly increase the rate of flocculation [27, 42, 43]. Thus, a relatively long preshear of 20 minutes was used in this study to ensure all tests were at a well-defined reference state. It should be noted that for NC prepared in solution via magnetic stirring, at high NC contents the cement paste was too stiff and no flow could be initiated by the rheometer, as it exceeded the equipment's maximum torque. Therefore, mixes containing 2.5 and 3.0 wt. % (2.5NCmag and 3.0NC mag) required manual initial torquing to initiate structural breakdown prior to applying pre-shear to protect the testing apparatus.

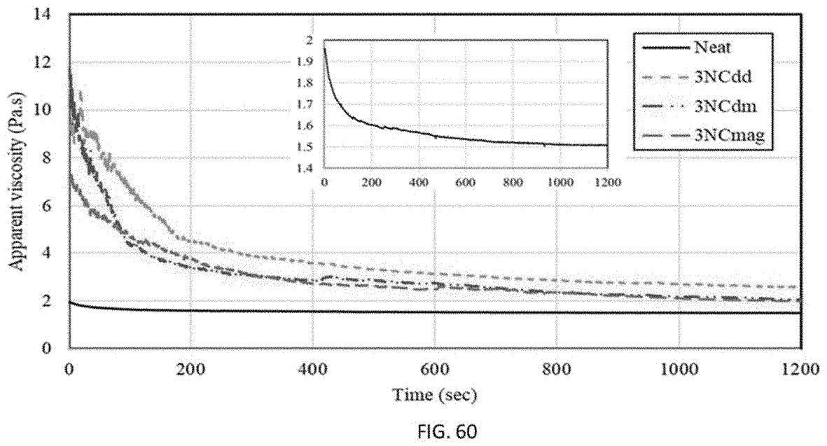

The rheological protocol is described in 59. It starts with a preshear, where the plastic viscosity was determined once steady-state was reached. The prolonged preshear was needed to ensure all mixes reached a steady state response before measuring the static yield response. Due to the high shear strain rate applied during preshear, the formation of hydration products was retarded. This is reflected with the downward sloping apparent viscosity evolution as shown in FIG. 60 for selected mixes. Following the preshear, a rest period of 30 seconds using a zero-stress condition was applied to allow for structuration. A strain rate of 0.1 s⁻¹ was then applied to measure the static yield stress. Another zero-stress rest period was applied for 30 seconds, then small amplitude oscillation shear (SAOS) was applied at a frequency of 1 Hz and logarithmic strain sweep from 1×10⁻⁶ to 1 l/s. The storage modulus G′ was continuously recorded, where there was an initial linear viscoelastic regime (LVR), where G′ is nearly constant, followed by a drop, which marks the end of the LVR and indicates irreversible damage to the rigid structure. The applied strain amplitude corresponding to the end of the LVR is identified as the rigid critical strain, which is typically of the order of a few 10⁻⁴ [2]. The storage modulus at such strain levels can then be interpreted as the elastic modulus according to linear viscoelasticity principals. Finally, we capture the evolution of the storage modulus over time by applying a strain of 1×10⁻⁴ at a frequency of 1 Hz over 30 minutes. Analysis of the storage modulus followed the work done by Ma et al. based on Eq. (2), where c is a fully developed structural parameter condition, 0 is the relaxation time, t is the time parameter and G_{rigid} is the rate of linear evolution of storage modulus [23].

$${G}^{′} = c ( 1 - {e}^{- \frac{t}{θ}} ) + {G}_{rigid} t \qquad Eq . ( 3 )$$

Our protocol measured plastic viscosity, static yield stress, and storage modulus in series, in order to reduce the overall number of tests and to simulate the 3DCP process. In a general extrusion-based 3D concrete printing scheme, the fresh cement-based material is subjected to prolonged shearing during pumping and extrusion, then deposited, where the deposited layer is able to hold its shape if it exhibits sufficient green strength to sustain self-weight induced stresses and in some cases the weight of subsequent layers. The initial pre-shear simulates shearing from pumping and extrusion, from which we obtain corresponding viscosity. From there, static yield stress is measured to determine the capacity for shape stability shortly after deposition. And finally, the fresh material's stiffness and evolution over time will indicate the extent of elastic deformation of the layer, as well as overall structural stability, as printing continues. So although the static yield stress and storage modulus of a given paste sample will be measured at different shear histories, these parameters can be directly compared against different mix designs, which was the aim of this study.

2.5 Calorimetry

The hydration kinetics were investigated for the hydrating mixes (excluding kerosene system) at 25° C. using isothermal calorimetry (TAM Air III). A new paste was prepared for each test. 5 g of paste was loaded inside each standardized glass ampule, where a total of three tests were performed per mix. Data was collected for 48 hours and all samples generated a total of 185 kJ±3 kJ by 36 hours indicating the generation of a similar total amount of hydration products.

2.6 SEM Scans

Scanning electron microscope images were collected for NC powder and unhydrated 2.0NCdd powder, as well as 7-day air-cured 2.0NCmag and 2.0NCdd cement pastes. 2.0 wt. % content was selected as the median content examined in this paper. All samples were coated with 1 nm gold palladium (Au—Pd) via 108 Manual Sputter Coater. Scans were collected using Zeiss Sigma VP SEM with a resolution of 12 Å at 2-5 kV. Hydrated samples were obtained from fractured pieces of hardened cement samples that were produced using the same mixing approach as described prior.

2.7 Particle Size Analysis

The particle size distribution was measured using Beckman Coulter Laser Diffraction Particle Sizing Analyzer; LS 13 320. The device has a working range of 17 nm to 2000 μm and uses a sonicated aqueous submersion technique. This test was utilized to examine the effect of dry dispersion processing on the cement particle distribution. Plain cement was processed at similar energy to that used for 1NCdd and the difference in particle distribution before and after was recorded.

3. Results:

3.1 SEM:

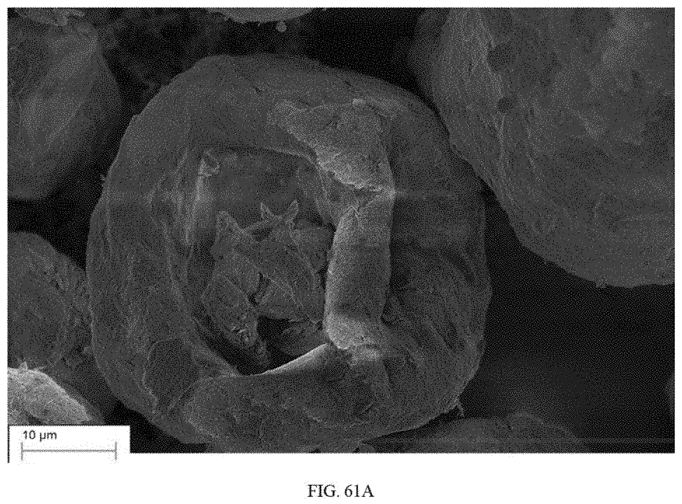

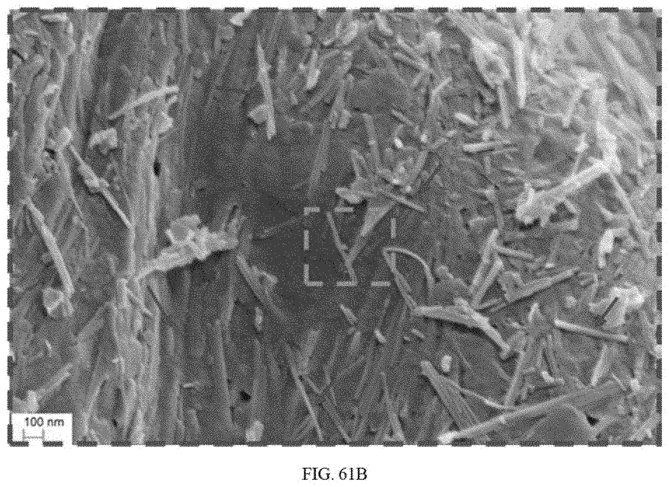

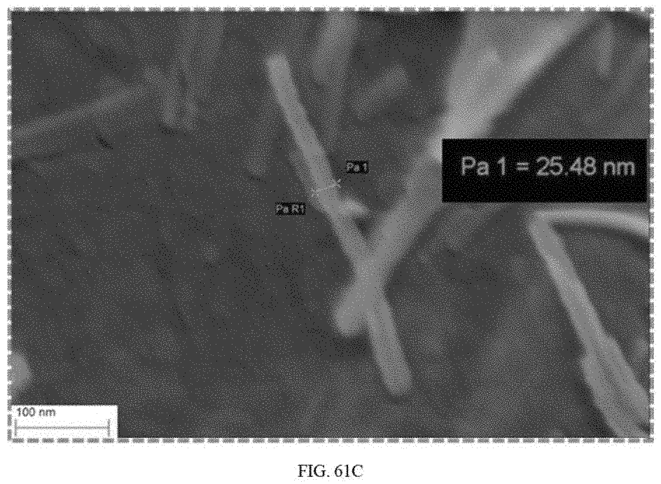

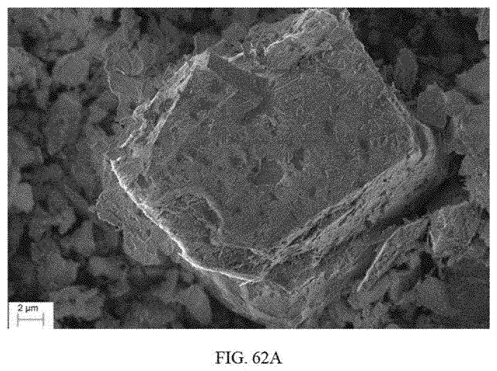

The extreme dimensions of nanomaterials generate high surface energy as the number of atoms on the surface are higher than those inside, reaching upwards of 50% at 3 nm. As a result, nanomaterials such as NC tend to agglomerate in order to reduce their free surface energy and stabilize [31]. FIG. 61 shows evidence of this phenomenon by looking at NC in the as-received, dry state, where agglomerates are at the micron level (FIG. 58A), while also emphasizing the uniformity and dimensionality of the NC used in this study (FIG. 58B, FIG. 58C).

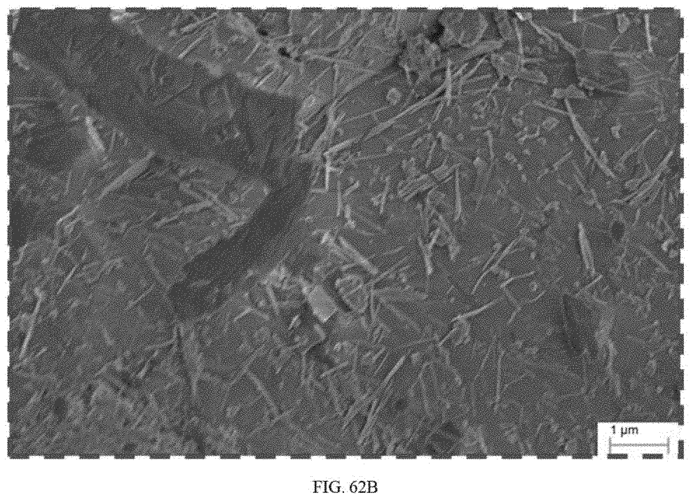

Typical dispersion methods are applied for nanomaterials in water so the dispersive state of NC can only be investigated in solution prior to combining with cement, or post hydration. Imaging post hydration however requires high resolution environmental SEMs and the ability to arrest hydration abruptly and rapidly. For example, Makar and Chan were able to utilize FEG-SEM and flash freezing using liquid nitrogen to examine growth of hydration products and the dispersive state of single walled CNTs [34]. Because dd coats cement with NC in the absence of water (and hydration products, as a result) scans such as the one shown in FIG. 62 can be collected using typical SEM equipment, showing unhydrated cement particles and dry NC. It is apparent that through dd, the cement particles can be effectively coated with singly dispersed NC particles. Furthermore, similar geometries of NC as those in FIG. 61 can be observed.

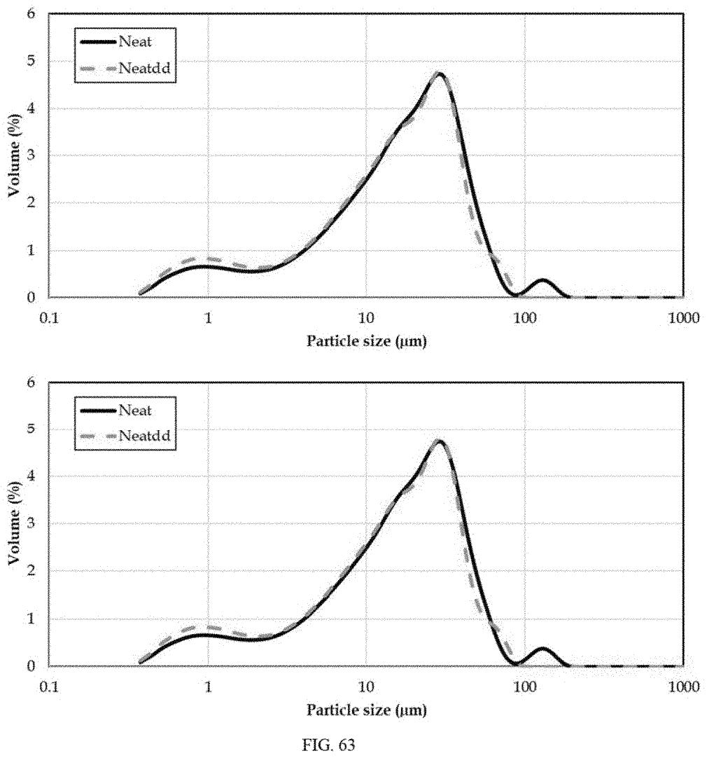

Cement powder was tested before and after dd processes to examine the effect of sonication and distillation on the cement particle gradation and rheology. As a result of dd, particles sized in the 100-200 μm range completely disappeared in Neatdd, as shown in FIG. 63. A higher number of finer particles was observed, especially in the 0.3-2.5 μm range. This decrease can be described statistically by an overall 8% decrease in particle size mean and a reduction from 2.26 μm to 1.65 μm of the particle size threshold occupying 10% by volume. These findings agree with Makar and Chan and are attributed to the high sonication energy applied to the system [31]. Makar and Chan also identified the reduction in particle size to be primarily in the gypsum phase [31]. The rheological properties were also measured and show a decrease in static yield stress of 16% (from 141 Pa to 118 Pa), a decrease in storage modulus of 27% (from 2.9×10⁵ Pa to 2.1×10⁵ Pa) and a decrease in viscosity by 8% (from 1.59 Pa·s to 1.47 Pa·s). Therefore, herein pastes where NC is introduced via mag or dm are compared against Neat, while those where NC is dry dispersed are compared against Neatdd to isolate the effect of NC.

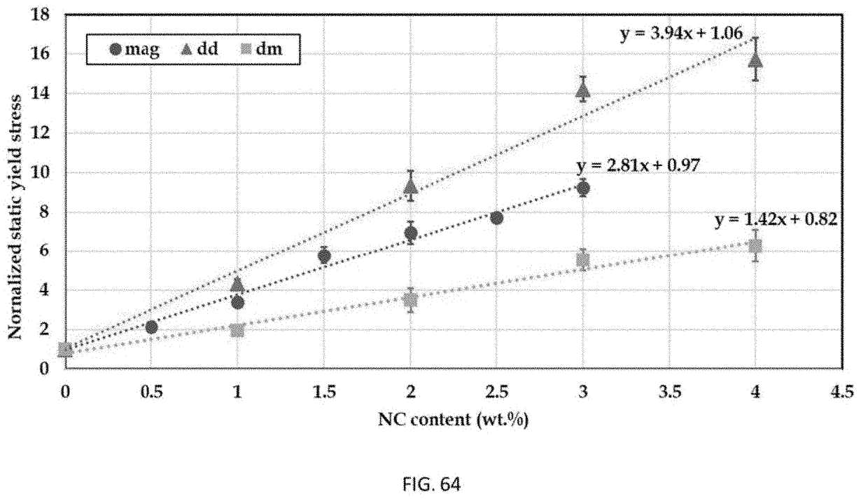

The rheological responses of NC-cement pastes at different NC contents were measured for all three dispersion methods. FIG. 64 shows the results of static yield stress normalized by their respective reference pastes Neat and Neatdd, which exhibited static yield stress values of 141 Pa and 118 Pa, respectively. It is worth noting that replacement of cement is associated with reduction in static yield stress due to a decrease in cement-cement interactions due to dilution. However, the addition of the new NC-NC and NC-cement interactions mitigate all decrease, and the effects are negligible on the static yield stress. It is evident that NC is successful in increasing static yield stress regardless of dispersion method, and increase in effectiveness increases with dispersion energy, where the highest is dd followed by mag then dm. Compared to dm, mag and dd show 1.98 and 2.77 times increase, respectively, in the efficiency of NC, which is taken to be the slope of the regression lines. This translates to lower contents of NC to reach a target yield stress, e.g. to achieve the same static yield stress achieved by 1 wt. % NC dispersed via dm, only 0.5 and 0.35 wt. % NC would be required if dispersed via mag and dd, respectively. Furthermore, up to 4 wt. % NC content was incorporated successfully via dd, reaching an increase in static yield stress by around 1500% to 1860 Pa at 0.34 w/b ratio (4NCdd).

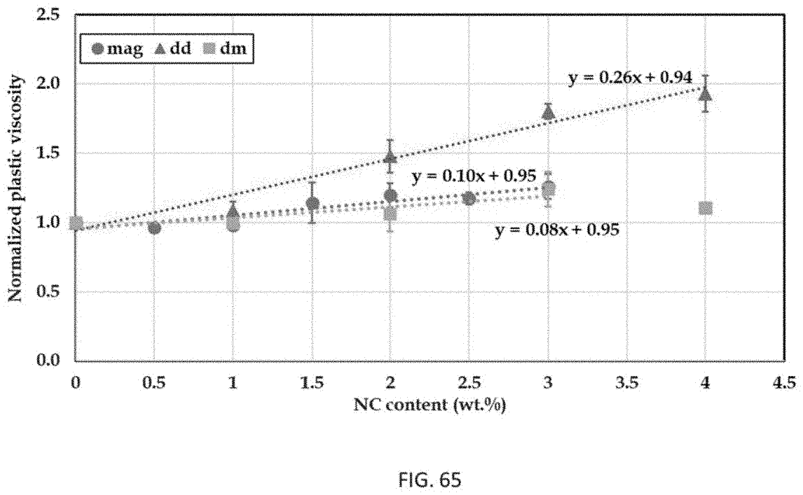

The results of plastic viscosity, which was measured as the steady-state viscosity, is shown in FIG. 65. Reported values are normalized by their respective reference pastes Neat and Neatdd, which exhibited viscosity values of 1.6 Pa-s and 1.5 Pa-s, respectively. The results of mag and dm show statistically insignificant changes in viscosity at NC contents up to 1.5 and 2.0 wt. %, respectively, but increases by up to 25% compared with Neat at higher contents irrespective of NC content. Dd showed little change at 1 wt. % but an increase in viscosity beyond 1.0 wt. %, reaching 90% increase compared with Neatdd at 4.0 wt. %. Still, the increase in viscosity is not prohibitively high for 3DCP processes. For example, Zhang et al. tested the buildability of different mixes with viscosities in the range of 3.5-4.5 Pa·s and reported excellent fluidity [14] where the highest viscosity reported in this work is that of 4NCdd at 2.8 Pa·s. Furthermore, the increase in viscosity is significantly less than the increase in static yield stress, which ranges from 500% to 1500% for 2NCdm and 4NCdd, respectively. The variations of NC's effect on viscosity due to dispersion method and content potentially explain the variations observed by different authors on the effect of NC on viscosity where [11, 14, 15] showed that NC has no significant effect on viscosity while [8, 24, 25] showed an increase in viscosity.

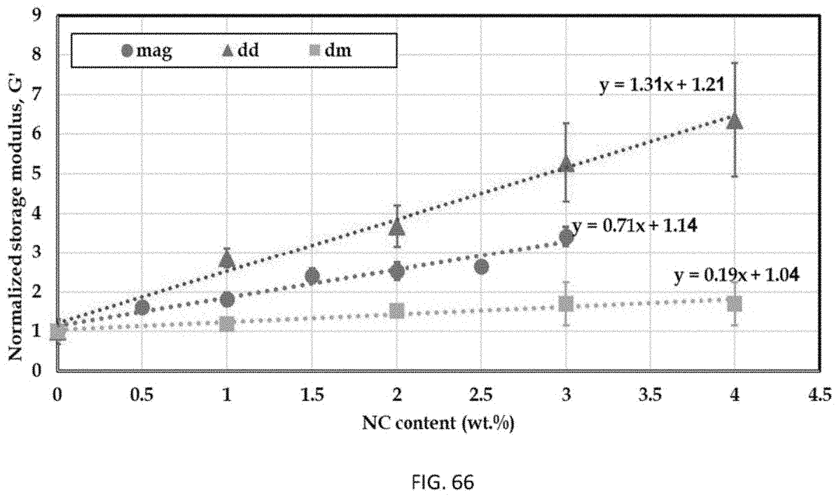

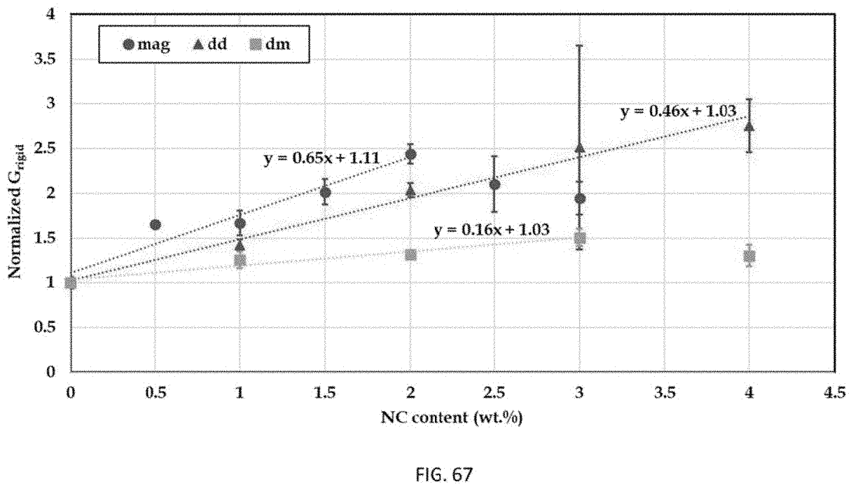

Storage modulus measurements from the SAOS amplitude sweep are presented in FIG. 66. In plain cement paste systems, the storage modulus at strain values in the order of few 10⁻⁴ is associated with C—S—H links [2]. These rigid interactions can be classified as cement-cement or cement-NC for NC modified cement pastes. And an increase in storage modulus can be an indicator of additional C—S—H links, thicker ones or combination of both, and can be used to compare NC addition level and dispersion method. It should be noted that although we will continue to refer to the origin of the rigid structure as C—S—H links/bridges for simplicity, it can be attributed to the formation of any early hydrates.

Storage modulus results show higher degree of sensitivity to dispersion energy compared to static yield stress, where the NC efficiencies are 3.68 and 6.9 times higher for mag and dd, respectively, compared to dm. Such findings suggest that higher dispersion energy could correspond to more uniformly dispersed, single NC needles enhancing degree of percolation and subsequent nucleation and rigidification, or serving as links themselves. It should be noted that this is subject to the limit of energy to achieve uniform dispersion without damaging the particles. The origin of the increase in storage modulus is further examined by looking at the evolution of the storage modulus and examining the hydration kinetics through calorimetry.

In addition to obtaining G′ from the amplitude sweep, we also monitored G′ evolution to obtain a measure of rate of stiffening. Applying Eqn (3), we focused our analysis on G_{rigid}, i.e. rate of linear increase of G′ over time, which is considered to be a measure of rigidification due to the growth of early hydrates. The results are shown in FIG. 64. Regardless of dispersion method, the addition of NC caused an increase in G_{rigid}, indicating an increase in rate of rigidification. Both dm and mag reached their maximum increase in G_{rigid} within 3.0 and 2.0 wt. % NC, respectively. The addition of NC beyond these contents showed a decrease in G_{rigid} while maintaining an overall increase compared to Neat. Dd showed an increase in G_{rigid} proportional to NC content up to 2.0 wt. %, but at 3.0 and 4.0 wt. % there was a significant increase in measurement variation, making the difference statistically insignificant. Therefore there seems to be a threshold level for all dispersion methods, beyond which no increase in G_{rigid} is observed. Additionally, in contrast to previous results on static yield stress and storage modulus, mag had higher NC efficiency for G_{rigid} compared to dd up to 2.0 wt. %. Although the results of storage modulus captured a steady increase in G′ with NC content and dispersion energy, suggesting enhanced nucleation and growth of hydrates, this was not seen in the results of G_{rigid}. Considering all these observations, it is clear that the influence of dispersion on structural build-up kinetics is more complex. The role of NC on potential seeding effects and hydration kinetics was explored further via isothermal calorimetry, and will be discussed later on.

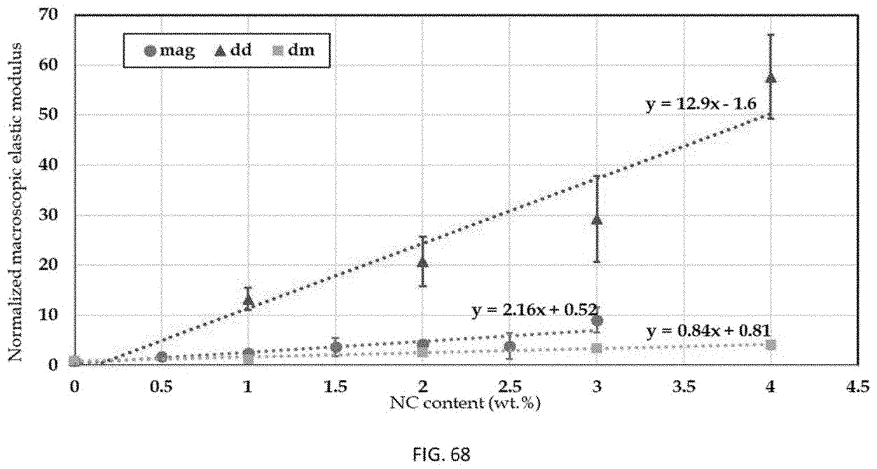

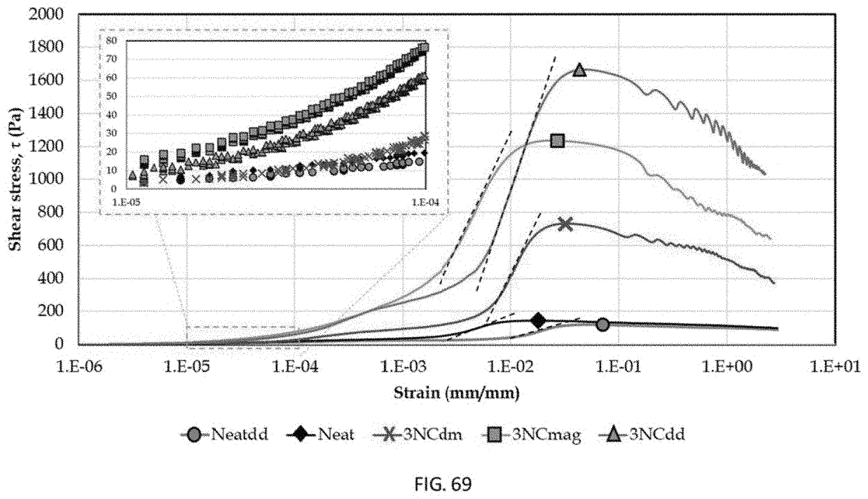

According to Roussel et al., there exist rigid and soft colloidal critical strains associated with the breakage of C—S—H links and colloidal network which are at the order of few hundredths % and few % strains, respectively [2]. At the order of few % strain and prior to yield, the stiffness of the percolated network is governed by soft colloidal interactions as rigid C—S—H links are ruptured past the rigid critical strain [2]. Nevertheless, the yield stress is still a function of the stress required for the breakage of both networks. Consequently, the macroscopic stress τ_{macro} (the stress applied to the percolated network up to and within the yield stress) can be expressed as a product of the macroscopic strain γ_{macro} in the order of few % and macroscopic elastic modulus G′_{macro}; that is, τ_{macro}=G′_{macro} γ_{macro} [2]. Hence, we measure G′_{macro} within the linear regions of the stress-strain response where the strain is in the order of few % representing the stiffness of the soft colloidal network and the results are shown in FIG. 68. FIG. 69 shows the stress-strain response at 3 wt. % NC as representatives of each dispersion method in comparison to the reference pastes, Neat and Neatdd, where the dashed lines represent the linear region where G′_{macro} is measured.

Similar to previous results, high G′_{macro} sensitivity was observed with dd followed by mag then dm. With respect to each dispersion method on static yield stress, storage modulus and G′_{macro}, NC efficiency showed higher sensitivity to properties that include soft interactions, i.e. static yield and G′_{macro}, compared to only rigid interactions, i.e. SAOS. For example, the upper limit of increase in static yield stress for dd is 1500% compared to 550% in storage modulus. There is also a significant shift in the increase magnitude between the corresponding macroscopic stress at strain values in the 10⁻³-10⁻² range compared to 10⁻⁵ to 10⁻⁴ (See the small box in FIG. 69). These results indicate that NC has greater impact on colloidal interactions rather than rigid forces. We also see significant change in the NC efficiency with increasing dispersion energy. This relationship is discussed in more depth later on.

3.4 Rheology—Kerosene System

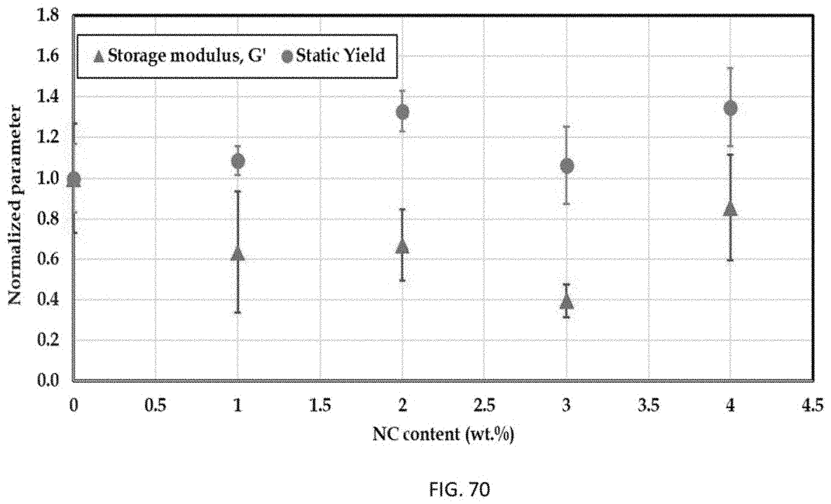

To further study colloidal interactions, we use dd NC-cement in kerosene solutions. This method of dispersion was used because NC are not dispersible in kerosene by using magnetic stirring and because dd is significantly more efficient than dm. Further, kerosene prevents hydration, eliminating the influence of any early hydrates and leaving only colloidal interactions. It is known that there are two main types of non-contact colloidal interaction existing in a cementitious system if we do not consider the steric hindrance induced by polymer additives: Van der Waals forces and electrostatic forces from adsorbed ions. By using kerosene as the suspending medium, we can diminish the influence of electrostatic force in cement paste. Kerosene is a nonpolar solvent, as opposed to water or isopropyl/ethyl alcohol, and hence we expect that electrostatic interactions are weak compared to aqueous phases and may be considered as negligible on the basis of solvation energy arguments [44]. We also looked at different NC contents up to 4.0 wt. %, measuring both static yield and storage modulus, as shown in FIG. 70. The addition of NC showed insignificant effects on both static yield stress and storage modulus considering statistical significance. Because we observed significant changes in static yield stress in cement-water pastes modified with NC and none in the cement-kerosene pastes, we can deduce that the origins of colloidal interactions of NC in cement-based systems are mainly ionic bonds and electrostatic interactions due to dissolution. As a result, higher degree of dispersion would potentially increase the number of potential interactions. This in part explains why dd, which utilizes the highest dispersion energy, shows the highest static yield stress, followed by mag then dm.

3.5 Calorimetry—Cement Paste Systems

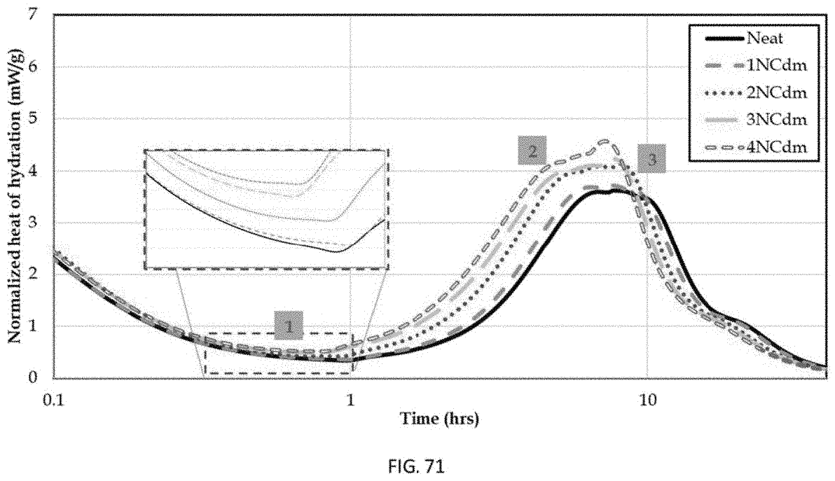

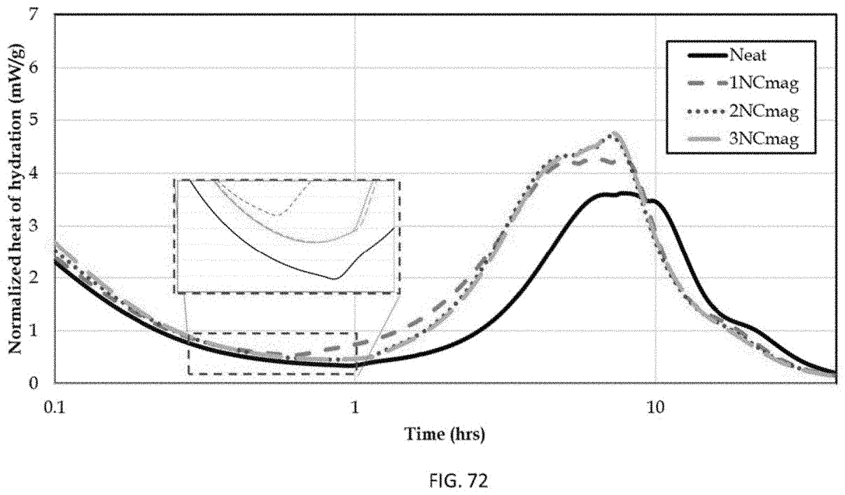

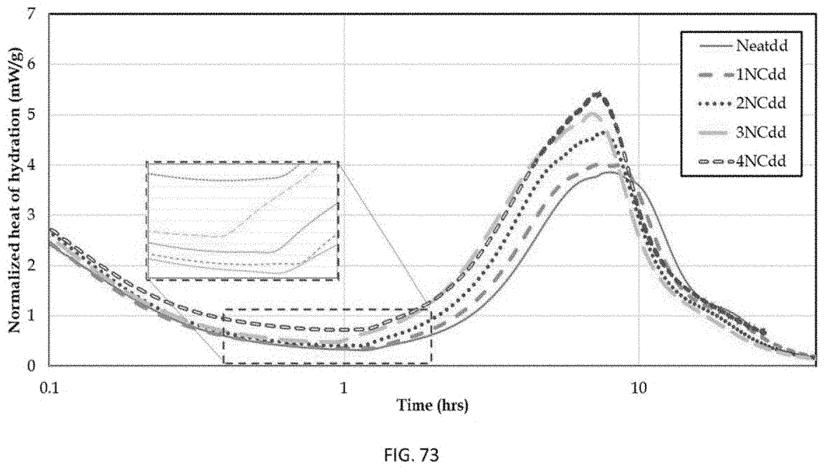

In section 3.3, we discussed that the results of storage modulus suggest stronger rigid structure, either through linking of cements by early hydrates or the NC themselves. And the results of G_{rigid} indicated NC dispersed by all methods led to an increase in rate of storage modulus evolution, although threshold levels were observed. To further characterize this effect and expand its relationship with hydration kinetics, we can analyze the results of isothermal calorimetry of dm, mag and dd shown in FIG. 71, FIG. 72, and FIG. 73, respectively. In FIG. 71, we identify 3 critical points: #1 is associated with surface reaction C₃S and measures the end of the dormant period (also called termination peak) and the start of the acceleration period [34, 38, 45], #2 marks the main C₃S reaction indicating complete setting and the beginning of early hardening and strength development, and #3 marks the main C₃A reaction indicating ettringite formation, sulfate depletion and the end of the acceleration period [34, 46]. Point #1 has been shown through isothermal calorimetry and cold field emission SEM to identify the shift from surface C—S—H nucleation to C—S—H growth and is mainly affected by change in surface area [38]. It should be noted that because NC are added as weight replacement of cement, pastes with higher NC content are more diluted. The dilution effect would cause a small backward time shift (moving to the right) in point #1 and small reduction in maximum heat of hydration in the acceleration peak.

NC have been suggested to have nucleation or seeding potential [14, 47, 48], which would result in a forward time shift in point #1 with an increase in NC content. NC-cement pastes prepared with dm and dd showed an insignificant difference at 1 wt. % and a forward shift (earlier) with increasing NC content up to 3.0 wt. % for point #1. Cement pastes prepared via mag showed a forward shift in peak #1 irrespective of NC content, statistically speaking. These results only agree marginally with the relationship between nucleation potential and expected shift in point #1. Thus, either the resolution of the isothermal calorimetry test was not enough to capture this phenomenon, or nucleation potential cannot fully explain the origin of how NC is increasing modulus. To clarify the contribution of hydration versus nanoclay on structure will require further investigation on build-up kinetics and is out of the scope of the present paper. Nevertheless, all NC cement pastes, regardless of their method of dispersion, show higher peaks of heat of hydration at the acceleration period in agreement with other researchers [7, 14, 29]. This also agrees with the results of storage modulus evolution (FIG. 64).

Discussion

Our results showed an increase in static yield stress at significantly higher levels than storage modulus, 1500% compared to 550%, respectively, which suggests that the contribution of soft ionic forces due to addition of NC are greater than rigid forces. Our prior discussion in the background and motivation further shows that the main driver of the soft colloidal forces are NC-NC interactions. Since our results show higher NC efficiency for dd, mag and then dm in static yield stress, plastic viscosity, storage modulus and macroscopic elastic modulus, the state of NC dispersion must be critical to the number of NC-NC and NC-cement interactions. Dispersion of nanomaterials encompasses two main features: disentangling or breaking apart agglomerates and distributing nanomaterials uniformly within the medium. The prior can be characterized through imaging while the latter is examined through consistency and magnitude of measured behavior. Yazdanbakhsh and Z. Garsley concluded that uniform dispersion in cement composites requires deagglomerated cement particles [16]. Because cement most often is in an agglomerated state [3], uniform solution dispersion of nanomaterials cannot produce uniform dispersion in cement composites. Of the three dispersion methods investigated, dd is the only method where both NC and cement are deagglomerated at the same time due to sonication of both in ethanol. Therefore, we suggest that of the three investigated dispersion methods, dd has the most uniform dispersion with the highest number of deagglomerated or individual NC needles. Since cement pastes prepared via mag and dm utilize similar mixing energy to distribute NC within the cement matrix, the investment of energy to disentangle and deagglomerate NC is critical to maximize NC efficiency on the rheological response of cement paste.

3DCP remains in its initial stages of development, which includes significant developments in rheological models and additives, printers, extruders, pumps, printing properties and mechanical/structural performance. Similar to current construction methods, this technology should be applicable in pre-cast facilities as well as on site. The additive system used to achieve the rheological demand should be efficient, scalable, low maintenance and versatile. Currently, significant delays can be expected due to printing errors, weather or machinery related delays. For example, Diggs-McGee et al. showed that for the construction time of 5 days, the actual printing time is 14 hours and the elapsed printing-active time is 31 hours [49]. Nanomodified cement through dd offers a simple method of using NC cement on site and offers an extended shelf life, compared to solution dispersions that may segregate over time. This method also shows higher efficiency in increasing the static yield stress by up to 1500% with a maximum increase in viscosity of 90%. The stiffness of the resulting layers characterized by G′_{macro} is also significantly higher than other methods, a key factor in buildability and shape stability [1].

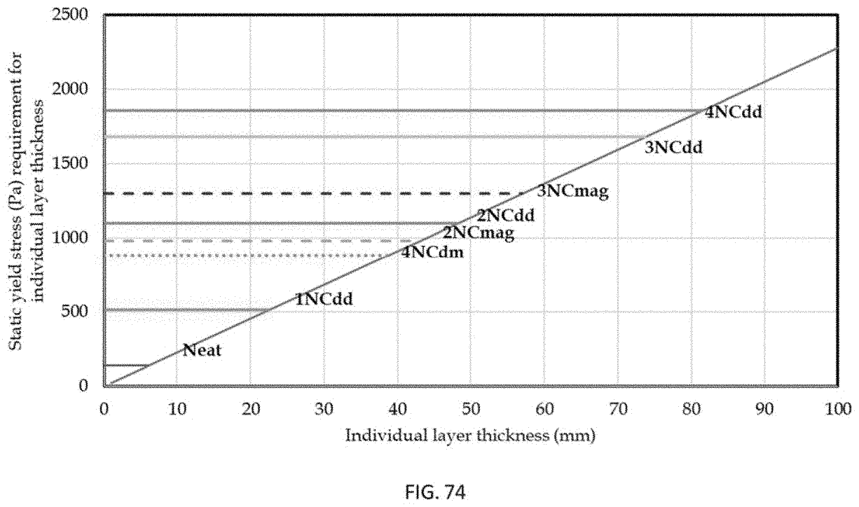

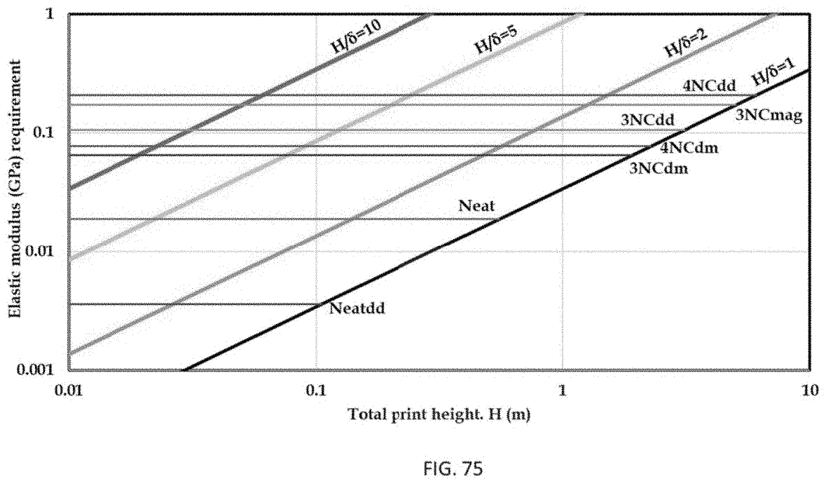

The static yield stress can be directly applied to the maximum layer height possible according to Roussel: τ_{y}≥μgh₀, where τ_{y} is the static yield stress, ρ is the density, g is the gravity and h₀ is the individual layer height [1]. FIG. 73 shows the corresponding maximum initial layer height possible where dd can reach initial layer heights of 81.5 mm at 4 wt. % content. Regardless of the print height however, structural stability remains critical in 3DCP applications. In fact, the structural stability is significantly impacted by the print geometry and specifically the print slenderness ratio (H/6). Roussel has also estimated structural stability by considering the effect of buckling on a one linear meter long, unbraced wall through: E≥3 ρgH³/2δ² where E is the elastic modulus (referred to in this work as G′_{macro}), H is the total print height and δ is the layer width [1]. Prints where geometry allows for internal structural bracing can have higher possible print height or lower critical elastic modulus. This relationship is then very useful in approximating the structural stability of unbraced segments within a print. In FIG. 74, we show this relationship for some of the highest contents of NC examined for each dispersion method. One may note that the E value used here was measured shortly after an extended pre-shear (in the protocol in FIG. 57, the low strain rate step) so the print height, H, is that of the freshly deposited layer, before the development of green strength as the material rests. But this early E is useful, as it will set the initial condition for layer stability. As suggested by our storage modulus evolution (FIG. 66), there is a continuous growth of E due to increased nucleation that further increases the layer stiffness and stability. As discussed with respect to the macroscopic elastic modulus (FIG. 65), higher content of NC increases the elastic modulus and consequently shape stability. In fact, only cement with NC would produce structurally stable layer depositions with a slenderness ratio of 10. 4NCdd offers the highest shape stability despite the fact that the reference cement for dd is significantly less stiff than the unprocessed Neat cement. This preliminary analysis shows that NC's impact on rheology translates to significant improvements in printing properties, specifically enhanced buildability and shape stability, and these improvements scale with NC content and energy utilized in dispersion.

### CONCLUSION

We examined various dispersion methods for NC (dry mixing, magnetic stirring in solution, and dry dispersion) and tested their impact on rheological and hydration behavior of cement pastes. Dry dispersion is a new dispersion method that successfully coats cement grains with NC needles. NC cement paste tests included rheological measurements (i.e. static yield stress, viscosity, and small amplitude oscillation shear), SEM imaging, and isothermal calorimetry. Our results show that there is a significantly higher increase in static yield stress, up to 1500%, than in storage modulus, limited to 550%, with the addition of ddNC up to 4%, and no increase in either of these parameters in the kerosene NC-cement systems. As a result, we suggest that soft colloidal interactions due to adsorbed ions play a more significant role in increasing the static yield stress than rigid interactions or Van der Waals forces. Within these soft adsorbed ionic forces, we discussed how NC-cement, NC-NC and cement-cement interactions are affected by the addition of NC. We also examined the effect of NC dispersion on rheology, and we discussed NC potential for 3DCP. Our results show:

Static yield stress and storage modulus increased from reference cement paste by up to 1500% and 550%, respectively. The increase was proportional to NC content up to 4% wt with minimal increase in viscosity by up to 90%.

The efficiency of NC in altering the rheological response of cement paste was higher for methods with higher dispersion energy: dry dispersion, magnetic stirring followed by dry mixing.

Heat of hydration during the acceleration period increased with NC content and dispersion energy.

It is possible to significantly reduce the required NC dosage for 3DCP by utilizing dry dispersion, which is a method that has no dispersion decay as it disperses on solid rather than in solution.

The higher NC efficiency in static yield stress compared to storage modulus observed in our results indicate that NC-NC soft interactions (specifically from adsorbed ions per our kerosene system investigation) are the main driver of static yield stress structuration.

NC increases C—S—H growth and potentially surface-based C—S—H nucleation, which corresponds to increased rigidification and stiffness.

The effect of NC on static yield stress, storage modulus and its storage modulus evolution can lead to high buildability and shape stability for 3DCP.

Aspects

The following Aspects are illustrative only and do not serve to limit the scope of the present disclosure or the appended claims.

Aspect 1. A method, comprising: combining a cementitious material, a cellulosic material, and a nanomaterial so as to give rise to a curable material, (i) the cellulosic material being combined with the nanomaterial before combination with the cementitious material, (ii) the cellulosic material being combined with the cementitious material before combination with the nanomaterial, (iii) the nanomaterial being combined with the cementitious material before combination with the cellulosic material, (iv) the cellulosic material, the nanomaterial, and the cementitious material being combined together, or any combination of (i), (ii), (iii), and (iv).

As described elsewhere herein, the method may be performed so as to give rise to a dry material. The method can also be performed in solution, e.g., in water or other solution. Without being bound to any particular theory or embodiment, combination can be effected by sonication, stirring/agitation, or any combination thereof. The components can be combined in any order, e.g., the cellulosic material can be combined with the nanomaterial, and the resultant combination can then be combined with the cementitious material. Any or all of the foregoing combining can be accomplished in the presence of water or other solvent, but this is not a requirement, as an or all of the foregoing can be accomplished in the absence of a solvent or with a solvent essentially absent (with water being an example such solvent), i.e., in a dry or nearly dry manner.

Aspect 2. The method of Aspect 1, wherein the cellulosic material is combined with the nanomaterial such that the nanomaterial is dispersed on the cellulosic material. The combination can be effected by, e.g., sonication, vibration, stirring/agitation, or any combination thereof. A solvent may be present, but this is not a requirement, as the combination can be effected in a dry or even nearly dry manner.

Aspect 3. The method of Aspect 1, wherein the nanomaterial is combined with the cementitious material such that the nanomaterial is dispersed on the cementitious material. The combination can be effected by, e.g., sonication, vibration, stirring/agitation, or any combination thereof. A solvent may be present, but this is not a requirement, as the combination can be effected in a dry or even nearly dry manner.

Aspect 4. The method of Aspect 1, wherein the cellulosic material is present as a solution before combination with the nanomaterial or the cementitious material.

Aspect 5. The method of Aspect 1, wherein the nanomaterial material is present as a solution before combination with the cellulosic material or the cementitious material.

Aspect 6. The method of Aspect 1, wherein the cellulosic material is combined with the nanomaterial before combination with the cementitious material.

Aspect 7. The method of Aspect 1, wherein the cellulosic material is combined with the cementitious material before combination with the nanomaterial.

Aspect 8. The method of Aspect 1, wherein the nanomaterial is combined with the cementitious material before combination with the cellulosic material.

Aspect 9. The method of Aspect 1, wherein the cementitious material comprises a hydraulic, calcium-based cement or MgO. Portland cement is one suitable material. The cementitious material can include one or more supplementary cementitious materials (e.g. fly ash, slag, silica fume) and alternative binders (i.e. reactive magnesium-based cements). It should be understood, however, that MgO can be utilized in addition to or even as a cementitious material. As discussed elsewhere herein, MgO can react with CO₂ to give rise to carbonates that provide strength and also act as carbon sinks. MgO can be used, e.g., as a substitute for Portland cement. One or more geopolymers can also be present; a geopolymer can be, e.g., a compound or mixture of compounds consisting of repeating units such as silico-oxide (—Si—O—Si—O—), silico-aluminate (—Si—O—Al—O—), ferro-silico-aluminate (—Fe—O—Si—O—Al—O—) or alumino-phosphate (—Al—O—P—O—), created through a process of geopolymerization.

Aspect 10. The method of any one of Aspects 1-9, wherein the nanomaterial comprises a nanoclay. A nanoclay can be, e.g., a purified magnesium alumino-silicate, commonly known as palygorskite or attapulgite. Such materials can be needle-like in shape. Such materials can have a diameter of, e.g., 15-40 nm and length of, e.g., 1-3 μm. These needles can be charged, e.g., negatively charged along their length and positively charged at the ends. A nanoclay can be entirely one charge (e.g., positive charge, negative charge), but can also include regions of different charge.

Other nanomaterials (e.g., graphene nanoplatelets, silica nanoparticles, alumina nanoparticles, calcium carbonate nanoparticles, single- and multi-wall carbon nanotubes, and other nanoparticles) can also be used; such materials can be used with nanoclays, but can also be used in place of nanoclays. Without being bound to any particular theory or embodiment, a conductive nanomaterial (e.g., graphene, carbon nanotube) can be used. Such conductive materials allow for the formation of conductive structures whose conductivities (and attendant structural condition) can be monitored. A structure can be formed that includes one or more electrodes, which electrodes can be used to monitor electrical conductance within one or more regions of the structure.

Aspect 11. The method of any one of Aspects 1-10, wherein the cellulosic material comprises a cellulosic polymer. Such a polymer can have a methoxy substitution between 27.5-31.5 wt. % at a degree of substitution of 1.5-1.9.

Aspect 12. The method of any one of Aspects 1-11, wherein the cellulosic material defines a molecular weight in the range of from about 4,000 to about 140,000 (e.g., from about 4,000 to about 140,000, from about 10,000 to about 120,000, from about 20,000 to about 100,000, from about 35,000 to about 70,000. A molecular weight in the range of about 10,000 to about 18,000 can be especially suitable, e.g., for a range of tailorable behavior. Example cellulosic material and manufacturers include, e.g., Sigma-Aldrich, Spectrum Chemicals, BeanTown Chemical, and Acros Organics. Methyl cellulose is one example cellulose; other celluloses (e.g., cellulose ethers) can be used, e.g., methylhydroxyethyl cellulose (MHEC), ethylhydroxyethyl cellulose (EHEC), methylhydroxypropyl cellulose (MHPC), hydroxyethyl cellulose (HEC), hydrophobically modified hydroxyethyl cellulose (HMHEC), and the like. It should be understood that cellulose can be substituted by a variety of substituents, as methylcellulose is only illustrative form of cellulose that can be used. Likewise, the molecular weight of the methylcellulose used in the examples herein is illustrative only, as cellulose of varying molecular weights can be used. Likewise, the degree of substitution of cellulose can vary; the degree of substitution can be up to 3, although more typical values are 1.3-2.6.

Aspect 13. The method of any one of Aspects 1-12, wherein the cellulosic material is present at from about 0.1 to about 6 wt % (and all intermediate values and ranges) in the curable material. For example, the cellulosic material can be present at from 0.1 to about 6 wt % in the curable material, or from about 0.2 to about 5.5 wt %, or from about 0.5 to about 5 wt %, or from about 0.8 to about 5 wt %, or from about 1 to about 4.5 wt %, or from about 1.5 to about 4 wt %, or from about 2 to about 3.5 wt %, or even from about 2.5 to about 3 wt %.

Aspect 14. The method of any one of Aspects 1-13, wherein the nanomaterial is present at from about 0.1 to about 10 wt % (and all intermediate values and ranges) in the curable material. For example, the cellulosic material can be present at from 0.1 to about 10 wt % in the curable material, or from about 0.2 to about 9 wt %, or from about 0.5 to about 8 wt %, or from about 0.8 to about 7 wt %, or from about 1 to about 6 wt %, or from about 1.5 to about 5 wt %, or from about 2 to about 4 wt %, or even from about 2.5 to about 3 wt %.

Aspect 15. The method of any one of Aspects 1-14, wherein the curable material (e.g., as a cement paste phase) has a static yield stress of, e.g., from about 8 to about 10,000 Pa. The static yield stress can be measured by, e.g., measuring the cement paste phase using a cup and vane geometry at a given strain rate. The static yield stress can be, e.g., from about to about 10,000 Pa, or from about 10 to about 9,000 Pa, or from about 50 to about 7500 Pa, or from about 100 to about 5000 Pa, or from about 250 to about 4000 Pa, or from about 300 to about 3500 Pa, or from about 500 to about 2500 Pa.

Aspect 16. The method of any one of Aspects 1-15, wherein the curable material (e.g., as a cement paste phase) has a plastic viscosity of, e.g., from about 0.3 Pa·s to about 18 Pa·s, e.g., from about 0.3 to about 18 Pa·s, from about 0.5 to about 15 Pa·s, from about 1 to about 12 Pa·s, from about 2 to about 10 Pa·s, from about 3 to about 8 Pa·s, from about 5 to about 7 Pa·s.

Aspect 17. The method of any one of Aspects 1-16, further comprising dispensing an amount of the curable material in an additive manufacturing process.

Aspect 18. A curable material made according to any one of Aspects 1-16.

Aspect 19. A method, comprising: combining a cementitious material, a cellulosic material, and a nanomaterial to form a curable material, the method being performed such that the curable material optionally exhibits at least one of: a pre-selected static yield stress, a pre-selected viscosity, a pre-selected heat of hydration, or pre-selected hydration kinetics, the cementitious material, the cellulosic material, or the nanomaterial being combined with another of the cementitious material, cellulosic material, and nanomaterial before being combined with the third of the cementitious material, cellulosic material, and nanomaterial. As but some examples, one can arrive at a curable material having a static yield stress of, e.g., from about 8 to about 10,000 Pa. One can also arrive at a curable material having a viscosity of from about 0.3 to about 18 Pa·s. One can also arrive at a curable material having a desired set of hydration kinetics and/or a desired heat of hydration.

Aspect 20. The method of Aspect 19, wherein the cementitious material, the cellulosic material, or the nanomaterial is combined with another of the cementitious material, cellulosic material, and nanomaterial such that the cementitious material, the cellulosic material, or the nanomaterial is dispersed on the another of the cementitious material, cellulosic material, and nanomaterial.

Aspect 21. A pre-mix, comprising: a nanomaterial combined with a cellulosic material.

Aspect 22. The pre-mix of Aspect 21, wherein the nanomaterial is dispersed on the cellulosic material. A pre-mix can optionally comprise a cementitious material and/or MgO, as described elsewhere herein.

Aspect 23. A method, comprising combining the pre-mix of Aspect 21 or Aspect 22 with a cementitious material so as to give rise to a curable material.

Aspect 24. The method of Aspect 23, further comprising dispensing an amount of the curable material in an additive manufacturing process.

Aspect 25. The method of Aspect 24, further comprising forming at least part of a structure with the additive manufacturing process.

Aspect 26. A curable composition, comprising: a cementitious material, a cellulosic material, and a nanomaterial, the cellulosic material and the nanomaterial being present in proportions such that the curable material optionally exhibits at least one of: a pre-selected static yield stress, a pre-selected viscosity, a pre-selected heat of hydration, or pre-selected hydration kinetics.

Aspect 27. The curable composition of Aspect 26, wherein the nanomaterial comprises a nanoclay.

Aspect 28. The curable composition of Aspect 28, wherein the curable composition is essentially free of water. As described elsewhere herein, curable compositions can be formed by dry dispersion, which dry dispersion can in some instances include one or more of stirring, agitation, and sonication.

Aspect 29. A curable material, comprising: a cementitious material; a cellulosic material; and a nanomaterial. Suitable cementitious materials, cellulosic materials, and nanomaterials are described elsewhere herein.

Aspect 30. The curable material of Aspect 29, wherein the cementitious material comprises a hydraulic, calcium-based cement or MgO.

Aspect 31. The curable material of any one of Aspects 29-30, wherein the nanomaterial comprises a nanoclay.

Aspect 32. The curable material of any one of Aspects 29-31, wherein the cellulosic material comprises a cellulosic polymer.

Aspect 33. The curable material of any one of Aspects 29-32, wherein the cellulosic material defines a molecular weight in the range of from about 4,000 to about 140,000 (e.g., from about 4,000 to about 140,000, from about 10,000 to about 120,000, from about 20,000 to about 100,000, from about 35,000 to about 70,000. A molecular weight in the range of about 10,000 to about 18,000 can be especially suitable, e.g., for a range of tailorable behavior.

Aspect 34. The curable material of any one of Aspects 29-33, wherein the cellulosic material is present at from about 0.1 to about 6 wt % in the curable material (and all intermediate values and ranges) in the curable material. For example, the cellulosic material can be present at from 0.1 to about 6 wt % in the curable material, or from about 0.2 to about 5.5 wt %, or from about 0.5 to about 5 wt %, or from about 0.8 to about 5 wt %, or from about 1 to about 4.5 wt %, or from about 1.5 to about 4 wt %, or from about 2 to about 3.5 wt %, or even from about 2.5 to about 3 wt %.

Aspect 35. The curable material of any one of Aspects 29-34, wherein the nanomaterial is present at from about 0.1 to about 10 wt % (and all intermediate values and ranges) in the curable material. For example, the cellulosic material can be present at from 0.1 to about 10 wt % in the curable material, or from about 0.2 to about 9 wt %, or from about 0.5 to about 8 wt %, or from about 0.8 to about 7 wt %, or from about 1 to about 6 wt %, or from about 1.5 to about 5 wt %, or from about 2 to about 4 wt %, or even from about 2.5 to about 3 wt %) in the curable material.

Aspect 36. The curable material of any one of Aspects 29-35, curable material has a static yield stress (e.g., as a cement paste phase) of from about 8 to about 3,000 Pa (e.g., from about 8 to about 3000 Pa, from about 10 to about 2500 Pa, from about 50 to about 2000 Pa, from about 75 to about 1750 Pa, from about 100 to about 1500 Pa, from about 150 to about 1250 Pa, from about 200 to about 1200 Pa, from about 300 to about 1000 Pa, or even from about 500 to about 900 Pa) when measuring the cement paste phase.

Aspect 37. The curable material of any one of Aspects 29-37, wherein the curable material has a plastic viscosity (e.g., as a cement paste phase) of from about 0.3 Pa·s to about 18 Pa·s when measuring the cement paste phase.

### REFERENCES

The following references are listed only for the convenience of the reader; the inclusion of a reference is not any acknowledgment that the reference is material to the patentability of the disclosed technology.
[1] N. Roussel, Rheological requirements for printable concretes, Cement and Concrete Research, Volume 112, 2018, Pages 76-85, ISSN 0008-8846, https://doi.org/10.1016/j.cemconres.2018.04.005
[2] N. Roussel, G. Ovarlez, S. Garrault, C. Brumaud, The origins of thixotropy of fresh cement pastes, Cement and Concrete Research, Volume 42, Issue 1, 2012, Pages 148-157, ISSN 0008-8846, https://doi.org/10.1016/j.cemconres.2011.09.004
[3] R. J. Flatt, Dispersion forces in cement suspensions, Cement and Concrete Research, Volume 34, Issue 3, 2004, Pages 399-408, ISSN 0008-8846, https://doi.org/10.1016/j.cemconres.2003.08.019.
[4] R. J. Flatt, P. Bowen, Electrostatic repulsion between particles in cement suspensions: Domain of validity of linearized Poisson-Boltzmann equation for nonideal electrolytes, Cement and Concrete Research, Volume 33, Issue 6, 2003, Pages 781-791, ISSN 0008-8846, https://doi.org/10.1016/S0008-8846(02)01059-1
[5] J. Kruger, S. Zeranka, G. Zijl, 3D concrete printing: A lower bound analytical model for buildability performance quantification, Automation in Construction, Volume 106, 2019, 102904, ISSN 0926-5805, https://doi.org/10.1016/j.autcon.2019.102904.
[6] R. Jayathilakage, P. Rajeev, J. G. Sanjayan, Yield stress criteria to assess the buildability of 3D concrete printing, Construction and Building Materials, Volume 240, 2020, 117989, ISSN 0950-0618, https://doi.org/10.1016/j.conbuildmat.2019.117989.
[7] A. V. Rahul, M. Santhanam, H. Meena, Z. Ghani, 3D printable concrete: Mixture design and test methods, Cement and Concrete Composites, Volume 97, 2019, Pages 13-23, ISSN 0958-9465,
[8] A. Kazemian, X. Yuan, E. Cochran, B. Khoshnevis, Cementitious materials for construction-scale 3D printing: Laboratory testing of fresh printing mixture, Construction and Building Materials, Volume 145, 2017, Pages 639-647, ISSN 0950-0618,
[9] D. G. Soltan & V. C. Li, A self-reinforced cementitious composite for building-scale 3D printing, Cement and Concrete Composites, Volume 90, 2018, Pages 1-13, ISSN 0958-9465,
[10] O. A. Mendoza Reales, P. Duda, E. C. C. M. Silva, M. D. M. Paiva, R. D. T. Filho, Nanosilica particles as structural buildup agents for 3D printing with Portland cement pastes, Construction and Building Materials, Volume 219, 2019, Pages 91-100, ISSN 0950-0618, https://doi.org/10.1016/j.conbuildmat.2019.05.174
[11] B. Panda, M. J. Tan, Experimental study on mix proportion and fresh properties of fly ash based geopolymer for 3D concrete printing, Ceramics International, Volume 44, Issue 9, 2018, Pages 10258-10265, ISSN 0272-8842,
[12] B. Panda, S. C. Paul, L. J. Hui, Y. W. D. Tay, M. J. Tan, Additive manufacturing of geopolymer for sustainable built environment, Journal of Cleaner Production, Volume 167, 2017, Pages 281-288, ISSN 0959-6526,
[13] M. Kaszyńska, M. Hoffmann, S. Skibicki, A. Zieliński, M. Techman, N. Olczyk, T. Wróblewski. Evaluation of suitability for 3D printing of high performance concretes. MATEC web of conferences, 2018, ISSN: 2261-236X, Volume 163, p. 01002. http://dx.doi.org/10.1051/matecconf/201816301002
[14] Y. Zhang, Y. Zhang, G. Liu, Y. Yang, M. Wu, B. Pang, Fresh properties of a novel 3D printing concrete ink, Construction and Building Materials, Volume 174, 2018, Pages 263-271, ISSN 0950-0618,
[15] B. Panda, S. Ruan, C. Unluer, M. J. Tan, Improving the 3D printability of high volume fly ash mixtures via the use of nano attapulgite clay, Composites Part B: Engineering, Volume 165, 2019, Pages 75-83, ISSN 1359-8368,
[16] A. Yazdanbakhsh and Z. Grasley, The theoretical maximum achievable dispersion of nanoinclusions in cement paste. Cement and Concrete Research, vol. 42, no. 6, pp. 798-804, 2012.
[17] T. Wangler, E. Lloret, L. Reiter, N. Hack, F. Gramazio, M. Kohler, M. Bernhard, B. Dillenburger, J. Buchli, N. Roussel, R. and Flatt. Digital Concrete: Opportunities and Challenges”, RILEM Technical Letters, 1, 2016, pp. 67-75. doi: 10.21809/rilemtechlett.2016.16.
[18] D. P. Bentz, S. Z. Jones, I. R. Bentz, M. A. Peitz, Towards the formulation of robust and sustainable cementitious binders for 3-D additive construction by extrusion, Construction and Building Materials, Volume 175, 2018, Pages 215-224, ISSN 0950-0618,
[19] B. Panda, J. H. Lim, M. J. Tan, Mechanical properties and deformation behaviour of early age concrete in the context of digital construction, Composites Part B: Engineering, Volume 165, 2019, Pages 563-571, ISSN 1359-8368,
[20] D. Jiao, C. Shi, Q. Yuan, X. An, Y. Liu, H. Li, Effect of constituents on rheological properties of fresh concrete-A review, Cement and Concrete Composites, Volume 83, 2017, Pages 146-159, ISSN 0958-9465, https://doi.org/10.1016/j.cemconcomp.2017.07.016.
[21] Y. Qian, S. Ma, S. Kawashima, G. D. Schutter, Rheological characterization of the viscoelastic solid-like properties of fresh cement pastes with nanoclay addition, Theoretical and Applied Fracture Mechanics, Volume 103, 2019, 102262, ISSN 0167-8442 https://doi.org/10.1016/j.cemconres.2016.09.005
[22] Y. Qian, S. Kawashima, Use of creep recovery protocol to measure static yield stress and structural rebuilding of fresh cement pastes, Cement and concrete research, 2016, ISSN: 0008-8846, Volume 90, p. 73
[23] S. Ma, Y. Qian, S. Kawashima, Experimental and modeling study on the non-linear structural build-up of fresh cement pastes incorporating viscosity modifying admixtures, Cement and concrete research, 2018, ISSN: 0008-8846, Volume 108, p. 1 https://doi.org/10.1016/j.cemconres.2018.02.022
[24] I. Dejaeghere, M. Sonebi, G. De Schutter, Influence of nano-clay on rheology, fresh properties, heat of hydration and strength of cement-based mortars, Construction and Building Materials, Volume 222, 2019, Pages 73-85, ISSN 0950-0618,
[25] Y. Liu, J. Han, M. Li, P. Yan, Effect of a nanoscale viscosity modifier on rheological properties of cement pastes and mechanical properties of mortars, Construction and Building Materials, Volume 190, 2018, Pages 255-264, ISSN 0950-0618,
[26] ActiveMinerals International, LLC. What is Acti-Gel® 208 and the science behind Acti-Gel® 208
[27] Y. Qian & G. De Schutter, Enhancing thixotropy of fresh cement pastes with nanoclay in presence of polycarboxylate ether superplasticizer (PCE), Cement and Concrete Research, Volume 111, 2018, Pages 15-22, ISSN 0008-8846,
[28] N. A. Tregger, M. E. Pakula, S. P. Shah, Influence of clays on the rheology of cement pastes, Cement and Concrete Research, Volume 40, Issue 3, 2010, Pages 384-391, ISSN 0008-8846,
[29] Z. Quanji, G. R. Lomboy, K. Wang, Influence of nano-sized highly purified magnesium alumino silicate clay on thixotropic behavior of fresh cement pastes, Construction and Building Materials, Volume 69, 2014, Pages 295-300, ISSN 0950-0618
[30] T. Chang, J. Shih, K. Yang, T. Hsiao. Material properties of portland cement paste with nano-montmorillonite. Journal of Materials Science, September 2007, ISSN: 0022-2461, Volume 42, Issue 17, p. 7478
[31] S. Parveen, S. Rana, and R. Fangueiro, “A Review on Nanomaterial Dispersion, Microstructure, and Mechanical Properties of Carbon Nanotube and Nanofiber Reinforced Cementitious Composites,” Journal of Nanomaterials, vol. 2013, 19 pages, 2013. https://doi.org/10.1155/2013/710175.
[32] S. Pradhan, J. Hedberg, E. Blomberg, S. Wold, I. O. Wallinder; Effect of sonication on particle dispersion, administered dose and metal release of non-functionalized, non-inert metal nanoparticles. Journal of nanoparticle research: an interdisciplinary forum for nanoscale science and technology, 2016, ISSN: 1572-896X, Volume 18, Issue 9, p. 1 https://doi.org/10.1007/s11051-016-3597-5
[33] Z. Guo-Dong, J. D. Kuntz, J. Wan, A. K. Mukherjee. Single-wall carbon nanotubes as attractive toughening agents in alumina-based nanocomposites. Nature materials, 2002, ISSN: 1476-4660, Volume 2, Issue 1, p. 38. http://dx.doi.org/10.1038/nmat793
[34] J. M. Makar, G. W. Chan. Growth of cement hydration products on single walled carbon nanotubes. Journal of the American Ceramic Society, June 2009, ISSN: 0002-7820, Volume 92, Issue 6, p. 1303. https://doi.org/10.1111/j.1551-2916.2009.03055.x
[35] J. M. Makar, J. Margeson, J. Luh. Carbon nanotube/cement composites-early results and potential applications, Construction Materials. In Proceedings of ConMat'05 and Mindess Symposium, Vancouver, Canada, 22-24 Aug. 2005; p. 32.
[36] J. Hogancamp & Z. Grasley, The use of microtine cement to enhance the efficacy of carbon nanofibers with respect to drying shrinkage crack resistance of portland cement mortars, Cement and Concrete Composites, Volume 83, 2017, Pages 405-414, ISSN 0958-9465,
[37] V. V. Rocha, P. Ludvig, A. C. C. Trindade, F. de Andrade Silva, The influence of carbon nanotubes on the fracture energy, flexural and tensile behavior of cement based composites, Construction and Building Materials, Volume 209, 2019, Pages 1-8, ISSN 0950-0618
J. M. Makar, G. W. End of the Induction Period in Ordinary Portland Cement as Examined by High-Resolution Scanning Electron Microscopy. Journal of the American Ceramic Society, April 2008, ISSN: 0002-7820, Volume 91, Issue 4, p. 1292
[38] E. Sakai, M. Daimon, Mechanisms of superplastification, in: J. Skalny, S. Mindess (Eds.), Materials Science of Concrete, vol. IV, American Ceramic Society, Westerville, O H, 1995, pp. 91-111.
[39] S. Mantellato, M. Palacios, R. J. Flatt. Relating early hydration, specific surface and flow loss of cement pastes. Mater Struct 52, 5, 2019. https://doi.org/10.1617/s11527-018-1304-y
[40] Y. Liu, J. Han, M. Li, P. Yan, Effect of a nanoscale viscosity modifier on rheological properties of cement pastes and mechanical properties of mortars, Construction and Building Materials, Volume 190, 2018, Pages 255-264, ISSN 0950-0618, https://doi.org/10.1016/j.conbuildmat.2018.09.110
[41] R. D. Ferron, S. Shah, E. Fuente, C. Negro, Aggregation and breakage kinetics of fresh cement paste, Cement and Concrete Research, Volume 50, 2013, Pages 1-10, ISSN 0008-8846, https://doi.org/10.1016/j.cemconres.2013.03.002.
[42] N. A. Tregger, M. E. Pakula, Surendra P. Shah, Influence of clays on the rheology of cement pastes, Cement and Concrete Research, Volume 40, Issue 3, 2010, Pages 384-391, ISSN 0008-8846, https://doi.org/10.1016/j.cemconres.2009.11.001.
[43] G. Kokot, M. I. Bespalova, M. Krishnan, Measured electrical charge of SiO₂ in polar and nonpolar media, J. Chem. Phys. 145, 194701, 2016; https://doi.org/10.1063/1.4967401
[44] J. M. Makar, G. W. Chan, and K. Y. Esseghaier. A peak in the hydration reaction at the end of the cement induction period. Journal of Materials Science, February 2007, ISSN: 0022-2461, Volume 42, Issue 4, p. 1388
[45] S. Mindness, J. F. Yong, D. Darwin (2003), Concrete. Upper Saddle River (New Jersey: Prentice Hall).
[46] N. Hamed, M. S. El-Feky, M. Kohail, E. A. R. Nasr. Effect of nano-clay de-agglomeration on mechanical properties of concrete. Construction & building materials, 2019, ISSN: 0950-0618, Volume 205, p. 245
[47] H. Lindgreen, M. Geiker, H. Kroyer, N. Springer, J. Skibsted. Microstructure engineering of Portland cement pastes and mortars through addition of ultrafine layer silicates. Cement & concrete composites, 2008, ISSN: 0958-9465, Volume 30, Issue 8, p. 686
[48] B. N. Diggs-McGee, E. L. Kreiger, M. A. Kreiger, M. P. Case, Print time vs. elapsed time: A temporal analysis of a continuous printing operation for additive constructed concrete, Additive Manufacturing, Volume 28, 2019, Pages 205-214, ISSN 2214-8604.

What is claimed:

1. A curable material, comprising
a cementitious material;
a cellulosic material; and
a nanomaterial.

2. The curable material of claim 1, wherein the cementitious material comprises a hydraulic, calcium-based cement or MgO.

3. The curable material of claim 1, wherein the nanomaterial comprises a nanoclay.

4. The curable material of claim 1, wherein the cellulosic material comprises a cellulosic polymer.

5. The curable material of claim 1, wherein the cellulosic material defines a molecular weight in the range of from about 4,000 to about 140,000.

6. The curable material of claim 1, wherein the cellulosic material is present at from about 0.1 to about 6 wt % in the curable material.

7. The curable material of claim 1, wherein the nanomaterial is present at from about 0.1 to about 10 wt % in the curable material.

8. The curable material of claim 1, curable material has a static yield stress of from about 8 to about 3,000 Pa when measuring the cement paste phase.

9. The curable material of claim 1, wherein the curable material has a plastic viscosity of from about 0.3 Pa·s to about 18 Pa·s when measuring the cement paste phase.

10. A method, comprising:
combining a cementitious material, a cellulosic material, and a nanomaterial so as to give rise to a curable material,
(i) the cellulosic material being combined with the nanomaterial before combination with the cementitious material,
(ii) the cellulosic material being combined with the cementitious material before combination with the nanomaterial,
(iii) the nanomaterial being combined with the cementitious material before combination with the cellulosic material,
(iv) the cellulosic material, the nanomaterial, and the cementitious material being combined together, or
any combination of (i), (ii), (iii), and (iv),
the combining optionally being performed in the absence of a solvent.

11. The method of claim 10, wherein the cellulosic material is combined with the nanomaterial such that the nanomaterial is dispersed on the cellulosic material.

12. The method of claim 10, wherein the nanomaterial is combined with the cementitious material such that the nanomaterial is dispersed on the cementitious material.

13. The method of claim 10, wherein the cellulosic material is combined with the nanomaterial before combination with the cementitious material.

14. The method of claim 10, wherein the cementitious material comprises a hydraulic, calcium-based cement or MgO.

15. The method of claim 10, wherein the nanomaterial comprises a nanoclay.

16. The method of claim 10, wherein the cellulosic material comprises a cellulosic polymer.

17. The method of claim 10, wherein the cellulosic material is present at from about 0.1 to about 6 wt % in the curable material.

18. The method of claim 10, wherein the nanomaterial is present at from about 0.1 to about 10 wt % in the curable material.

19. The method of claim 10, wherein (a) the curable material has a static yield stress of from about 8 to about 3,000 Pa when measuring the cement paste phase, (b) the curable material has a plastic viscosity of from about 0.3 Pa·s to about 18 Pa·s when measuring the cement paste phase, or both (a) and (b).

20. A method, comprising dispensing an amount of a curable material according to claim 1 in an additive manufacturing process.
